(19) United States
(12) Patent Application Publication
(10) Pub. No.: US 2021/0350555 A1
(43) Pub. Date: Nov. 11, 2021

(54) SYSTEMS AND METHODS FOR DETECTING PROXIMITY EVENTS

(71) Applicant: STANDARD COGNITION, CORP., San Francisco, CA (US)

(72) Inventors: Daniel L. FISCHETTI, SAN FRANCISCO, CA (US); Nicholas J. LOCASCIO, SAN FRANCISCO, CA (US); Prerit JAISWAL, Millbrae, CA (US)

(73) Assignee: STANDARD COGNITION, CORP., San Francisco, CA (US)

(21) Appl. No.: 17/314,415

(22) Filed: May 7, 2021

Related U.S. Application Data
(60) Provisional application No. 63/022,343, filed on May 8, 2020.

(51) Int. Cl. G06T 7/292; G06K 9/00; G06K 9/62; G06T 7/73; G06T 3/40; G06N 3/04; G06N 3/08; G06Q 10/08

(52) U.S. Cl. CPC G06T 7/292; G06T 2207/30232; G06K 9/6217; G06T 7/73; G06T 3/40; G06K 9/00369; G06K 9/6282; G06N 3/0454; G06N 3/08; G06Q 10/087; G06T 2207/20081; G06T 2207/10016; G06T 2207/20132; G06T 2207/20084; G06T 2207/30196; G06K 9/00771

(57) ABSTRACT

Systems and techniques are provided for tracking puts and takes of inventory items by sources and sinks in an area of real space. The system can include sensors producing a plurality of sequences of images of corresponding fields of view in the real space. The system can include image recognition logic, receiving sequences of images from the plurality of sequences. The image recognition logic processes the images in sequences to identify locations of sources and sinks over time represented in the images. The system can include logic to process the identified locations of sources and sinks over time to detect an exchange of an inventory item between sources and sinks.

### PRIORITY APPLICATION

This application claims the benefit of U.S. Provisional Patent Application No. 63/022,343 filed 8 May 2020, which application is incorporated herein by reference.

### BACKGROUND

### Field

The present invention relates to systems that identify and track puts and takes of items by subjects in real space.

### Description of Related Art

Technologies have been developed to apply image processing to identify and track actions of subjects in real space. For example, so-called cashier-less shopping systems are being developed with identify inventory items that have been picked up by the shoppers, and automatically accumulate shopping lists that can be used to bill the shoppers.

There are many locations in stores that can hold inventory items, and act in an exchange as one or both of a source of an inventory item or a sink of an inventory item. These locations are referred to herein as inventory caches. Examples of inventory caches include shelfs on inventory display structures, peg boards. baskets, bins, and other physical locations in the stores that typically do not move during a shopping episode. Other examples of inventory caches include shoppers hands, the crook of a shopper's elbow, a shopping bag or a shopping cart having locations in the store which move over time.

Tracking exchanges of inventory items in a store involving customers, such as a people in a shopping store, present many technical challenges. For example, consider such an image processing system deployed in a shopping store with multiple customers moving in aisles between the shelves and open spaces within the shopping store. Customer interactions can include takes of items from shelves (i.e. a fixed inventory cache) and placing them in their respective shopping carts or baskets (i.e. a moving inventory cache). Customers may also put items back on the shelf in an exchange from a moving inventory cache to a fixed inventory cache, if they do not want the item. The customers can also transfer items in their hands to the hands of other customers who may then put these items in their shopping carts or baskets in an exchange between two moving inventory caches. The customer can also simply touch inventory items, without an exchange of the inventory items.

It is desirable to provide a technology that solves technological challenges involved in effectively and automatically identifying and tracking exchanges of inventory items, including puts, takes and transfers, in large spaces.

### SUMMARY

A system, and method for operating a system, are provided for detecting and classifying exchanges of inventory items in an area of real space. This function of detection and classifying of exchanges of inventory items by image processing presents a complex problem of computer engineering, relating to the type of image data to be processed, what processing of the image data to perform, and how to determine actions from the image data with high reliability. The system described herein can in some embodiments perform these functions using only images from sensors, such as cameras disposed overhead in the real space, so that no retrofitting of store shelves and floor space with sensors and the like is required for deployment in a given setting. In other embodiments, a variety of configurations of sensors deployed in the area of real space can be utilized.

A system, method and computer program product are described, for tracking exchanges of inventory items between inventory caches which can act as at least one of sources and sinks of inventory items in exchanges of inventory items, including first processing a plurality of sequences of images, in which sequences of images in the plurality of sequences of images have respective fields of view in the real space, to locate inventory caches which move over time having locations in three dimensions; accessing data to locate inventory caches on inventory display structures in the area of real space; second processing the located inventory caches over time to detect a proximity event between the located inventory caches, the proximity event having a location in the area of real space and a time; and third processing images in at least one sequence of images in the plurality of sequences of images before and after the time of the proximity event to classify an exchange of an inventory item in the proximity event.

A system, method and computer program product are provided for detecting proximity events in an area of real space, where a proximity event is an event in which a moving inventory cache is located in proximity with another inventory cache, which can be moving or stationary. The system and method for detecting proximity events can use a plurality of sensors to produce a plurality of sequences of images, in which sequences of images in the plurality of sequences of images have respective fields of view in the real space. In advantageous systems, the field of view of each sensor overlaps with the field of view of at least one other sensor in the plurality of sensors. The system and method are described for processing the images from overlapping sequences of images to generate positions of subjects in three dimensions in the area of real space. Using the position of inventory caches in three dimensions, the system and method identifies proximity events, which have a location and a time, when distance between a moving inventory cache, such as a person, and another inventory cache such as a shelf or a person, is below a pre-determined threshold.

A system, method and computer program product capable of tracking exchanges of inventory items between individual persons, generally referred to herein as subjects, in an area of real space is described. Accordingly, a processing system can be configured as described herein to receive a plurality of sequences of images, where sequences of images in the plurality of sequences of images have of respective fields of view in the real space. The processing system includes an image recognition logic, receiving sequences of images from the plurality of sequences, and processing the images in sequences to identify locations of inventory caches linked to first and second subjects over time represented in the images. The system includes logic to process the identified locations of the inventory caches linked to first and second subjects over time to detect an exchange of an inventory item between the first and second subjects.

In one embodiment, the processing of images to generate positions of subjects and inventory caches linked to the subjects in three dimensions in the area of real space includes calculating locations of joints of subjects in three dimensions in the area of real space. The system can process the sets of joints and their locations to identify a subject as a constellation of joints, and an inventory cache as a location linked to the constellation of joints, such as a position of a joint corresponding to the subjects hand.

The detected exchanges can include at least one of a transfer event, put event, a take event or a touch event. A transfer event can be an exchange in which the inventory cache acting as a source, and the inventory cache acting as a sink, are linked to different shoppers. A put event can be an exchange in which the inventory cache acting as a source is linked to shopper, and the inventory cache acting as a sink, is an inventory location in the store that is typically not moving. A take event can be an exchange in which the inventory cache acting as a source is an inventory location in the store that is typically not moving, and the inventory cache acting as a sink is linked to a shopper. A touch event can be a proximity event without an exchange of inventory item, where the inventory cache acting as a source also acts as the sink for the purposes of classifying the event.

In one embodiment, the system includes logic to detect a put event when the distance between the source, represented by a three dimensional position of a subject holding an item prior to the detected proximity event and not holding the item after the detected proximity event, and the sink, represented by the three dimensional position of a subject not holding an item prior to the detected proximity event and holding the item after the detected proximity event is less than the threshold.

In one embodiment, the system includes logic to detect a take event when distance between the sink, represented by a three dimensional position of a subject not holding an item prior to the detected proximity event and holding the item after the detected proximity event, and the source, represented by the three dimensional position of a subject holding an item prior to the detected proximity event and not holding the item after the detected proximity event is less than the threshold.

Locations which can act as sources and sinks are referred to herein as inventory caches, which have locations in three dimensions in the area of real space. Inventory caches can be hands or a crux of an elbow on shoppers, shopping bags, shopping carts or other locations which move over time as the shoppers move through the area of real space. Inventory caches can be locations in inventory display structures, such as shelves, which typically do no move during a shopping episode.

In one embodiment, the system includes logic to detect a touch event when the distance between the sink, represented by a three dimensional position of a subject not holding an item prior to the detected proximity event and not holding the item after the detected proximity event, and the source, represented by the three dimensional position of a subject holding an item prior to the detected proximity event and holding the item after the detected proximity event is less than the threshold.

In one embodiment, the system can include logic to detect a transfer event or an exchange event between a sink and a source. The source and sinks can be represented by subjects in three dimensions in the area of real space. The sources and sinks can also include positions of shelves or other locations in three dimensions in the area of real space. The system can detect a transfer event or an exchange event when the source and sink are located at a distance which is below a pre-defined threshold distance. The system can include logic to process sequences of images of sources and sinks over time to detect exchange of items between sources and sinks. In one embodiment, the transfer event or exchange event can include a put event and a take event. The source holds the inventory item before the proximity event is detected and does not hold the inventory item after the proximity event. The sink does not hold the inventory item before the proximity event and holds the inventory item after the proximity event. Therefore, the technology disclosed can detect exchanges or transfers of inventory items from source to sinks.

In some embodiments, the processing of the images to detect the locations of shoppers, or other subjects, and of inventory caches linked to the shoppers which move, can include first reducing the resolution of the images, and then applying the reduced resolution images to a trained inference engine like a neural network. The processing of images to detect the inventory items subject of the exchanges can be executed using the same images with a high resolution compared to the without the reduced resolution, or with different resolutions such as the input resolution from the source of the images.

The processing of images to detect the inventory items subject of the exchanges can be executed by first cropping the images, such as on bounding boxes around inventory caches such as hands, to produce cropped images, and applying the cropped images to trained inference engines. The cropped images can have a high resolution, such as the native resolution output by the sensors generating the sequences of images.

A system, method and computer program product are provided for detecting proximity events in an area of real space. The system can include a plurality of sensors to produce respective sequences of images of corresponding fields of view in the real space. The field of view of each sensor can overlap with the field of view of at least one other sensor in the plurality of sensors. The system includes logic to receive corresponding sequences of images in two dimensions from the plurality of sensors and process the two-dimensional images from overlapping sequences of images to generate positions of subjects in three dimensions in the area of real space. The system can include logic to access a database storing three dimensional positions of locations on inventory display structures which can act as sources and sinks in the area of real space. Systems and methods are provided for processing a time sequence of three-dimensional positions of subjects and inventory display structures in the area of real space to detect proximity events when distance between a source and a sink is below a pre-determined threshold. The source is a subject or an inventory display structure holding an item prior to the detected proximity event and not holding the item after the detected proximity event and the sink is a subject or an inventory display structure not holding an item prior to the detected proximity event and holding the item after the detected proximity event.

A system, method and computer program product are provided for fusing inventory events in an area of real space. The system can include a plurality of sensors to produce respective sequences of images of corresponding fields of view in the real space. The field of view of each sensor can overlap with the field of view of at least one other sensor in the plurality of sensors. The system can include logic to process sequences of images to identify locations of sources and sinks. The sources and sinks can represent subjects in three dimensions in the area of real space. The system can include redundant procedures to detect an inventory event indicating exchange of an item between a source and a sink. The system can include logic to produce streams of inventory events using the redundant procedures, the inventory events can include classification of the item exchanged. The system can include logic to match an inventory event in one stream of the inventory events with inventory events in other streams of the inventory events within a threshold of a number of frames preceding or following the detection of the inventory event. The system can generate a fused inventory event by weighted combination of the item classification of the item exchanged in the inventory event and the item exchanged in the matched inventory event.

In one embodiment, the system can include three redundant procedures to produce streams of inventory events. The first procedure processes sequences of images to identify locations of sources and sinks over time represented in the images. The sources and sink can represent subjects in the area of real space. In one embodiment, the system can also receive locations of shelves in the area of real space and use the three-dimensional positions of shelves as sources and sinks. The system can detect exchange of an item between a source and a sink when distance between the source and the sink is below a pre-determined threshold. The first procedure can produce a stream of proximity events over time. The second procedure includes logic to process bounding boxes of hands in images in the sequences of images to produce holding probabilities and classifications of items in the hands. The system includes logic to perform a time sequence analysis of the holding probabilities and classifications of items to detect region proposals events and produces a stream of region proposal events over time. The system can include a matching logic to match a proximity event in the stream of proximity events with events in the stream of region proposals events within a threshold of a number of frames preceding or following the detection of the proximity event. The system can generate a fused inventory event by weighted combination of the item classification of the item exchanged in the proximity event and the item exchanged in the matched region proposals event.

The system can include a third procedure that includes logic to mask foreground source and sinks in images in the sequences of images to generate background images of inventory display structures. The system can include logic to process background images to detect semantic diffing events including item classifications and sources and sinks associated with the classified items and producing a stream of semantic diffing events over time. The system can include a matching logic to match proximity event in the stream of proximity events with events in the stream of semantic diffing events within a threshold of a number of frames preceding or following the detection of the proximity event. The system can include logic to generate a fused inventory event by weighted combination of the item classification of the item exchanged in the proximity event and the item exchanged in the matched semantic diffing event. The system can match inventory events from two or more inventory streams detect puts, takes, touch, and transfer or exchanges or items between sources and sinks. The system can also use inventory events detected by one procedure to detect puts, takes, touch, and transfer or exchanges or items between sources and sinks.

Methods and computer program products which can be executed by computer systems are also described herein.

Other aspects and advantages of the present invention can be seen on review of the drawings, the detailed description and the claims, which follow.

### BRIEF DESCRIPTION OF THE DRAWINGS

FIG. 1 illustrates an architectural level schematic of a system in which a proximity event detection engine detects proximity events in an area of real space.

FIG. 2A is a side view of an aisle in a shopping store illustrating a camera arrangement.

FIG. 2B is a perspective view of subject interacting with items on shelves in an inventory display structure in the area of real space.

FIG. 3 illustrates a three-dimensional and a two-dimensional view of an inventory display structure (or a shelf unit).

FIG. 4A illustrates input, output and convolution layers in an example convolutional neural network to classify joints of subjects in sequences of images.

FIG. 4B is an example data structure for storing joint information.

FIG. 5A presents a graphical illustration of detection of proximity events over a period of time when the distance between inventory caches is less than a threshold distance.

FIG. 5B presents example illustrations of movement of subjects in an area of real space and detection of proximity events by calculating distances between hand joints of subjects, or other moving inventory caches.

FIG. 6 shows an example data structure for storing a subject including the information of associated joints.

FIG. 7 is a flowchart illustrating process steps for tracking subjects using the subject tracking engine of FIG. 1.

FIG. 8 is a flowchart showing more detailed process steps for a video process step of FIG. 7.

FIG. 9A is a flowchart showing a first part of more detailed process steps for the scene process of FIG. 7.

FIG. 9B is a flowchart showing a second part of more detailed process steps for the scene process of FIG. 7.

FIG. 10A is an example architecture for combining event stream from location-based put and take detection with event stream from region proposals-based (WhatCNN and WhenCNN) put and take detection.

FIG. 10B is an example architecture for combining event stream from location-based put and take detection with event stream from semantic diffing-based put and take detection.

FIG. 10C shows multiple image channels from multiple cameras and coordination logic for the subjects and their respective shopping cart data structures.

FIG. 10D is an example data structure including locations of inventory caches for storing inventory items.

FIG. 11A presents graphical illustrations for event type detection using item holding probability values before and after the occurrence of a proximity event.

FIG. 11B presents an example of an item hand-off (or item exchange) between a source subject and a sink subject resulting in a put event and a take event.

FIG. 12 is a flowchart illustrating process steps for identifying and updating subjects in the real space.

FIG. 13 is a flowchart showing process steps for processing hand joints (or moving inventory caches) of subjects to identify inventory items.

FIG. 14 is a flowchart showing process steps for time series analysis of inventory items per hand joint (or moving inventory cache) to create a shopping cart data structure per subject.

FIG. 15 is a flowchart presenting process steps for detecting proximity events.

FIG. 16 is a flowchart presenting process steps for detecting item associated with the proximity event detected in FIG. 11.

FIG. 17 is a flowchart presenting process steps for location-based events stream fusion with region proposals-based events stream and semantic diffing-based events stream.

FIG. 18A is an example of a decision tree for predicting location-based events based on distance of joints to shelves.

FIG. 18B is an example architecture for training a random forest classifier and applying the trained classifier to predict location-based events.

FIG. 19 presents an example architecture of a WhatCNN model illustrating the dimensionality of convolutional layers.

FIG. 20 presents a high-level block diagram of an embodiment of a WhatCNN model for classification of hand images.

FIG. 21 presents details of a first block of the high-level block diagram of a WhatCNN model presented in FIG. 20.

FIG. 22 presents operators in a fully connected layer in the example WhatCNN model presented in FIG. 19.

FIG. 23A presents a first part of process steps for detecting semantic diffing events.

FIG. 23B presents a second part of process steps for detecting semantic diffing events.

FIG. 24 is an example of a computer system architecture implementing the proximity events detection logic.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

### System Overview

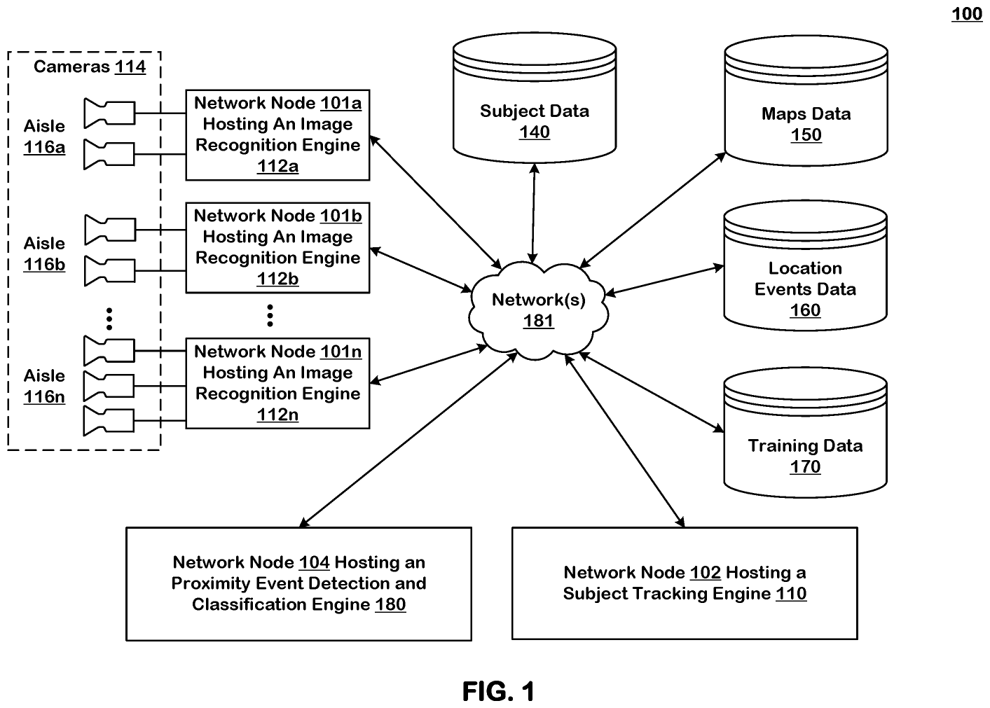

A system and various implementations of the subject technology is described with reference to FIGS. 1-24. The system and processes are described with reference to FIG. 1, an architectural level schematic of a system in accordance with an implementation. Because FIG. 1 is an architectural diagram, certain details are omitted to improve the clarity of the description.

The discussion of FIG. 1 is organized as follows. First, the elements of the system are described, followed by their interconnections. Then, the use of the elements in the system is described in greater detail.

FIG. 1 provides a block diagram level illustration of a system 100. The system 100 includes cameras 114, network nodes hosting image recognition engines 112a, 112b, and 112n, a subject tracking engine 110 deployed in a network node 102 (or nodes) on the network, a subject database 140, a maps database 150, a proximity events database 160, a training database 170, a proximity event detection engine 180 deployed in a network node 104 (or nodes), and a communication network or networks 181. The network nodes can host only one image recognition engine, or several image recognition engines as described herein. The system can also include an inventory database, a joints heuristics database and other supporting data.

As used herein, a network node is an addressable hardware device or virtual device that is attached to a network, and is capable of sending, receiving, or forwarding information over a communications channel to or from other network nodes, including channels using TCP/IP sockets for example. Examples of electronic devices which can be deployed as hardware network nodes having media access layer addresses, and supporting one or more network layer addresses, include all varieties of computers, workstations, laptop computers, handheld computers, and smartphones. Network nodes can be implemented in a cloud-based server system. More than one virtual device configured as a network node can be implemented using a single physical device.

For the sake of clarity, only three network nodes hosting image recognition engines are shown in the system 100. However, any number of network nodes hosting image recognition engines can be connected to the tracking engine 110 through the network(s) 181. Also, the image recognition engine, the tracking engine, the proximity event detection engine and other processing engines described herein can execute using more than one network node in a distributed architecture.

The interconnection of the elements of system 100 will now be described. Network(s) 181 couples the network nodes 101a, 101b, and 101n, respectively, hosting image recognition engines 112a, 112b, and 112n, the network node 102 hosting the tracking engine 110, the subject database 140, the maps database 150, the proximity events database 160, the training database 170, and the network node 104 hosting the proximity event detection engine 180. Cameras 114 are connected to the tracking engine 110 through network nodes hosting image recognition engines 112a, 112b, and 112n. In one embodiment, the cameras 114 are installed in a shopping store (such as a supermarket) such that sets of cameras 114 (two or more) with overlapping fields of view are positioned over each aisle to capture images of real space in the store. In FIG. 1, two cameras are arranged over aisle 116a, two cameras are arranged over aisle 116b, and three cameras are arranged over aisle 116n. The cameras 114 are installed over aisles with overlapping fields of view. In such an embodiment, the cameras are configured with the goal that customers moving in the aisles of the shopping store are present in the field of view of two or more cameras at any moment in time.

Cameras 114 can be synchronized in time with each other, so that images are captured at the same time, or close in time, and at the same image capture rate. The cameras 114 can send respective continuous streams of images at a predetermined rate to network nodes hosting image recognition engines 112a-112n. Images captured in all the cameras covering an area of real space at the same time, or close in time, are synchronized in the sense that the synchronized images can be identified in the processing engines as representing different views of subjects having fixed positions in the real space. For example, in one embodiment, the cameras send image frames at the rates of 30 frames per second (fps) to respective network nodes hosting image recognition engines 112a-112n. Each frame has a timestamp, identity of the camera (abbreviated as “camera_id”), and a frame identity (abbreviated as “frame_id”) along with the image data. Other embodiments of the technology disclosed can use different types of sensors such as infrared image sensors, RF image sensors, ultrasound sensors, thermal sensors, Lidars, etc., to generate this data. Multiple types of sensors can be used, including for example ultrasound or RF sensors in addition to the cameras 114 that generate RGB color output. Multiple sensors can be synchronized in time with each other, so that frames are captured by the sensors at the same time, or close in time, and at the same frame capture rate. In all of the embodiments described herein, sensors other than cameras, or sensors of multiple types, can be used to produce the sequences of images utilized. The images output by the sensors have a native resolution, where the resolution is defined by a number of pixels per row and an number of pixels per column, and by a quantization of the data of each pixel. For example an image can have a resolution of 1280 column by 720 rows of pixels over the full field of view, where each pixel includes one byte of data representing each of red, green and blue RGB colors.

Cameras installed over an aisle are connected to respective image recognition engines. For example, in FIG. 1, the two cameras installed over the aisle 116a are connected to the network node 101a hosting an image recognition engine 112a. Likewise, the two cameras installed over aisle 116b are connected to the network node 101b hosting an image recognition engine 112b. Each image recognition engine 112a-112n hosted in a network node or nodes 101a-101n, separately processes the image frames received from one camera each in the illustrated example.

In one embodiment, each image recognition engine 112a, 112b, and 112n is implemented as a deep learning algorithm such as a convolutional neural network (abbreviated CNN). In such an embodiment, the CNN is trained using a training database. In an embodiment described herein, image recognition of subjects in the real space is based on identifying and grouping joints recognizable in the images, where the groups of joints can be attributed to an individual subject. For this joints-based analysis, the training database has a large collection of images for each of the different types of joints for subjects. In the example embodiment of a shopping store, the subjects are the customers moving in the aisles between the shelves. In an example embodiment, during training of the CNN, the system 100 is referred to as a “training system”. After training the CNN using the training database, the CNN is switched to production mode to process images of customers in the shopping store in real time. In an example embodiment, during production, the system 100 is referred to as a runtime system (also referred to as an inference system). The CNN in each image recognition engine produces arrays of joints data structures for images in its respective stream of images. In an embodiment as described herein, an array of joints data structures is produced for each processed image, so that each image recognition engine 112a-112n produces an output stream of arrays of joints data structures. These arrays of joints data structures from cameras having overlapping fields of view are further processed to form groups of joints, and to identify such groups of joints as subjects.

The cameras 114 are calibrated before switching the CNN to production mode. The technology disclosed can include a calibrator that includes a logic to calibrate the cameras and stores the calibration data in a calibration database.

The tracking engine 110, hosted on the network node 102, receives continuous streams of arrays of joints data structures for the subjects from image recognition engines 112a-112n. The tracking engine 110 processes the arrays of joints data structures and translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the tracking engine 110 is stored in the subject database 140.

The tracking engine 110 uses logic to identify groups or sets of candidate joints having coordinates in real space as subjects in the real space. For the purposes of analogy, each set of candidate points is like a constellation of candidate joints at each point in time. The constellations of candidate joints can move over time.

The logic to identify sets of candidate joints comprises heuristic functions based on physical relationships amongst joints of subjects in real space. These heuristic functions are used to identify sets of candidate joints as subjects. The heuristic functions are stored in a heuristics database. The output of the subject tracking engine 110 is stored in the subject database 140. Thus, the sets of candidate joints comprise individual candidate joints that have relationships according to the heuristic parameters with other individual candidate joints and subsets of candidate joints in a given set that has been identified, or can be identified, as an individual subject.

In the example of a shopping store, shoppers (also referred to as customers or subjects) move in the aisles and in open spaces. The shoppers can take items from shelves in inventory display structures. In one example of inventory display structures, shelves are arranged at different levels (or heights) from the floor and inventory items are stocked on the shelves. The shelves can be fixed to a wall or placed as freestanding shelves forming aisles in the shopping store. Other examples of inventory display structures include, pegboard shelves, magazine shelves, lazy susan shelves, warehouse shelves, and refrigerated shelving units. The inventory items can also be stocked in other types of inventory display structures such as stacking wire baskets, dump bins, etc. The customers can also put items back on the same shelves from where they were taken or on another shelf. The system can include a maps database 150 in which locations of inventory caches on inventory display structures in the area of real space are stored. In one embodiment, three-dimensional maps of inventory display structures are stored that include the width, height, and depth information of display structures along with their positions in the area of real space. In one embodiment, the system can include or have access to memory storing a planogram identifying inventory locations in the area of real space and inventory items to be positioned on inventory locations. The planogram can also include information about portions of inventory locations designated for particular inventory items. The planogram can be produced based on a plan for the arrangement of inventory items on the inventory locations in the area of real space.

As the shoppers (or subjects) move in the shopping store, they can exchange items with other shoppers in the store. For example, a first shopper can hand-off an item to a second shopper in the shopping store. The second shopper who takes the item from the first shopper can then in turn put that item in her shopping basket, shopping cart, or simply keep the item in her hand. The second shopper can also put the item back on a shelf. The technology disclosed can detect a “proximity event” in which a moving inventory cache is positioned close to another inventory cache which can be moving or fixed, such that a distance between them is less than a threshold (e.g., 10 cm). Different values of threshold can be used greater than or less than 10 cm. In one embodiment, the technology disclosed uses locations of joints to locate inventory caches linked to shoppers to detect the proximity event. For example, the system can detect a proximity event when a left or a right hand joint of a shopper is positioned closer than the threshold to a left or right hand joint of another shopper or a shelf location. The system can also use positions of other joints such as elbow joints, or shoulder joints of subject to detect proximity events. The proximity event detection engine 180 includes the logic to detect proximity events in the area of real space. The system can store the proximity events in the proximity events database 160.

The technology disclosed can process the proximity events to detect puts and takes of inventory items. For example, when an item is handed-off from the first shopper to the second shopper, the technology disclosed can detect the proximity event. Following this, the technology disclosed can detect a type of the proximity event, e.g., put, take or touch type event. When an item is exchanged between two shoppers, the technology disclosed detects a put type event for the source shopper (or source subject) and a take type event for the sink shopper (or sink subject). The system can then process the put and take events to determine the item exchanged in the proximity event. This information is then used by the system to update the log data structures (or shopping cart data structures) of the source and sink shoppers. For example, the item exchanged is removed from the log data structure of the source shopper and added to the log data structure of the sink shopper. The system can apply the same processing logic when shoppers take items from shelves and put items back on the shelves. In this case, the exchange of items takes place between a shopper and a shelf. The system determines the item taken from the shelf or put on the shelf in the proximity event. The system then updates the log data structure of the shopper and the shelf accordingly.

The technology disclosed includes logic to detect a same event in the area of real space using multiple parallel image processing pipelines or subsystems or procedures. These redundant event detection subsystems provide a robust event detection and increases the confidence detection of puts and takes by matching events in multiple event streams. The system can then fuse events from multiple event streams using a weighted combination of items classified in event streams. In case one image processing pipeline cannot detect an event, the system can use the results from other image processing pipeline to update the log data structure of the shoppers. We refer to these events of puts and takes in the area of real space as “inventory events”. An inventory event can include information about the source and sink, classification of the item, a timestamp, a frame identifier, and a location in three dimensions in the area of real space. The multiple streams of inventory events can include a stream of location based-events, a stream of region proposals-based events, and a stream of semantic diffing-based events. We provide the details of the system architecture, including the machine learning models, system components, processing steps in the three image processing pipelines, respectively producing the three event streams. We also provide logic to fuse the events in a plurality of event streams.

The actual communication path through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript Object Notation (JSON), Extensible Markup Language (XML), Simple Object Access Protocol (SOAP), Java™ Message Service (JMS), and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming, MPI primitives, etc. or different scalable batch and stream management systems like Apache Storm™, Apache Spark™, Apache Kafka™, Apache Flink™ Truviso™, Amazon Elasticsearch Service™, Amazon Web Services™ (AWS), IBM Info-Sphere™, Borealis™, and Yahoo! S4™.

### Camera Arrangement

The cameras 114 are arranged to track multi-joint entities (or subjects) in a three-dimensional (abbreviated as 3D) real space. In the example embodiment of the shopping store, the real space can include the area of the shopping store where items for sale are stacked in shelves. A point in the real space can be represented by an (x, y, z) coordinate system. Each point in the area of real space for which the system is deployed is covered by the fields of view of two or more cameras 114.

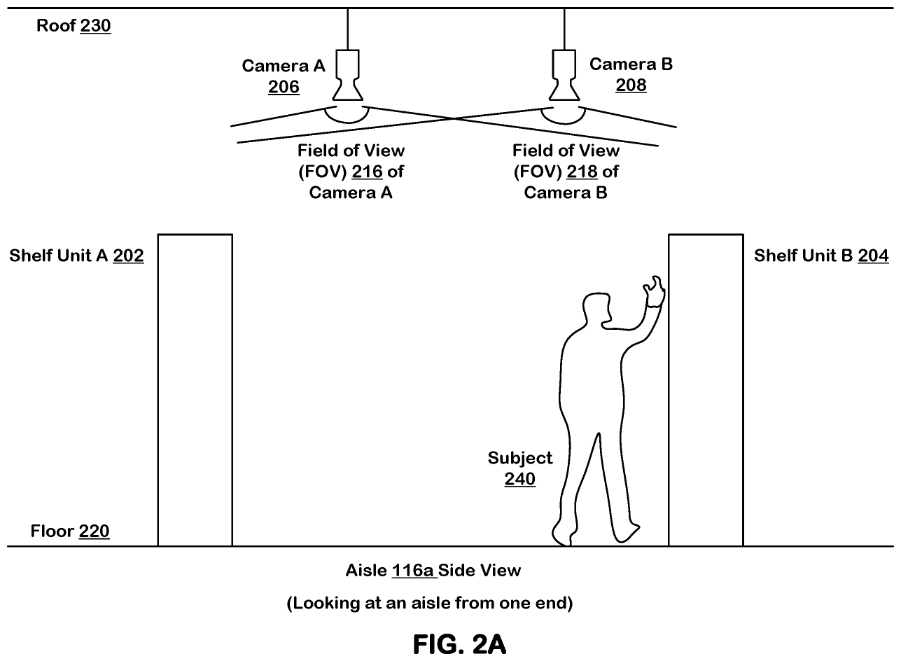

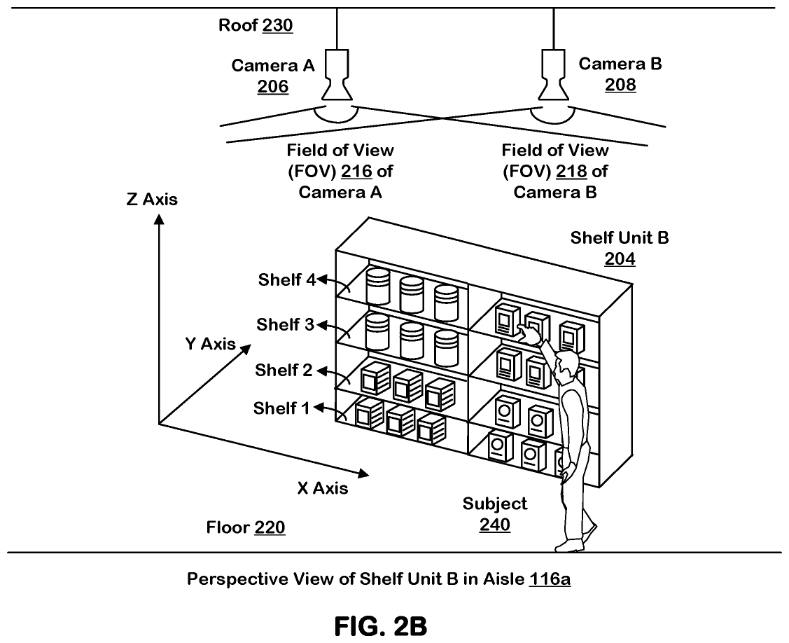

In a shopping store, the shelves and other inventory display structures can be arranged in a variety of manners, such as along the walls of the shopping store, or in rows forming aisles or a combination of the two arrangements. FIG. 2A shows an arrangement of shelves, forming an aisle 116a, viewed from one end of the aisle 116a. Two cameras, camera A 206 and camera B 208 are positioned over the aisle 116a at a predetermined distance from a roof 230 and a floor 220 of the shopping store above the inventory display structures such as shelves. The cameras 114 comprise cameras disposed over and having fields of view encompassing respective parts of the inventory display structures and floor area in the real space. If we view the arrangement of cameras from the top, the camera A 206 is positioned at a predetermined distance from the shelf A 202 and the camera B 208 is positioned at a predetermined distance from the shelf B 204. In another embodiment, in which more than two cameras are positioned over an aisle, the cameras are positioned at equal distances from each other. In such an embodiment, two cameras are positioned close to the opposite ends and a third camera is positioned in the middle of the aisle. It is understood that a number of different camera arrangements are possible.

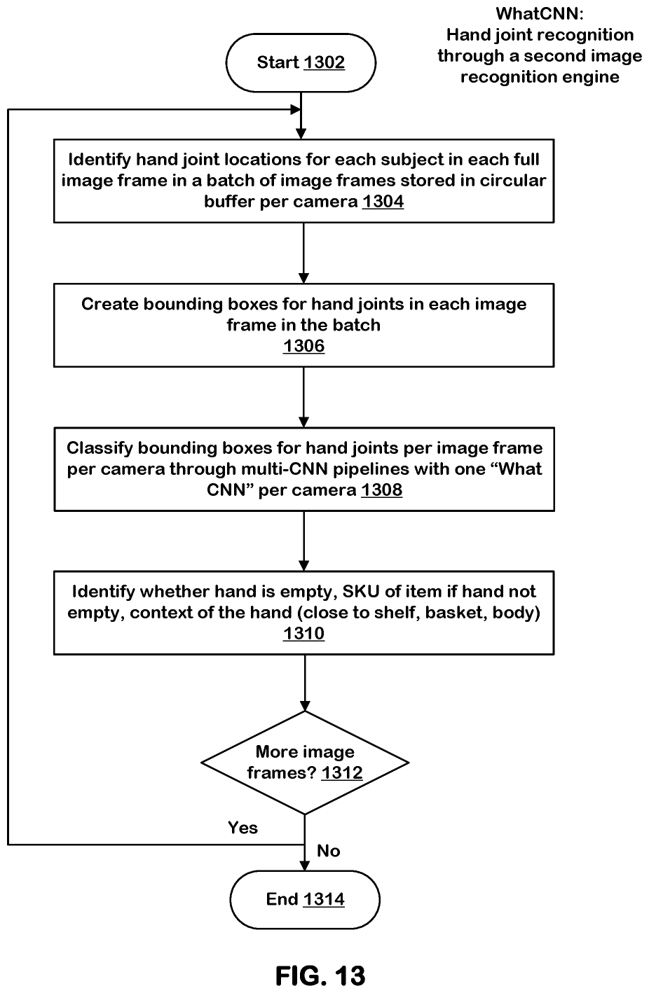

The coordinates in real space of members of a set of candidate joints, identified as a subject, identify locations in the floor area of the subject. In the example embodiment of the shopping store, the real space can include all of the floor 220 in the shopping store from which inventory can be accessed. Cameras 114 are placed and oriented such that areas of the floor 220 and shelves can be seen by at least two cameras. The cameras 114 also cover at least part of the shelves 202 and 204 and floor space in front of the shelves 202 and 204. Camera angles are selected to have both steep perspective, straight down, and angled perspectives that give more full body images of the customers. In one example embodiment, the cameras 114 are configured at an eight (8) foot height or higher throughout the shopping store. FIG. 13 presents an illustration of such an embodiment.

In FIG. 2A, the cameras 206 and 208 have overlapping fields of view, covering the space between a shelf A 202 and a shelf B 204 with overlapping fields of view 216 and 218, respectively. A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration.

FIG. 2B is a perspective view of the shelf unit B 204 with four shelves, shelf 1, shelf 2, shelf 3, and shelf 4 positioned at different levels from the floor. The inventory items are stocked on the shelves. A subject 240 is reaching out to take an item from the right-hand side portion of the shelf 4. A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration.

### Camera Calibration

The system can perform two types of calibrations: internal and external. In internal calibration, the internal parameters of the cameras 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000.

In external calibration, the external camera parameters are calibrated in order to generate mapping parameters for translating the 2D image data into 3D coordinates in real space. In one embodiment, one subject, such as a person, is introduced into the real space. The subject moves through the real space on a path that passes through the field of view of each of the cameras 114. At any given point in the real space, the subject is present in the fields of view of at least two cameras forming a 3D scene. The two cameras, however, have a different view of the same 3D scene in their respective two-dimensional (2D) image planes. A feature in the 3D scene such as a left-wrist of the subject is viewed by two cameras at different positions in their respective 2D image planes.

A point correspondence is established between every pair of cameras with overlapping fields of view for a given scene. Since each camera has a different view of the same 3D scene, a point correspondence is two pixel locations (one location from each camera with overlapping field of view) that represent the projection of the same point in the 3D scene. Many point correspondences are identified for each 3D scene using the results of the image recognition engines 112a-112n for the purposes of the external calibration. The image recognition engines identify the position of a joint as (x, y) coordinates, such as row and column numbers, of pixels in the 2D image planes of respective cameras 114. In one embodiment, a joint is one of 19 different types of joints of the subject. As the subject moves through the fields of view of different cameras, the tracking engine 110 receives (x, y) coordinates of each of the 19 different types of joints of the subject used for the calibration from cameras 114 per image.

For example, consider an image from a camera A and an image from a camera B both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one subject in the field of view of camera A and camera B during calibration, key joints of this subject are identified, for example, the center of left wrist. If these key joints are visible in image frames from both camera A and camera B then it is assumed that these represent corresponding points. This process is repeated for many image frames to build up a large collection of corresponding points for all pairs of cameras with overlapping fields of view. In one embodiment, images are streamed off of all cameras at a rate of 30 FPS (frames per second) or more and a resolution of 1280 by 720 pixels in full RGB (red, green, and blue) color. These images are in the form of one-dimensional arrays (also referred to as flat arrays).

In some embodiments, the resolution of the images is reduced before applying the images to the inference engines used to detect the joints in the images, such as a dropping every other pixel in a row, by reducing the size of the data for each pixel, or otherwise, so the input images at the inference engine have smaller amounts of data, and so the inference engines can operate faster.

The large number of images collected above for a subject can be used to determine corresponding points between cameras with overlapping fields of view. Consider two cameras A and B with overlapping field of view. The plane passing through camera centers of cameras A and B and the joint location (also referred to as feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the tracking engine 110 to identify the same joints in outputs (arrays of joints data structures) of different image recognition engines 112a-112n, processing images of cameras 114 with overlapping fields of view. The results of the internal and external camera calibration are stored in the calibration database 170.

A variety of techniques for determining the relative positions of the points in images of cameras 114 in the real space can be used. For example, Longuet-Higgins published, “A computer algorithm for reconstructing a scene from two projections” in Nature, Volume 293, 10 Sep. 1981. This paper presents computing a three-dimensional structure of a scene from a correlated pair of perspective projections when spatial relationship between the two projections is unknown. The Longuet-Higgins paper presents a technique to determine the position of each camera in the real space with respect to other cameras. Additionally, their technique allows triangulation of a subject in the real space, identifying the value of the z-coordinate (height from the floor) using images from cameras 114 with overlapping fields of view. An arbitrary point in the real space, for example, the end of a shelf in one corner of the real space, is designated as a (0, 0, 0) point on the (x, y, z) coordinate system of the real space.

In an embodiment of the technology, the parameters of the external calibration are stored in two data structures. The first data structure stores intrinsic parameters. The intrinsic parameters represent a projective transformation from the 3D coordinates into 2D image coordinates. The first data structure contains intrinsic parameters per camera as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the cameras 114.

```
{
      1: {
            K: [[x, x, x], [x, x, x], [x, x, x]],
            distortion_coefficients: [x, x, x, x, x, x, x, x]
      },
      ......
}
```

The second data structure stores per pair of cameras: a 3×3 fundamental matrix (F), a 3×3 essential matrix (E), a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two images of the same scene that constrains where the projection of points from the scene can occur in both images. Essential matrix is also a relationship between two images of the same scene with the condition that the cameras are calibrated. The projection matrix gives a vector space projection from 3D real space to a subspace. The rotation matrix is used to perform a rotation in Euclidean space. Translation vector “t” represents a geometric transformation that moves every point of a figure or a space by the same distance in a given direction. The homography_floor_coefficients are used to combine images of features of subjects on the floor 220 viewed by cameras with overlapping fields of views. The second data structure is shown below. Similar data is stored for all pairs of cameras. As indicated previously, the x's represents numeric floating point numbers.

```
  {
    1: {
        2: {
              F: [[x, x, x], [x, x, x], [x, x, x]],
              E: [[x, x, x], [x, x, x], [x, x, x]],
              P: [[x, x, x, x], [x, x, x, x], [x, x, x, x]],
              R: [[x, x, x], [x, x, x], [x, x, x]],
              t: [x, x, x],
              homography_floor_ coefficients: [x, x, x, x, x, x, x, x]
        }
    },
    ......
  }
```

### Two-Dimensional and Three-Dimensional Maps

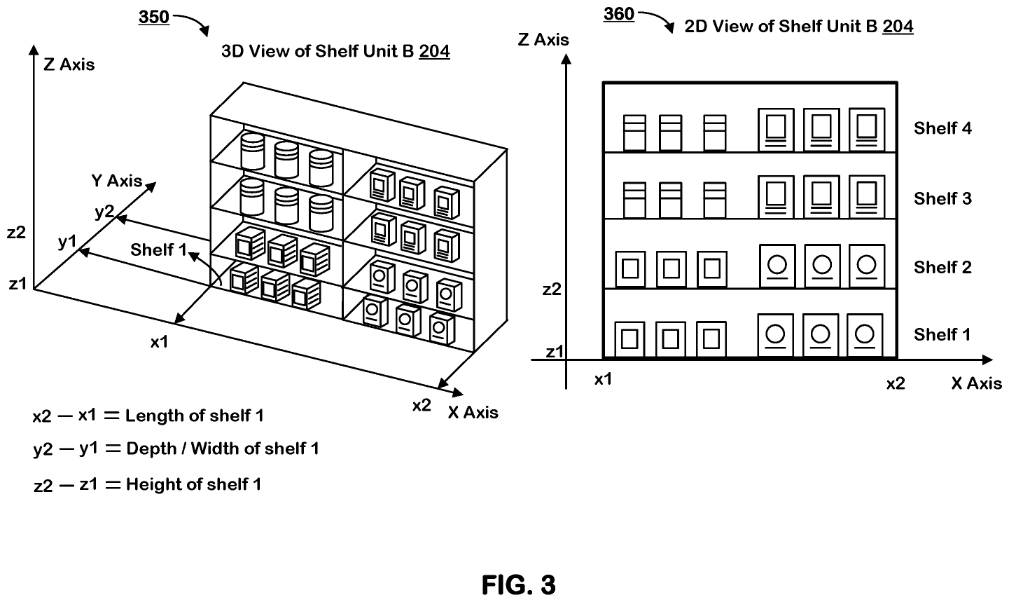

An inventory cache, such as location on a shelf, in a shopping store can be identified by a unique identifier in a map database (e.g., shelf_id). Similarly, a shopping store can also be identified by a unique identifier (e.g., store_id) in a map database. The two-dimensional (2D) and three-dimensional (3D) maps database 150 identifies locations of inventory caches in the area of real space along the respective coordinates. For example, in a 2D map, the locations in the maps define two dimensional regions on the plane formed perpendicular to the floor 220 i.e., XZ plane as shown in illustration 360 in FIG. 3. The map defines an area for inventory locations or shelves where inventory items are positioned. In FIG. 3, a 2D location of the shelf unit shows an area formed by four coordinate positions (x1, y1), (x1, y2), (x2, y2), and (x2, y1). These coordinate positions define a 2D region on the floor 220 where the shelf is located. Similar 2D areas are defined for all inventory display structure locations, entrances, exits, and designated unmonitored locations in the shopping store. This information is stored in the maps database 150.

In a 3D map, the locations in the map define three dimensional regions in the 3D real space defined by X, Y, and Z coordinates. The map defines a volume for inventory locations where inventory items are positioned. In illustration 350 in FIG. 3, a 3D view 350 of shelf 1, at the bottom of shelf unit B 204, shows a volume formed by eight coordinate positions (x1, y1, z1), (x1, y1, z2), (x1, y2, z1), (x1, y2, z2), (x2, y1, z1), (x2, y1, z2), (x2, y2, z1), (x2, y2, z2) defining a 3D region in which inventory items are positioned on the shelf 1. Similar 3D regions are defined for inventory locations in all shelf units in the shopping store and stored as a 3D map of the real space (shopping store) in the maps database 150. The coordinate positions along the three axes can be used to calculate length, depth and height of the inventory locations as shown in FIG. 3.

In one embodiment, the map identifies a configuration of units of volume which correlate with portions of inventory locations on the inventory display structures in the area of real space. Each portion is defined by starting and ending positions along the three axes of the real space. Like 2D maps, the 3D maps can also store locations of all inventory display structure locations, entrances, exits and designated unmonitored locations in the shopping store.

The items in a shopping store are arranged in some embodiments according to a planogram which identifies the inventory locations (such as shelves) on which a particular item is planned to be placed. For example, as shown in an illustration 350 in FIG. 3, a left half portion of shelf 3 and shelf 4 are designated for an item (which is stocked in the form of cans). The system can include pre-defined planograms for the shopping store which include positions of items on the shelves in the store. The planograms can be stored in the maps database 150. In one embodiment, the system can include logic to update the positions of items on shelves in real time or near real time.

### Convolutional Neural Network

The image recognition engines in the processing platforms receive a continuous stream of images at a predetermined rate. In one embodiment, the image recognition engines comprise convolutional neural networks (abbreviated CNN).

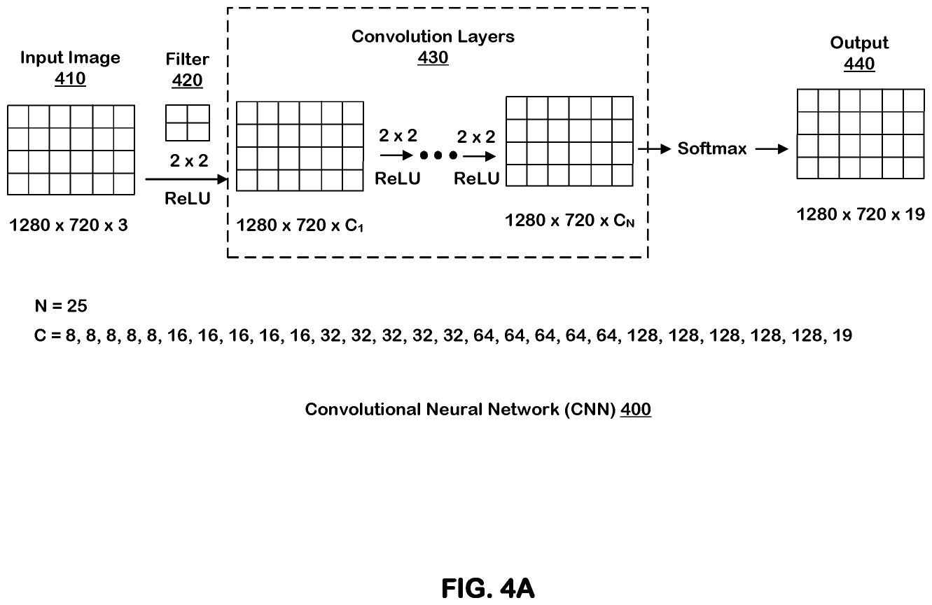

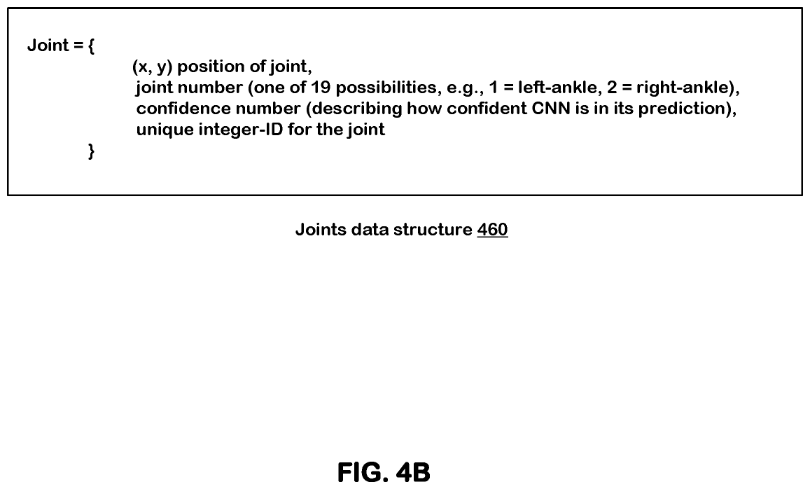

FIG. 4A illustrates processing of image frames by an example CNN referred to by a numeral 400. The input image 410 is a matrix consisting of image pixels arranged in rows and columns. In one embodiment, the input image 410 has a width of 1280 pixels, height of 720 pixels and 3 channels red, blue, and green also referred to as RGB. The channels can be imagined as three 1280×720 two-dimensional images stacked over one another. Therefore, the input image has dimensions of 1280×720×3 as shown in FIG. 4A. As mentioned above, in some embodiments, the images are filtered to provide images with reduced resolution for input to the CNN.

A 2×2 filter 420 is convolved with the input image 410. In this embodiment, no padding is applied when the filter is convolved with the input. Following this, a nonlinearity function is applied to the convolved image. In the present embodiment, rectified linear unit (ReLU) activations are used. Other examples of nonlinear functions include sigmoid, hyperbolic tangent (tan h) and variations of ReLU such as leaky ReLU. A search is performed to find hyper-parameter values. The hyper-parameters are C₁, C₂, . . . , C_{N} where C_{N} means the number of channels for convolution layer “N”. Typical values of N and C are shown in FIG. 4A. There are twenty five (25) layers in the CNN as represented by N equals 25. The values of C are the number of channels in each convolution layer for layers 1 to 25. In other embodiments, additional features are added to the CNN 400 such as residual connections, squeeze-excitation modules, and multiple resolutions.

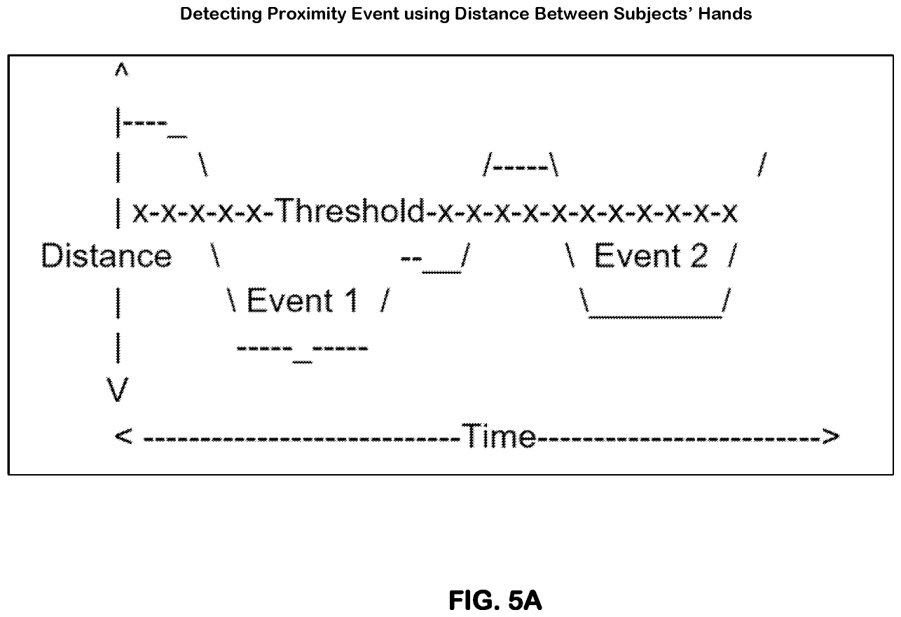

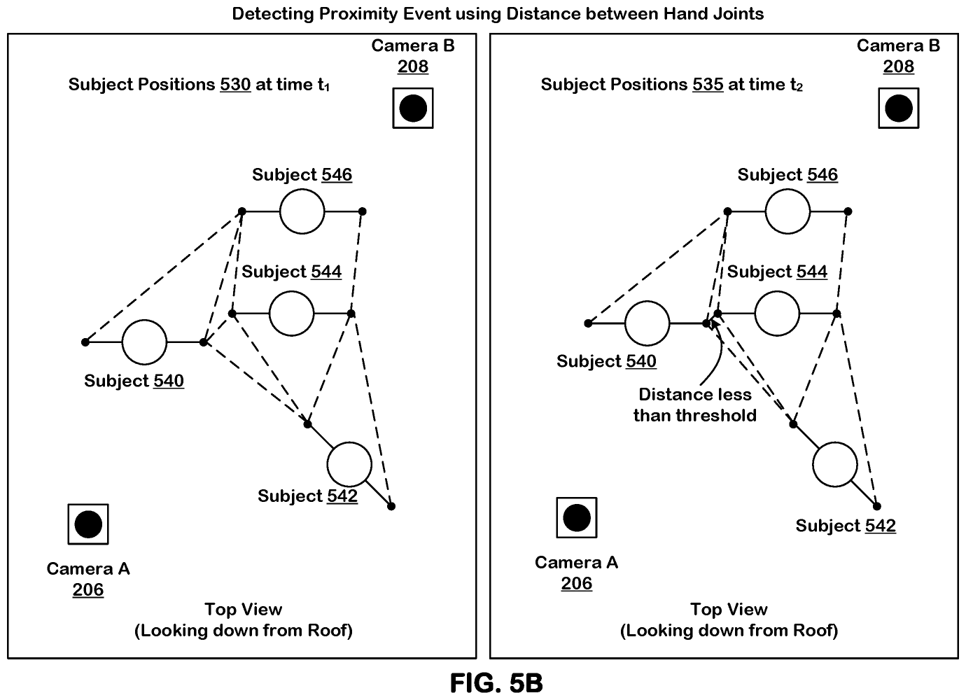

In typical CNNs used for image classification, the size of the image (width and height dimensions) is reduced as the image is processed through convolution layers. That is helpful in feature identification as the goal is to predict a class for the input image. However, in the illustrated embodiment, the size of the input image (i.e. image width and height dimensions) is not reduced, as the goal is to not only to identify a joint (also referred to as a feature) in the image frame, but also to identify its location in the image so it can be mapped to coordinates in the real space. Therefore, as shown FIG. 5, the width and height dimensions of the image remain unchanged relative to the input images (with full or reduced resolution) as the processing proceeds through convolution layers of the CNN, in this example.

In one embodiment, the CNN 400 identifies one of the 19 possible joints of the subjects at each element of the image. The possible joints can be grouped in two categories: foot joints and non-foot joints. The 19^{th} type of joint classification is for all non-joint features of the subject (i.e. elements of the image not classified as a joint).

Foot Joints:
Ankle joint (left and right)

Non-foot Joints:
Neck
Nose
Eyes (left and right)
Ears (left and right)
Shoulders (left and right)
Elbows (left and right)
Wrists (left and right)
Hip (left and right)
Knees (left and right)

Not a joint

As can be seen, a “joint” for the purposes of this description is a trackable feature of a subject in the real space. A joint may correspond to physiological joints on the subjects, or other features such as the eye, or nose.

The first set of analyses on the stream of input images identifies trackable features of subjects in real space. In one embodiment, this is referred to as “joints analysis”. In such an embodiment, the CNN used for joints analysis is referred to as “joints CNN”. In one embodiment, the joints analysis is performed thirty times per second over thirty frames per second received from the corresponding camera. The analysis is synchronized in time i.e., at 1/30^{th} of a second, images from all cameras 114 are analyzed in the corresponding joints CNNs to identify joints of all subjects in the real space. The results of this analysis of the images from a single moment in time from plural cameras is stored as a “snapshot”.

A snapshot can be in the form of a dictionary containing arrays of joints data structures from images of all cameras 114 at a moment in time, representing a constellation of candidate joints within the area of real space covered by the system. In one embodiment, the snapshot is stored in the subject database 140.

In this example CNN, a softmax function is applied to every element of the image in the final layer of convolution layers 430. The softmax function transforms a K-dimensional vector of arbitrary real values to a K-dimensional vector of real values in the range [0, 1] that add up to 1. In one embodiment, an element of an image is a single pixel. The softmax function converts the 19-dimensional array (also referred to a 19-dimensional vector) of arbitrary real values for each pixel to a 19-dimensional confidence array of real values in the range [0, 1] that add up to 1. The 19 dimensions of a pixel in the image frame correspond to the 19 channels in the final layer of the CNN which further correspond to 19 types of joints of the subjects.

A large number of picture elements can be classified as one of each of the 19 types of joints in one image depending on the number of subjects in the field of view of the source camera for that image.

The image recognition engines 112a-112n process images to generate confidence arrays for elements of the image. A confidence array for a particular element of an image includes confidence values for a plurality of joint types for the particular element. Each one of the image recognition engines 112a-112n, respectively, generates an output matrix 440 of confidence arrays per image. Finally, each image recognition engine generates arrays of joints data structures corresponding to each output matrix 540 of confidence arrays per image. The arrays of joints data structures corresponding to particular images classify elements of the particular images by joint type, time of the particular image, and coordinates of the element in the particular image. A joint type for the joints data structure of the particular elements in each image is selected based on the values of the confidence array.

Each joint of the subjects can be considered to be distributed in the output matrix 440 as a heat map. The heat map can be resolved to show image elements having the highest values (peak) for each joint type. Ideally, for a given picture element having high values of a particular joint type, surrounding picture elements outside a range from the given picture element will have lower values for that joint type, so that a location for a particular joint having that joint type can be identified in the image space coordinates. Correspondingly, the confidence array for that image element will have the highest confidence value for that joint and lower confidence values for the remaining 18 types of joints.

In one embodiment, batches of images from each camera 114 are processed by respective image recognition engines. For example, six contiguously timestamped images are processed sequentially in a batch to take advantage of cache coherence. The parameters for one layer of the CNN 400 are loaded in memory and applied to the batch of six image frames. Then the parameters for the next layer are loaded in memory and applied to the batch of six images. This is repeated for all convolution layers 430 in the CNN 400. The cache coherence reduces processing time and improves performance of the image recognition engines.

In one such embodiment, referred to as three-dimensional (3D) convolution, a further improvement in performance of the CNN 400 is achieved by sharing information across image frames in the batch. This helps in more precise identification of joints and reduces false positives. For examples, features in the image frames for which pixel values do not change across the multiple image frames in a given batch are likely static objects such as a shelf. The change of values for the same pixel across image frames in a given batch indicates that this pixel is likely a joint. Therefore, the CNN 400 can focus more on processing that pixel to accurately identify the joint identified by that pixel.

### Joints Data Structure

The output of the CNN 400 is a matrix of confidence arrays for each image per camera. The matrix of confidence arrays is transformed into an array of joints data structures. A joints data structure 460 as shown in FIG. 4B is used to store the information of each joint. The joints data structure 460 identifies x and y positions of the element in the particular image in the 2D image space of the camera from which the image is received. A joint number identifies the type of joint identified. For example, in one embodiment, the values range from 1 to 19. A value of 1 indicates that the joint is a left-ankle, a value of 2 indicates the joint is a right-ankle and so on. The type of joint is selected using the confidence array for that element in the output matrix 440. For example, in one embodiment, if the value corresponding to the left-ankle joint is highest in the confidence array for that image element, then the value of the joint number is “1”.

A confidence number indicates the degree of confidence of the CNN 400 in predicting that joint. If the value of confidence number is high, it means the CNN is confident in its prediction. An integer-Id is assigned to the joints data structure to uniquely identify it. Following the above mapping, the output matrix 440 of confidence arrays per image is converted into an array of joints data structures for each image.

The image recognition engines 112a-112n receive the sequences of images from cameras 114 and process images to generate corresponding arrays of joints data structures as described above. An array of joints data structures for a particular image classifies elements of the particular image by joint type, time of the particular image, and the coordinates of the elements in the particular image. In one embodiment, the image recognition engines 112a-112n are convolutional neural networks CNN 400, the joint type is one of the 19 types of joints of the subjects, the time of the particular image is the timestamp of the image generated by the source camera 114 for the particular image, and the coordinates (x, y) identify the position of the element on a 2D image plane.

In one embodiment, the joints analysis includes performing a combination of k-nearest neighbors, mixture of Gaussians, various image morphology transformations, and joints CNN on each input image. The result comprises arrays of joints data structures which can be stored in the form of a bit mask in a ring buffer that maps image numbers to bit masks at each moment in time.

### Tracking Engine

The subject tracking engine 110 is configured to receive arrays of joints data structures generated by the image recognition engines 112a-112n corresponding to images in sequences of images from cameras having overlapping fields of view. The arrays of joints data structures per image are sent by image recognition engines 112a-112n to the tracking engine 110 via the network(s) 181 as shown in FIG. 1. The tracking engine 110 translates the coordinates of the elements in the arrays of joints data structures corresponding to images in different sequences into candidate joints having coordinates in the real space. The tracking engine 110 comprises logic to identify sets of candidate joints having coordinates in real space (constellations of joints) as subjects in the real space. In one embodiment, the tracking engine 110 accumulates arrays of joints data structures from the image recognition engines for all the cameras at a given moment in time and stores this information as a dictionary in the subject database 140, to be used for identifying a constellation of candidate joints. The dictionary can be arranged in the form of key-value pairs, where keys are camera ids and values are arrays of joints data structures from the camera. In such an embodiment, this dictionary is used in heuristics-based analysis to determine candidate joints and for assignment of joints to subjects. In such an embodiment, a high-level input, processing and output of the tracking engine 110 is illustrated in table 1.

TABLE 1
Inputs, processing and outputs from subject tracking
engine 110 in an example embodiment.

| Inputs | Processing | Output |
|---|---|---|
| Arrays of joints data | Create joints dictionary | List of subjects |
| structures per image and for | Re-project joint | in the real space |
| each joints data structure | positions in the fields of | at a moment in |
| Unique ID | view of cameras with | time |
| Confidence number | overlapping fields of | |
| Joint number | view to candidate joints | |
| (x, y) position in | | |
| image space | | |

### Grouping Candidate Joints

The subject tracking engine 110 receives arrays of joints data structures along two dimensions: time and space. Along the time dimension, the tracking engine receives sequentially timestamped arrays of joints data structures processed by image recognition engines 112a-112n per camera. The joints data structures include multiple instances of the same joint of the same subject over a period of time in images from cameras having overlapping fields of view. The (x, y) coordinates of the element in the particular image will usually be different in sequentially timestamped arrays of joints data structures because of the movement of the subject to which the particular joint belongs. For example, twenty picture elements classified as left-wrist joints can appear in many sequentially timestamped images from a particular camera, each left-wrist joint having a position in real space that can be changing or unchanging from image to image. As a result, twenty left-wrist joints data structures 600 in many sequentially timestamped arrays of joints data structures can represent the same twenty joints in real space over time.

Because multiple cameras having overlapping fields of view cover each location in the real space, at any given moment in time, the same joint can appear in images of more than one of the cameras 114. The cameras 114 are synchronized in time, therefore, the tracking engine 110 receives joints data structures for a particular joint from multiple cameras having overlapping fields of view, at any given moment in time. This is the space dimension, the second of the two dimensions: time and space, along which the subject tracking engine 110 receives data in arrays of joints data structures.

The subject tracking engine 110 uses an initial set of heuristics stored in a heuristics database to identify candidate joints data structures from the arrays of joints data structures. The goal is to minimize a global metric over a period of time. A global metric calculator can calculate the global metric. The global metric is a summation of multiple values described below. Intuitively, the value of the global metric is minimum when the joints in arrays of joints data structures received by the subject tracking engine 110 along the time and space dimensions are correctly assigned to respective subjects. For example, consider the embodiment of the shopping store with customers moving in the aisles. If the left-wrist of a customer A is incorrectly assigned to a customer B, then the value of the global metric will increase. Therefore, minimizing the global metric for each joint for each customer is an optimization problem. One option to solve this problem is to try all possible connections of joints. However, this can become intractable as the number of customers increases.

A second approach to solve this problem is to use heuristics to reduce possible combinations of joints identified as members of a set of candidate joints for a single subject. For example, a left-wrist joint cannot belong to a subject far apart in space from other joints of the subject because of known physiological characteristics of the relative positions of joints. Similarly, a left-wrist joint having a small change in position from image to image is less likely to belong to a subject having the same joint at the same position from an image far apart in time, because the subjects are not expected to move at a very high speed. These initial heuristics are used to build boundaries in time and space for constellations of candidate joints that can be classified as a particular subject. The joints in the joints data structures within a particular time and space boundary are considered as “candidate joints” for assignment to sets of candidate joints as subjects present in the real space. These candidate joints include joints identified in arrays of joints data structures from multiple images from a same camera over a period of time (time dimension) and across different cameras with overlapping fields of view (space dimension).

Foot Joints

The joints can be divided for the purposes of a procedure for grouping the joints into constellations, into foot and non-foot joints as shown above in the list of joints. The left and right-ankle joint types in the current example, are considered foot joints for the purpose of this procedure. The subject tracking engine 110 can start identification of sets of candidate joints of particular subjects using foot joints. In the embodiment of the shopping store, the feet of the customers are on the floor 220 as shown in FIG. 2A. The distance of the cameras 114 to the floor 220 is known. Therefore, when combining the joints data structures of foot joints from arrays of data joints data structures corresponding to images of cameras with overlapping fields of view, the subject tracking engine 110 can assume a known depth (distance along z axis). The value depth for foot joints is zero i.e. (x, y, 0) in the (x, y, z) coordinate system of the real space. Using this information, the subject tracking engine 110 applies homographic mapping to combine joints data structures of foot joints from cameras with overlapping fields of view to identify the candidate foot joint. Using this mapping, the location of the joint in (x, y) coordinates in image space is converted to the location in the (x, y, z) coordinates in the real space, resulting in a candidate foot joint. This process is performed separately to identify candidate left and right foot joints using respective joints data structures.

Following this, the subject tracking engine 110 can combine a candidate left foot joint and a candidate right foot joint (assigns them to a set of candidate joints) to create a subject. Other joints from the galaxy of candidate joints can be linked to the subject to build a constellation of some or all of the joint types for the created subject.

If there is only one left candidate foot joint and one right candidate foot joint then it means there is only one subject in the particular space at the particular time. The tracking engine 110 creates a new subject having the left and the right candidate foot joints belonging to its set of joints. The subject is saved in the subject database 140. If there are multiple candidate left and right foot joints, then the global metric calculator attempts to combine each candidate left foot joint to each candidate right foot joint to create subjects such that the value of the global metric is minimized.

Non-Foot Joints

To identify candidate non-foot joints from arrays of joints data structures within a particular time and space boundary, the subject tracking engine 110 uses the non-linear transformation (also referred to as a fundamental matrix) from any given camera A to its neighboring camera B with overlapping fields of view. The non-linear transformations are calculated using a single multi joint subject and stored in a calibration database as described above. For example, for two cameras A and B with overlapping fields of view, the candidate non-foot joints are identified as follows. The non-foot joints in arrays of joints data structures corresponding to elements in image frames from camera A are mapped to epipolar lines in synchronized image frames from camera B. A joint (also referred to as a feature in machine vision literature) identified by a joints data structure in an array of joints data structures of a particular image of camera A will appear on a corresponding epipolar line if it appears in the image of camera B. For example, if the joint in the joints data structure from camera A is a left-wrist joint, then a left-wrist joint on the epipolar line in the image of camera B represents the same left-wrist joint from the perspective of camera B. These two points in images of cameras A and B are projections of the same point in the 3D scene in real space and are referred to as a “conjugate pair”.

Machine vision techniques such as the technique by Longuet-Higgins published in the paper, titled, “A computer algorithm for reconstructing a scene from two projections” in Nature, Volume 293, 10 Sep. 1981, are applied to conjugate pairs of corresponding points to determine height of joints from the floor 220 in the real space. Application of the above method requires predetermined mapping between cameras with overlapping fields of view. That data can be stored in a calibration database as non-linear functions determined during the calibration of the cameras 114 described above.

The subject tracking engine 110 receives the arrays of joints data structures corresponding to images in sequences of images from cameras having overlapping fields of view, and translates the coordinates of the elements in the arrays of joints data structures corresponding to images in different sequences into candidate non-foot joints having coordinates in the real space. The identified candidate non-foot joints are grouped into sets of subjects having coordinates in real space using a global metric calculator. The global metric calculator can calculate the global metric value and attempt to minimize the value by checking different combinations of non-foot joints. In one embodiment, the global metric is a sum of heuristics organized in four categories. The logic to identify sets of candidate joints comprises heuristic functions based on physical relationships among joints of subjects in real space to identify sets of candidate joints as subjects. Examples of physical relationships among joints are considered in the heuristics as described below.

First Category of Heuristics

The first category of heuristics includes metrics to ascertain similarity between two proposed subject-joint locations in the same camera view at the same or different moments in time. In one embodiment, these metrics are floating point values, where higher values mean two lists of joints are likely to belong to the same subject. Consider the example embodiment of the shopping store, the metrics determine the distance between a customer's same joints in one camera from one image to the next image along the time dimension. Given a customer A in the field of view of the camera, the first set of metrics determines the distance between each of person A's joints from one image from the camera to the next image from the same camera. The metrics are applied to joints data structures 460 in arrays of joints data structures per image from cameras 114.

In one embodiment, two example metrics in the first category of heuristics are listed below:
1. The inverse of the Euclidean 2D coordinate distance (using x, y coordinate values for a particular image from a particular camera) between the left ankle-joint of two subjects on the floor and the right ankle-joint of the two subjects on the floor summed together.
2. The sum of the inverse of Euclidean 2D coordinate distance between every pair of non-foot joints of subjects in the image frame.

Second Category of Heuristics

The second category of heuristics includes metrics to ascertain similarity between two proposed subject-joint locations from the fields of view of multiple cameras at the same moment in time. In one embodiment, these metrics are floating point values, where higher values mean two lists of joints are likely to belong to the same subject. Consider the example embodiment of the shopping store, the second set of metrics determines the distance between a customer's same joints in image frames from two or more cameras (with overlapping fields of view) at the same moment in time.

In one embodiment, two example metrics in the second category of heuristics are listed below:
1. The inverse of the Euclidean 2D coordinate distance (using x, y coordinate values for a particular image from a particular camera) between the left ankle-joint of two subjects on the floor and the right ankle-joint of the two subjects on the floor summed together. The first subject's ankle-joint locations are projected to the camera in which the second subject is visible through homographic mapping.
2. The sum of all pairs of joints of inverse of Euclidean 2D coordinate distance between a line and a point, where the line is the epipolar line of a joint of an image from a first camera having a first subject in its field of view to a second camera with a second subject in its field of view and the point is the joint of the second subject in the image from the second camera.

Third Category of Heuristics

The third category of heuristics include metrics to ascertain similarity between all joints of a proposed subject-joint location in the same camera view at the same moment in time. Consider the example embodiment of the shopping store, this category of metrics determines distance between joints of a customer in one frame from one camera.

Fourth Category of Heuristics

The fourth category of heuristics includes metrics to ascertain dissimilarity between proposed subject-joint locations. In one embodiment, these metrics are floating point values. Higher values mean two lists of joints are more likely to not be the same subject. In one embodiment, two example metrics in this category include:

1. The distance between neck joints of two proposed subjects.
2. The sum of the distance between pairs of joints between two subjects.

In one embodiment, various thresholds which can be determined empirically are applied to the above listed metrics as described below:

1. Thresholds to decide when metric values are small enough to consider that a joint belongs to a known subject.
2. Thresholds to determine when there are too many potential candidate subjects that a joint can belong to with too good of a metric similarity score.
3. Thresholds to determine when collections of joints over time have high enough metric similarity to be considered a new subject, previously not present in the real space.
4. Thresholds to determine when a subject is no longer in the real space.
5. Thresholds to determine when the tracking engine 110 has made a mistake and has confused two subjects.

The subject tracking engine 110 includes logic to store the sets of joints identified as subjects. The logic to identify sets of candidate joints includes logic to determine whether a candidate joint identified in images taken at a particular time corresponds with a member of one of the sets of candidate joints identified as subjects in preceding images. In one embodiment, the subject tracking engine 110 compares the current joint-locations of a subject with previously recorded joint-locations of the same subject at regular intervals. This comparison allows the tracking engine 110 to update the joint locations of subjects in the real space. Additionally, using this, the subject tracking engine 110 identifies false positives (i.e., falsely identified subjects) and removes subjects no longer present in the real space.

Consider the example of the shopping store embodiment, in which the subject tracking engine 110 created a customer (subject) at an earlier moment in time, however, after some time, the subject tracking engine 110 does not have current joint-locations for that particular customer. It means that the customer was incorrectly created. The subject tracking engine 110 deletes incorrectly generated subjects from the subject database 140. In one embodiment, the subject tracking engine 110 also removes positively identified subjects from the real space using the above described process. Consider the example of the shopping store, when a customer leaves the shopping store, the subject tracking engine 110 deletes the corresponding customer record from the subject database 140. In one such embodiment, the subject tracking engine 110 updates this customer's record in the subject database 140 to indicate that “customer has left the store”.

In one embodiment, the subject tracking engine 110 attempts to identify subjects by applying the foot and non-foot heuristics simultaneously. This results in “islands” of connected joints of the subjects. As the subject tracking engine 110 processes further arrays of joints data structures along the time and space dimensions, the size of the islands increases. Eventually, the islands of joints merge to other islands of joints forming subjects which are then stored in the subject database 140. In one embodiment, the subject tracking engine 110 maintains a record of unassigned joints for a predetermined period of time. During this time, the tracking engine attempts to assign the unassigned joint to existing subjects or create new multi joint entities from these unassigned joints. The tracking engine 110 discards the unassigned joints after a predetermined period of time. It is understood that, in other embodiments, different heuristics than the ones listed above are used to identify and track subjects.

In one embodiment, a user interface output device connected to the node 102 hosting the subject tracking engine 110 displays position of each subject in the real spaces. In one such embodiment, the display of the output device is refreshed with new locations of the subjects at regular intervals.

### Detecting Proximity Events

The technology disclosed can detect proximity events when the distance between a source and a sink is below a threshold. FIG. 5A shows an example of graphical illustration of detected proximity events over a time in the area of real space. The distance between sources and sinks are plotted along y-axis and time is represented along x-axis. In the example graph, a proximity event 1 is detected when the distance between a source and a sink falls below the threshold distance. Note that for a second proximity event to be detected for the same source and the same sink, the distance between the source and sink needs to increase above the threshold distance. The graph illustrates that the distance between the source and sink increases above the threshold distance before a second event (event 2) is detected. A source and a sink can be an inventory cache linked to a subject (such as a shopper) in the area of real space or an inventory cache having a location on a shelf in an inventory display structure. Therefore, the technology disclosed can not only detect item puts and takes from shelves on inventory display structures but also item hand-offs or item exchanges between shoppers in the store.

In one embodiment, the technology disclosed uses the positions of hand joints of subjects and positions of shelves to detect proximity events. For example, the system can calculate distance of left hand and right hand joints, or joints corresponding to hands, of every subject to left hand and right hand joints of every other subject in the area of real space or shelf locations at every time interval. The system can calculate these distances at every second or less than one second time interval. In one embodiment, the system can calculate the distances between hand joints of subjects and shelves per aisle or per portion of the area of real space to improve computational efficiency as the subjects can hand off items to other subjects that are positioned close to each other. The system can also use other joints of subjects to detect proximity events, for example, if one or both hand joints of a subject are occluded, the system can use left and right elbow joints of this subject when calculating the distance to hand joints of other subjects and shelves. If the elbow joints of the subject are also occluded, then the system can use left and right shoulder joints of the subject to calculate its distance from other subjects and shelves. The system can use the positions of shelves and other static objects such as bins, etc. from the location data stored in the maps database.

FIG. 5B presents an example illustration of a portion of the area of real space (such as a shopping store). The position of subjects in the portion of the area of real space at a time t1 is shown in the illustration 530. The subjects are illustrated as stick figures with left and right hand joints. At the time t₁, there are four subjects 540, 542, 544, and 546 in the area of real space shown. The hand joints (left or right) of none of the subjects are closer to the hand joints (left or right) of any other subject at the time t₁ than a pre-determined threshold. The updated positions of the subjects 540, 542, 544, and 546 are shown at a time t₂ in an illustration 535 in FIG. 5B. The hand joints of the subjects 540 and 544 are positioned closer than a threshold distance. The system thus, detects a proximity event at a time t₂. Note that a proximity event does not necessarily indicate hand off of items between subjects 540 and 542. The technology disclosed includes logic that can indicate the type of the proximity event. A first type of proximity event can be a “put” event in which the item is handed off from a source to a sink. For example, a subject (source) who is holding the item prior to the proximity event, can give the item to another subject (sink) or place it on a shelf (sink) following the proximity event. A second type of proximity events can be a “take” event in which a subject (sink) who is not holding the item prior to the proximity event can take an item from another subject (source) or a shelf (source) following the event. A third type of proximity event is a “touch” event in which there is no exchange of items between a source and a sink. Example of touch event can include a subject holding the item on a shelf for a moment and then putting the item back on the shelf and moving away from the shelf. Another example of a touch event can occur when hands of two subjects move closer to each other such that the distance between the hands of two subjects is less than the threshold distance. However, there is no exchange of items from the source (the subject who is holding the item prior to the proximity event) to the sink (the subject who is not holding the item prior to the proximity event).

We now describe the subject data structures and process steps for subject tracking. Following this, we present the details of the joints CNN model that can be used to identify and track subjects in the area of real space. Then we present WhatCNN model which can be used to predict items in the hands of subjects in the area of real space. In one embodiment, the technology disclosed can use output from the WhatCNN model indicating whether a subject is holding an item or not. The What CNN can also predict an item identifier of the item that a subject is holding.

### Subject Data Structure

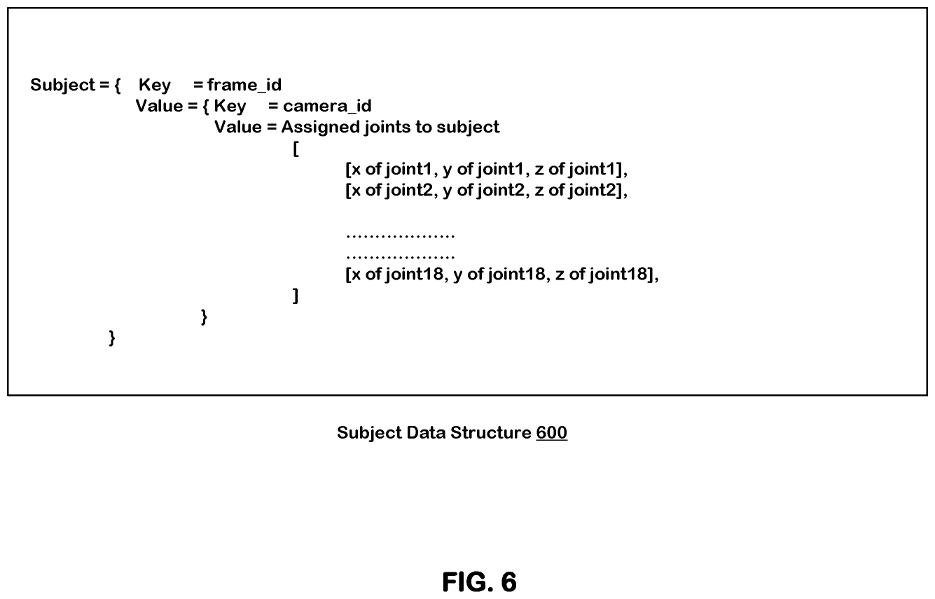

The joints of the subjects are connected to each other using the metrics described above. In doing so, the subject tracking engine 110 creates new subjects and updates the locations of existing subjects by updating their respective joint locations. FIG. 6 shows the subject data structure 600 to store the subjects in the area of real space. The data structure 600 stores the subject related data as a key-value dictionary. The key is a frame_number and value is another key-value dictionary where key is the camera_id and value is a list of 18 joints (of the subject) with their locations in the real space. The subject data is stored in the subject database 140. Every new subject is also assigned a unique identifier that is used to access the subject's data in the subject database 140.

In one embodiment, the system identifies joints of a subject and creates a skeleton of the subject. The skeleton is projected into the real space indicating the position and orientation of the subject in the real space. This is also referred to as “pose estimation” in the field of machine vision. In one embodiment, the system displays orientations and positions of subjects in the real space on a graphical user interface (GUI). In one embodiment, the image analysis is anonymous, i.e., a unique identifier assigned to a subject created through joints analysis does not identify personal identification details (such as names, email addresses, mailing addresses, credit card numbers, bank account numbers, driver's license number, etc.) of any specific subject in the real space.

### Process Flow of Subject Tracking

A number of flowcharts illustrating subject detection and tracking logic are described herein. The logic can be implemented using processors configured as described above programmed using computer programs stored in memory accessible and executable by the processors, and in other configurations, by dedicated logic hardware, including field programmable integrated circuits, and by combinations of dedicated logic hardware and computer programs. With all flowcharts herein, it will be appreciated that many of the steps can be combined, performed in parallel, or performed in a different sequence, without affecting the functions achieved. In some cases, as the reader will appreciate, a rearrangement of steps will achieve the same results only if certain other changes are made as well. In other cases, as the reader will appreciate, a rearrangement of steps will achieve the same results only if certain conditions are satisfied. Furthermore, it will be appreciated that the flow charts herein show only steps that are pertinent to an understanding of the embodiments, and it will be understood that numerous additional steps for accomplishing other functions can be performed before, after and between those shown.

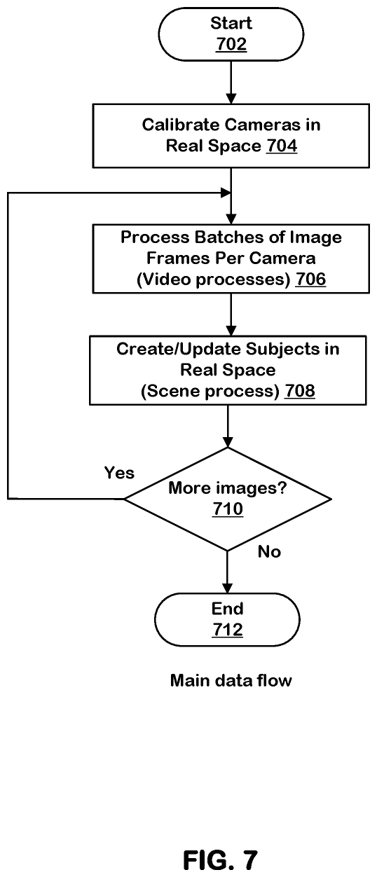

FIG. 7 is a flowchart illustrating process steps for tracking subjects. The process starts at step 702. The cameras 114 having field of view in an area of the real space are calibrated in process step 704. The calibration process can include identifying a (0, 0, 0) point for (x, y, z) coordinates of the real space. A first camera with the location (0, 0, 0) in its field of view is calibrated. More details of camera calibration are presented earlier in this application. Following this, a next camera with overlapping field of view with the first camera is calibrated. The process is repeated at step 704 until all cameras 114 are calibrated. In a next process step of camera calibration, a subject is introduced in the real space to identify conjugate pairs of corresponding points between cameras with overlapping fields of view. Some details of this process are described above. The process is repeated for every pair of overlapping cameras. The calibration process ends if there are no more cameras to calibrate.

Video processes are performed at step 706 by image recognition engines 112a-112n. In one embodiment, the video process is performed per camera to process batches of image frames received from respective cameras. The output of all or some of the video processes from respective image recognition engines 112a-112n are given as input to a scene process performed by the tracking engine 110 at step 708. The scene process identifies new subjects and updates the joint locations of existing subjects. At step 710, it is checked if there are more image frames to be processed. If there are more image frames, the process continues at step 706, otherwise the process ends at step 712.

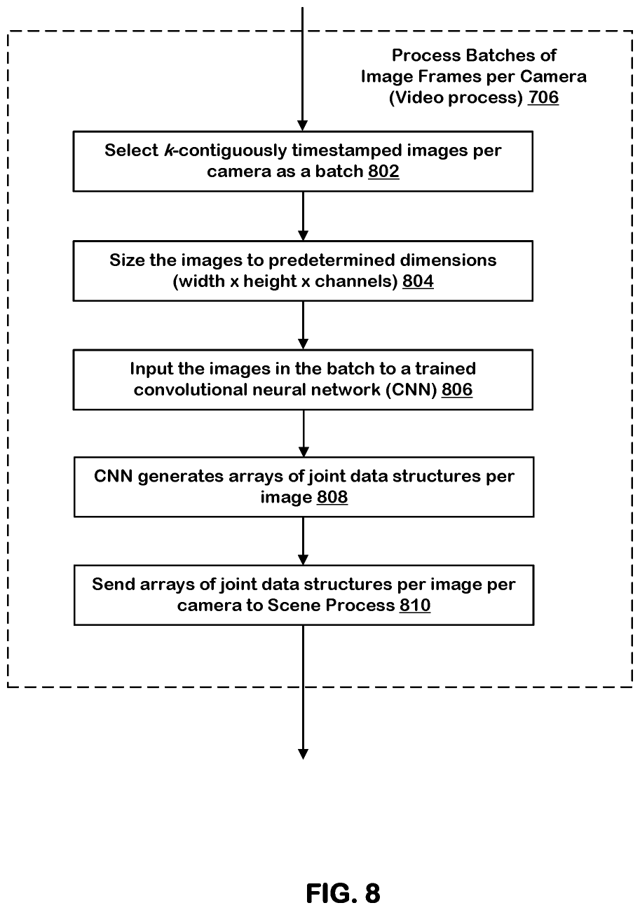

A flowchart in FIG. 8 shows more detailed steps of the “video process” step 706 in the flowchart of FIG. 7. At step 802, k-contiguously timestamped images per camera are selected as a batch for further processing. In one embodiment, the value of k=6 which is calculated based on available memory for the video process in the network nodes 101a-101n, respectively hosting image recognition engines 112a-112n. It is understood that the technology disclosed can process image batches of greater than or less than six images. In a next step 804, the size of images is set to appropriate dimensions. In one embodiment, the images have a width of 1280 pixels, height of 720 pixels and three channels RGB (representing red, green and blue colors). At step 806, a plurality of trained convolutional neural networks (CNN) process the images and generate arrays of joints data structures per image. The output of the CNNs are arrays of joints data structures per image (step 808). This output is sent to a scene process at step 810.

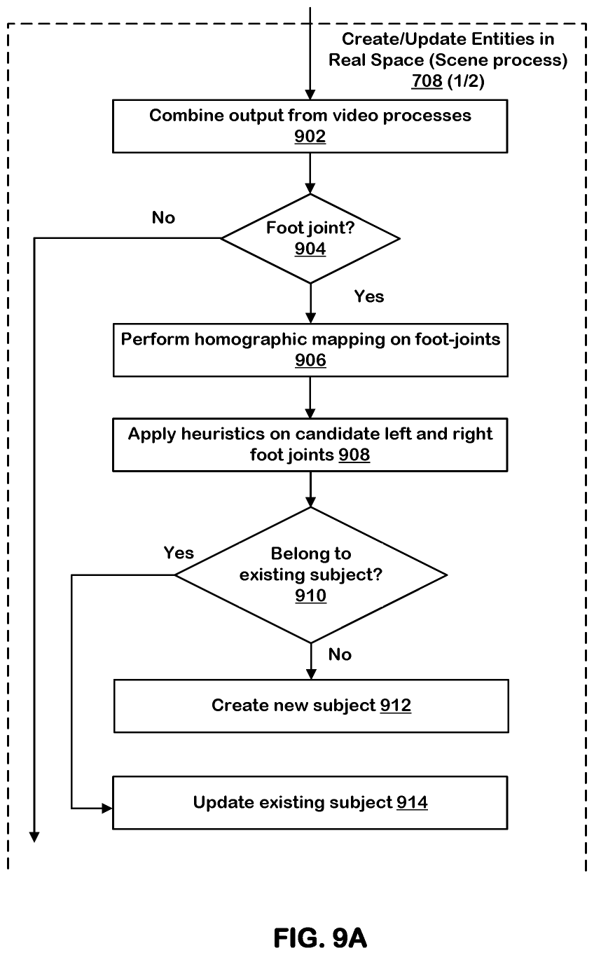

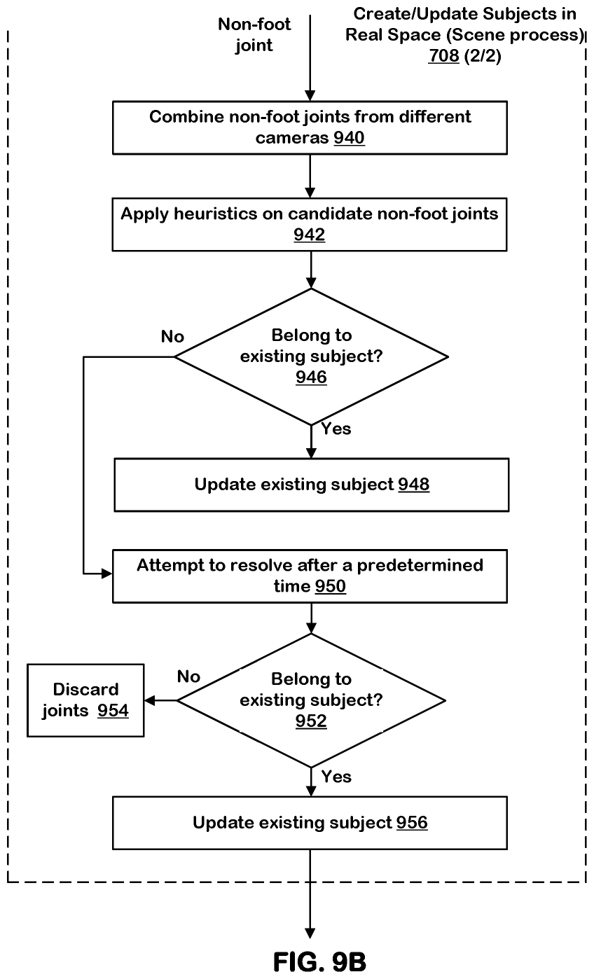

FIG. 9A is a flowchart showing a first part of more detailed steps for “scene process” step 708 in FIG. 7. The scene process combines outputs from multiple video processes at step 902. At step 904, it is checked whether a joints data structure identifies a foot joint or a non-foot joint. If the joints data structure is of a foot-joint, homographic mapping is applied to combine the joints data structures corresponding to images from cameras with overlapping fields of view at step 906. This process identifies candidate foot joints (left and right foot joints). At step 908 heuristics are applied on candidate foot joints identified in step 906 to identify sets of candidate foot joints as subjects. It is checked at step 910 whether the set of candidate foot joints belongs to an existing subject. If not, a new subject is created at step 912. Otherwise, the existing subject is updated at step 914.

A flowchart in FIG. 9B illustrates a second part of more detailed steps for the “scene process” step 708. At step 940, the data structures of non-foot joints are combined from multiple arrays of joints data structures corresponding to images in the sequence of images from cameras with overlapping fields of view. This is performed by mapping corresponding points from a first image from a first camera to a second image from a second camera with overlapping fields of view. Some details of this process are described above. Heuristics are applied at step 942 to candidate non-foot joints. At step 946 it is determined whether a candidate non-foot joint belongs to an existing subject. If so, the existing subject is updated at step 948. Otherwise, the candidate non-foot joint is processed again at step 950 after a predetermined time to match it with an existing subject. At step 952 it is checked whether the non-foot joint belongs to an existing subject. If true, the subject is updated at step 956. Otherwise, the joint is discarded at step 954.

In an example embodiment, the processes to identify new subjects, track subjects and eliminate subjects (who have left the real space or were incorrectly generated) are implemented as part of an “entity cohesion algorithm” performed by the runtime system (also referred to as the inference system). An entity is a constellation of joints referred to as subject above. The entity cohesion algorithm identifies entities in the real space and updates locations of the joints in real space to track movement of the entity.

### Classification of Proximity Events

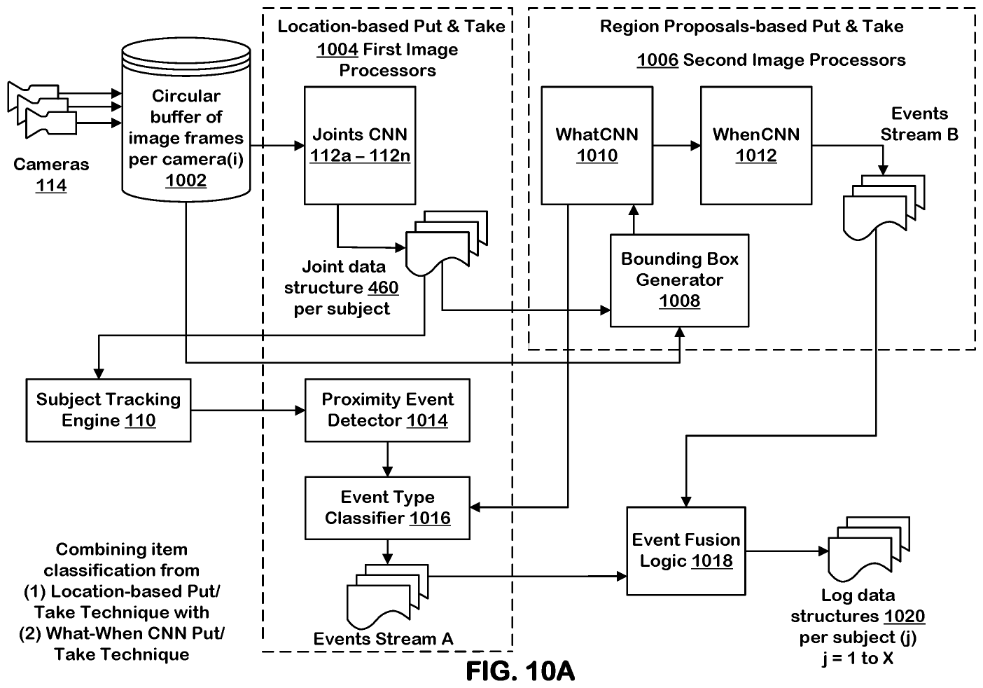

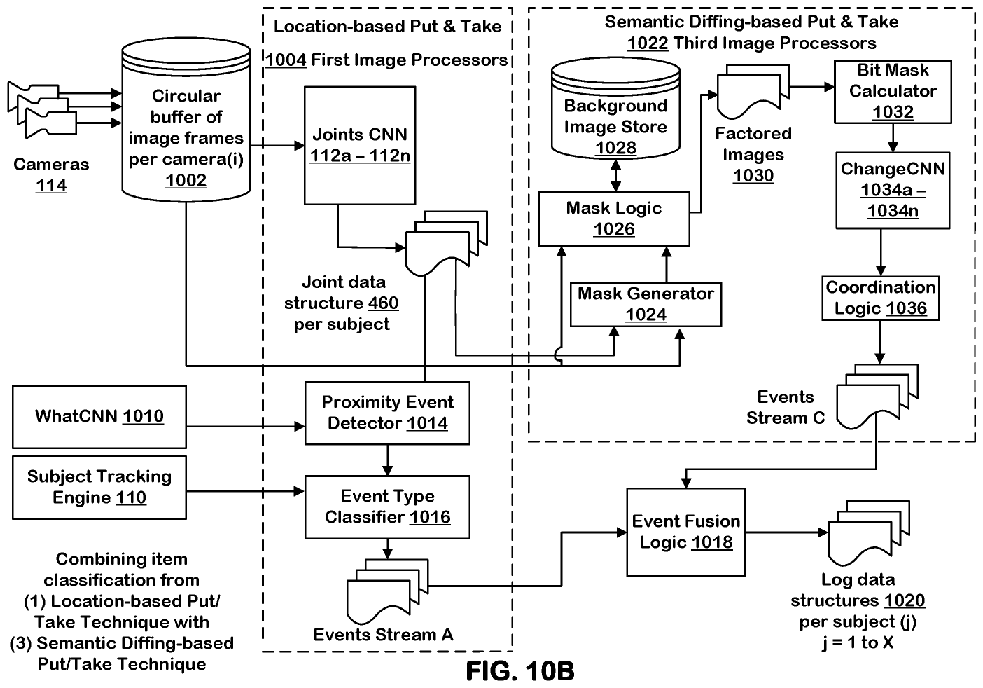

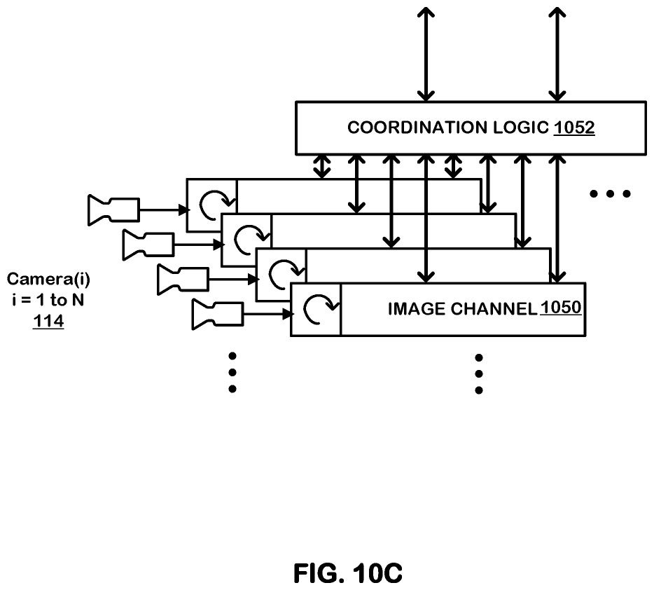

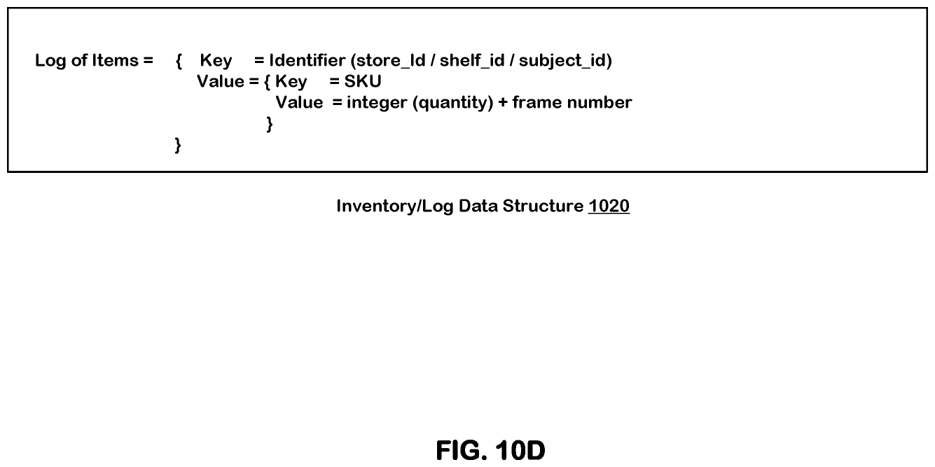

We now describe the technology to identify a type of the proximity event by classifying the detected proximity events. The proximity event can be a take event, a put event, a hand-off event or a touch event. The technology disclosed can further identify an item associated with the identified event. A system and various implementations for tracking exchanges of inventory items between sources and sinks in an area of real space are described with reference to FIGS. 10A and 10B. The system and processes described with reference to FIGS. 10A and 10B, which are architectural level schematic of a system in accordance with an implementation. Because FIGS. 10A and 10B are an architectural diagram, certain details are omitted to improve the clarity of the description.

The technology disclosed comprises of multiple image processors that can detect put and take events in parallel. We can also refer to these image processors as image processing pipelines that process the sequences of images from cameras 114. The system can then fuse the outputs from two or more image processors to generate an output identifying the event type and the item associated with the event. The multiple processing pipelines for detecting put and take events increases the robustness of the system as the technology disclosed can predict a take and put of an item in an area of real space using the output of one of the image processors when the other image processors cannot generate a reliable output for that event. The first image processors 1004 uses locations of subjects and locations of inventory display structures to detect “proximity events” which are further processed to detect put and take events. The second image processors 1006 use bounding boxes of hand images of subjects in the area of real space and perform time series analysis of classification of hand images to detect region proposals-based put and take events. The third images processors 1022 can use masks to remove foreground objects (such as subjects or shoppers) from images and process background images (of shelves) to detect change events (or diff events) indicating puts and takes of items. The put and take events (or exchanges or items between sources and sinks) detected by the three image processors can be referred to as “inventory events”.

The same cameras and the same sequences of images are used by first image processors 1004 (predicting location-based inventory events), second image processors 1006 (predicting region proposals-based inventory events) and the third image processors 1022 (predicting semantic diffing-based inventory events), in one implementation. As a result, detections of puts, takes, transfers (exchanges), or touch of inventory items are performed by multiple subsystems (or procedures) using the same input data allowing for high confidence, and high accuracy, in the resulting data.

In FIG. 10A, we present the system architecture illustrating the first and the second image processors and fusion logic to combine their respective outputs. In FIG. 10B, we present a system architecture illustrating the first and the third image processors and fusion logic to combine their respective outputs. It should be noted that all three image processors can operate in parallel and the outputs of any combination of the two or more image processors can be combined. The system can also detect inventory events using one of the image processors.

### Location-Based Events and Region Proposals-Based Events

FIG. 10A is a high-level architecture of two pipelines of neural networks processing image frames received from cameras 114 to generate shopping cart data structures for subjects in the real space. The system described here includes per camera image recognition engines as described above for identifying and tracking multi joint subjects. Alternative image recognition engines can be used, including examples in which only one “joint” is recognized and tracked per individual, or other features or other types of images data over space and time are utilized to recognize and track subjects in the real space being processed.

The processing pipelines run in parallel per camera, moving images from respective cameras to image recognition engines 112a-112n via circular buffers 1002 per camera. In one embodiment, the first image processors subsystem 1004 includes image recognition engines 112a-112n implemented as convolutional neural networks (CNNs) and referred to as joint CNNs 112a-112n. As described in relation to FIG. 1, cameras 114 can be synchronized in time with each other, so that images are captured at the same time, or close in time, and at the same image capture rate. Images captured in all the cameras covering an area of real space at the same time, or close in time, are synchronized in the sense that the synchronized images can be identified in the processing engines as representing different views at a moment in time of subjects having fixed positions in the real space.

In one embodiment, the cameras 114 are installed in a shopping store (such as a supermarket) such that sets of cameras (two or more) with overlapping fields of view are positioned over each aisle to capture images of real space in the store. There are N cameras in the real space, represented as camera (i) where the value of i ranges from 1 to N. Each camera produces a sequence of images of real space corresponding to its respective field of view.

In one embodiment, the image frames corresponding to sequences of images from each camera are sent at the rate of 30 frames per second (fps) to respective image recognition engines 112a-112n. Each image frame has a timestamp, identity of the camera (abbreviated as “camera_id”), and a frame identity (abbreviated as “frame_id”) along with the image data. The image frames are stored in a circular buffer 1502 (also referred to as a ring buffer) per camera 114. Circular buffers 1002 store a set of consecutively timestamped image frames from respective cameras 114. In some embodiments, an image resolution reduction process, such as downsampling or decimation, is applied to images output from the circular buffers 1002, before input to the Joints CNN 122a-122n.

A joints CNN processes sequences of image frames per camera and identifies 18 different types of joints of each subject present in its respective field of view. The outputs of joints CNNs 112a-112n corresponding to cameras with overlapping fields of view are combined to map the location of joints from 2D image coordinates of each camera to 3D coordinates of real space. The joints data structures 460 per subject (j) where j equals 1 to x, identify locations of joints of a subject (j) in the real space. The details of subject data structure 460 are presented in FIG. 4B. In one example embodiment, the joints data structure 460 is a two level key-value dictionary of joints of each subject. A first key is the frame_number and the value is a second key-value dictionary with the key as the camera_id and the value as the list of joints assigned to a subject.

The data sets comprising subjects identified by joints data structures 460 and corresponding image frames from sequences of image frames per camera are given as input to a bounding box generator 1008 in the second image processors subsystem 1006 (or the second processing pipeline). The second image processors produce a stream of region proposals-based events stream, shown as events stream B in FIG. 10A. The second image processors subsystem further comprise foreground image recognition engines. In one embodiment, the foreground image recognition engines recognize semantically significant objects in the foreground (i.e. shoppers, their hands and inventory items) as they relate to puts and takes of inventory items for example, over time in the images from each camera. In the example implementation shown in FIG. 10A, the foreground image recognition engines are implemented as WhatCNN 1010 and WhenCNN 1012. The bounding box generator 1008 implements the logic to process data sets to specify bounding boxes which include images of hands of identified subjects in images in the sequences of images. The bounding box generator 1008 identifies locations of hand joints in each source image frame per camera using locations of hand joints in the multi joints data structures (also referred to as subject data structures) 600 corresponding to the respective source image frame. In one embodiment, in which the coordinates of the joints in subject data structure indicate location of joints in 3D real space coordinates, the bounding box generator maps the joint locations from 3D real space coordinates to 2D coordinates in the image frames of respective source images.

The bounding box generator 1008 creates bounding boxes for hand joints in image frames in a circular buffer per camera 114. In some embodiments, the image frames output from the circular buffer to the bounding box generator has full resolution, without downsampling or decimation, alternatively with a resolution higher than that applied to the joints CNN. In one embodiment, the bounding box is a 128 pixels (width) by 128 pixels (height) portion of the image frame with the hand joint located in the center of the bounding box. In other embodiments, the size of the bounding box is 64 pixels×64 pixels or 32 pixels×32 pixels. For m subjects in an image frame from a camera, there can be a maximum of 2m hand joints, thus 2m bounding boxes. However, in practice fewer than 2m hands are visible in an image frame because of occlusions due to other subjects or other objects. In one example embodiment, the hand locations of subjects are inferred from locations of elbow and wrist joints. For example, the right hand location of a subject is extrapolated using the location of the right elbow (identified as p1) and the right wrist (identified as p2) as extrapolation_amount*(p2−p1)+p2 where extrapolation_amount equals 0.4. In another embodiment, the joints CNN 112a-112n are trained using left and right hand images. Therefore, in such an embodiment, the joints CNN 112a-112n directly identify locations of hand joints in image frames per camera. The hand locations per image frame are used by the bounding box generator 1008 to create a bounding box per identified hand joint.

WhatCNN 1010 is a convolutional neural network trained to process the specified bounding boxes in the images to generate a classification of hands of the identified subjects. One trained WhatCNN 1010 processes image frames from one camera. In the example embodiment of the shopping store, for each hand joint in each image frame, the WhatCNN 1010 identifies whether the hand joint is empty. The WhatCNN 1010 also identifies a SKU (stock keeping unit) number of the inventory item in the hand joint, a confidence value indicating the item in the hand joint is a non-SKU item (i.e. it does not belong to the shopping store inventory) and a context of the hand joint location in the image frame.

The outputs of WhatCNN models 1010 for all cameras 114 are processed by a single WhenCNN model 1012 for a pre-determined window of time. In the example of a shopping store, the WhenCNN 1012 performs time series analysis for both hands of subjects to identify whether a subject took a store inventory item from a shelf or put a store inventory item on a shelf. A stream of put and take events (also referred to as region proposals-based inventory events) is generated by the WhenCNN 1012 and is labeled as events stream B in FIG. 10B. The put and take events from the event stream are used to update the log data structures of subjects (also referred to as shopping cart data structures including list of inventory items). A log data structure 1020 is created per subject to keep a record of the inventory items in a shopping cart (or basket) associated with the subject. The log data structures per shelf and per store can be generated to indicate items on shelves and in a store. The system can include an inventory database to store the log data structures of subjects, shelves and stores.

### Video Processes and Scene Process to Classify Region Proposals

In one embodiment of the system, data from a so called “scene process” and multiple “video processes” is given as input to WhatCNN model 1010 to generate hand image classifications. Note that the output of each video process is given to a separate WhatCNN model. The output from the scene process is a joints dictionary. In this dictionary, keys are unique joint identifiers and values are unique subject identifiers with which the joint is associated. If no subject is associated with a joint, then it is not included in the dictionary. Each video process receives a joints dictionary from the scene process and stores it into a ring buffer that maps frame numbers to the returned dictionary. Using the returned key-value dictionary, the video processes select subsets of the image at each moment in time that are near hands associated with identified subjects. These portions of image frames around hand joints can be referred to as region proposals.

In the example of a shopping store, a “region proposal” is the frame image of hand location from one or more cameras with the subject in their corresponding fields of view. A region proposal can be generated for sequences of images from all camera in the system. It can include empty hands as well as hands carrying shopping store inventory items and items not belonging to shopping store inventory. Video processes select portions of image frames containing hand joint per moment in time. Similar slices of foreground masks are generated. The above (image portions of hand joints and foreground masks) are concatenated with the joints dictionary (indicating subjects to whom respective hand joints belong) to produce a multi-dimensional array. This output from video processes is given as input to the WhatCNN model.

The classification results of the WhatCNN model can be stored in the region proposal data structures. All regions for a moment in time are then given back as input to the scene process. The scene process stores the results in a key-value dictionary, where the key is a subject identifier and the value is a key-value dictionary, where the key is a camera identifier and the value is a region's logits. This aggregated data structure is then stored in a ring buffer that maps frame numbers to the aggregated structure for each moment in time.

Region proposal data structures for a period of time e.g., for one second, are given as input to the scene process. In one embodiment, in which cameras are taking images at the rate of 30 frames per second, the input includes 30 time periods and corresponding region proposals. The system includes logic (also referred to as scene process) that reduces 30 region proposals (per hand) to a single integer representing the inventory item SKU. The output of the scene process is a key-value dictionary in which the key is a subject identifier and the value is the SKU integer.

The WhenCNN model 1012 performs a time series analysis to determine the evolution of this dictionary over time. This results in identification of items taken from shelves and put on shelves in the shopping store. The output of the WhenCNN model is a key-value dictionary in which the key is the subject identifier and the value is logits produced by the WhenCNN. In one embodiment, a set of heuristics can be used to determine the shopping cart data structure 1020 per subject. The heuristics are applied to the output of the WhenCNN, joint locations of subjects indicated by their respective joints data structures, and planograms. The heuristics can also include the planograms that are precomputed maps of inventory items on shelves. The heuristics can determine, for each take or put, whether the inventory item is put on a shelf or taken from a shelf, whether the inventory item is put in a shopping cart (or a basket) or taken from the shopping cart (or the basket) or whether the inventory item is close to the identified subject's body

We now refer back to FIG. 10A to present the details of the first image processors 1004 for location-based put and take detection. The first image processors can be referred to as the first image processing pipeline. It can include a proximity event detector 1014 that receives information about inventory caches linked to subjects identified by joints data structures 460. The proximity event detector includes the logic to process positions of hand joints (left and right) of subjects, or other joints corresponding to inventory caches, to detect when a subject's position is closer to another subject than a pre-defined threshold such as 10 cm. Other values of threshold less than or greater than 10 cm can be used. The distance between the subjects is calculated using the positions of their hands (left and right). If one or both hands of a subject are occluded, the proximity event detector can use positions of other joints of subjects such as elbow joint, or shoulder joint, etc. The above positions calculation logic can be applied per hand per subject in all image frames in the sequence of image frames per camera to detect proximity events. In other embodiments, the system can apply the distance calculation logic after every 3 frames, 5 frames or 10 frames in the sequence of frames. The system can use other frame intervals or time intervals to calculate the distance between subjects or the distance between subjects and shelves.

If a proximity event is detected by the proximity event detector 1014, the event type classifier 1016 processes the output from the WhatCNN 1010 to classify the event as one of a take event, put event, a touch event, or a transfer or exchange event. The event type classifier receives the holding probability for the hand joints of subjects identified in the proximity event. The holding probability indicates a confidence score indicating whether the subject is holding an item or not. A large positive value indicates that WhatCNN model has a high level of confidence that the subject is holding an item. A large negative value indicates that the model is confident that the subject is not holding any item. A close to zero value of the holding probability indicates that WhatCNN model is not confident in predicting whether the subject is holding an item or not.

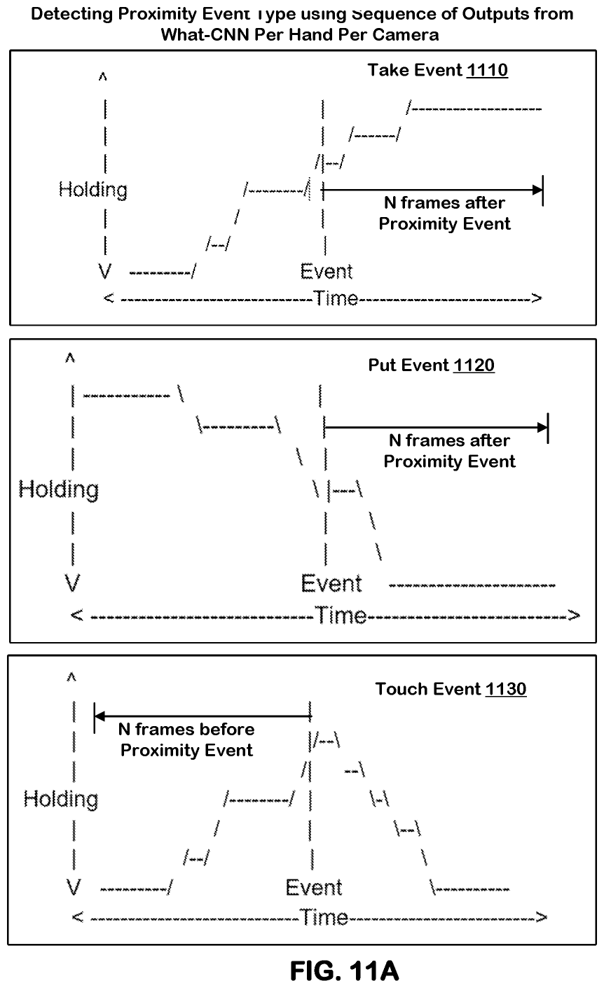

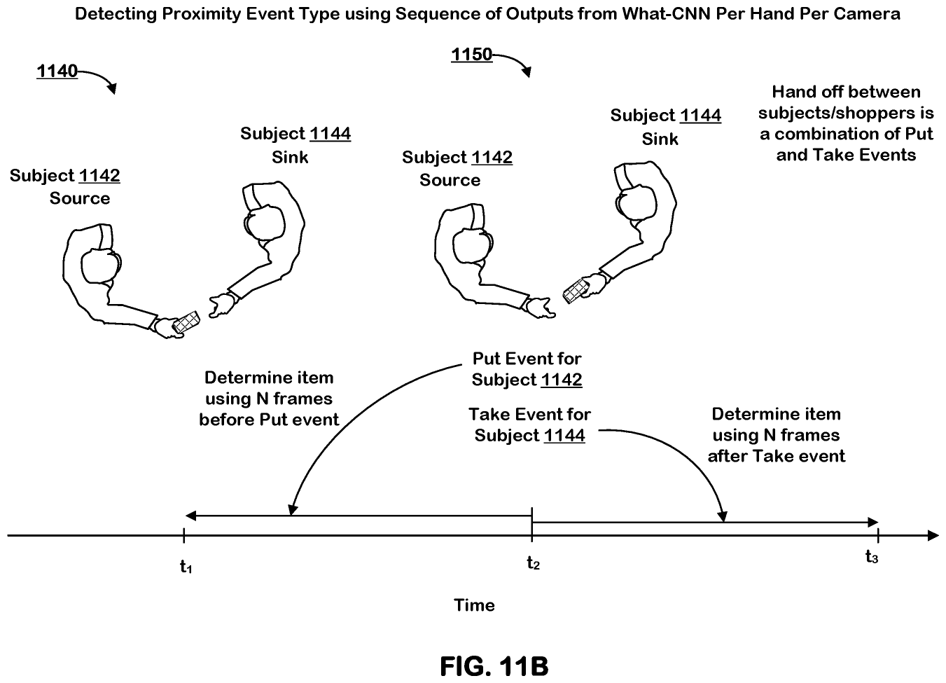

FIG. 11A present example graphs illustrating holding probabilities for take, put and touch events, respectively. The holding probability values are plotted on y-axis and time is plotted along the x-axis. The time of proximity event is shown as a vertical broken line on the three graphs.

The first graph 1110 in FIG. 11A presents the holding values for a take event over a period of time. In one embodiment, the system calculates an average of holding values for N frames after the frame in which the proximity event is detected and uses this value to detect the take event. For a take event, the difference between average holding probability (over N frames) after the event and holding probability in a frame after the event is greater than a threshold. We can see that the holding probability value increases after the proximity event in case of a take event. Note that the holding probability is for the sink subject who is holding the item in her hand after the proximity event. The sink subject may have been handed the item from a source subject or she may have taken the item from a source shelf.

The second graph 1120 in FIG. 11A presents the holding values for a put event over a period of time. In one embodiment, the system calculates an average of holding values for N frames after the frame in which the proximity event is detected and uses this value to detect the put event. For a put event, the difference between average holding probability (over N frames) after the event and holding probability in a frame after the event is less than a negative threshold. We can see that the values of holding probability decrease after the put proximity event. This is because the source subject is not holding the item in her hand after handing it over to a sink subject or putting it on a sink shelf.

The third graph 1130 in FIG. 11A presents holding values for a touch event over a period of time. In one embodiment, the system calculates an average of holding values for N frames before the frame in which the proximity event is detected and uses this value to detect the touch event. For a touch event, the difference between average holding probability (over N frames) before the event and holding probability in a frame after the event is less than a negative threshold. We can see that holding probability is low before the proximity event, its value increase for a short period of time after the proximity event occurrence and then falls again. This is because in a touch event a subject does not take the item from a shelf or from another subject, therefore, the holding probability value decreases after the proximity event.

Referring back to FIG. 10A, the event type classifier 1016 can take the holding probability values over N frames before and after the proximity event as input to detect whether the event detected is a take event, a put event, a touch event, or a transfer or exchange event. If a take event is detected, the system can use the average item class probability from WhatCNN over N frames after the proximity event to determine the item associated with the proximity event. FIG. 11B illustrates the hand-off or exchange of an item from the source subject to the sink subject. The sink subject may also have taken the detected item from a shelf or another inventory location. This item can then be added to the log data structure of the sink subject.

As shown in FIG. 11B, the exchange or transfer of item between two shoppers (or subjects) includes two events: a take event and a put event. For the put event, the system can take the average item class probability from WhatCNN over N frames before the proximity event to determine the item associated with the proximity event. The item detected is handed-off from the source subject to the sink subject. The source subject may also have put the item on a shelf or another inventory location. The detected item can then be removed from the log data structure of the source subject. The system detects a take event for the source subject and adds the item to the subject's log data structure. A touch event does not result in any changes to the log data structures of the source and sink in the proximity event.

Methods to Detect Proximity Events

We present examples of methods to detect proximity events. One example is based on heuristics using data about the locations of joints such as hand joints, and other examples use machine learning models that process data about locations of joints. Combinations of heuristics and machine learning models can used in some embodiments

### Method 1: Using Heuristics to Detect Proximity Events

The system detects positions of both hands of shoppers (or subjects) per frame per camera in the area of real space. Other joints or other inventory caches which move over time and are linked to shoppers can be used. The system calculates distances of left hand and right hand of each shopper to left hand and right hands of other shoppers in the area of real space. In one embodiment, the system calculates distances between hands of shoppers per portion of the area of real space, for example in each aisle of the shopping store. The system also calculates distances of left hand and right hand of each shopper per frame per camera to the nearest shelf in the inventory display structure. The shelves can be represented by a plane in a 3D coordinate system or by a 3D mesh. The system analyzes the time series of hand distances over time by processing sequences of image frames per camera.

The system selects a hand (left or right) per subject per frame that has a minimum distance (of the two hands) to the hand (left or right) of another shopper or to a shelf (i.e. fixed inventory cache). The system also determines if the hand is “in the shelf”. The hand is considered “in the shelf” if the (signed) distance between the hand and the shelf is below a threshold. A negative distance between the hand and shelf indicates that the hand has gone past the plane of the shelf. If the hand is in the shelf for more than a pre-defined number of frames (such as M frames), then the system detects a proximity event when the hand moves out of the shelf. The system determines that the hand has moved out of the shelf when the distance between the hand and shelf increases above a threshold distance. The system assigns a timestamp to the proximity event which can be a midpoint between the entrance time of the hand in the shelf and the exit time of the hand from the shelf. The hand associated with the proximity event is the hand (left or right) that has the minimum distance to the shelf at the time of the proximity event. Note that the entrance time can be the timestamp of the frame in which the distance between the shelf and hand falls below the threshold as mentioned above. The exit time can be the timestamp of the frame in which the distance between the shelf and the hand increases above the threshold.

### Method 2: Applying a Decision Tree Model to Detect Proximity Events

The second method to detect proximity events uses a decision tree model that uses heuristics and/or machine learning. The heuristics-based method to detect the proximity event might not detect proximity events when one or both hands of subjects are occluded in image frames from the sensors. This can result in missed detections of proximity events which can cause errors in updates to log data structures of shoppers. Therefore, the system can include an additional method to detect proximity events for robust event detections. If the system cannot detect one or both hands of an identified subject in an image frame, the system can use (left or right) elbow joint positions instead. The system can apply the same logic as described above to detect the distance of the elbow joint to a shelf or (left or right) hand of another subject to detect proximity event, if the distance falls below a threshold distance. If the elbow of the subject is occluded as well, then the system can use shoulder joint to detect a proximity event.

Shopping stores can use different types of shelves having different properties, e.g., depth of shelf, height of shelf, and space between shelves, etc. The distribution of occlusions of subjects (or portions of subjects) induced by shelves at different camera angles is different, we can train one or more decision tree models using labeled data. The labeled data can include corpus of example image data. We can train a decision tree that takes in a sequence of distances, with some missing data to simulate occlusions, of shelves to joints over a period of time. The decision tree outputs whether an event happened in the time range or not. In case of a proximity event prediction, the decision tree also predicts the time of the proximity event (relative to the initial frame).

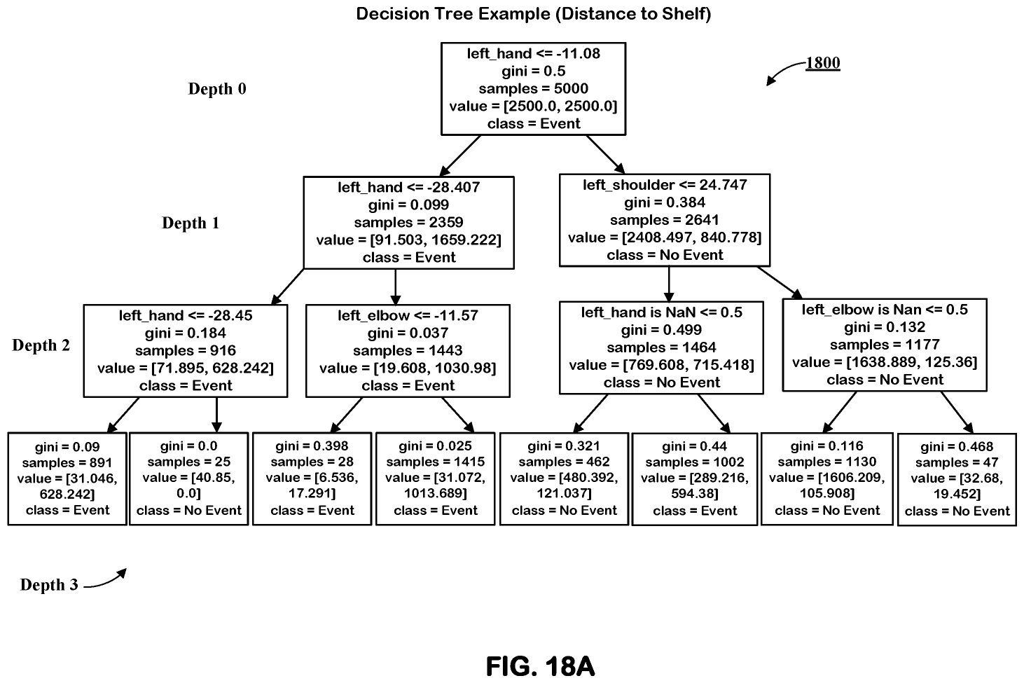

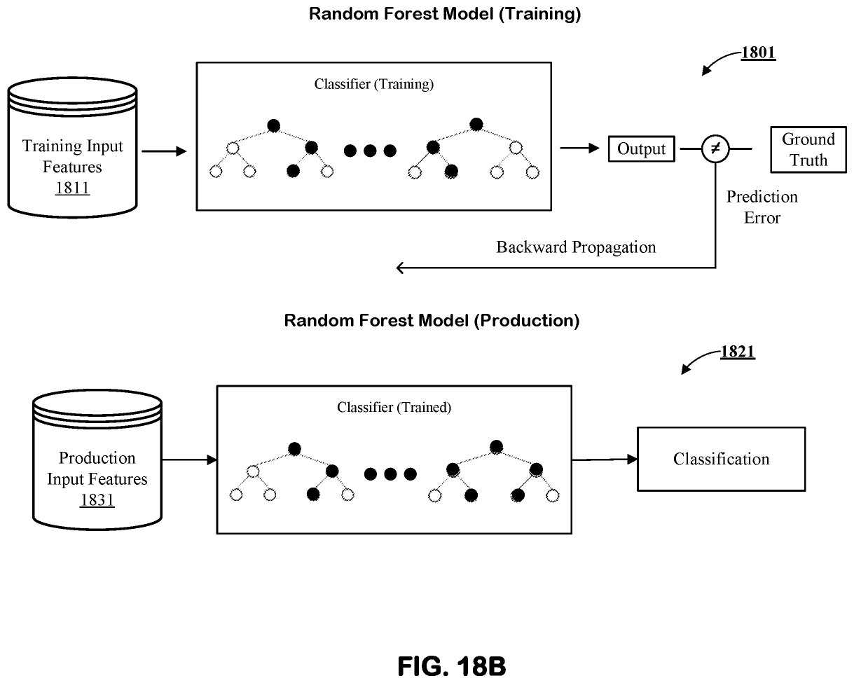

We present an example decision tree in FIG. 18A for predicting location-based events using distance of joints to shelves. The inputs to the decision tree are median distances of three-dimensional keypoints (3D keypoints) to shelves. A 3D keypoint can represent a three-dimensional position in the area of real space. The three-dimensional position can be a position of a joint in the area of real space. The outputs from the decision tree model are event classifications i.e., event or no event. The example decision tree in FIG. 18A has a depth of 3. It is understood that decision trees of depths greater than or less than 3 can be used. The example decision tree illustrates detection of location-based events using positions of left joints of subjects (e.g., left hand, left elbow, and left shoulder). Similar decision tree can be trained using right joints of subjects (e.g., right hand, right elbow, and right shoulder). Positions of other joints can also be used for predicting location-based events.

The example decision tree 1800 in FIG. 18A includes a root node at depth 0, two nodes at depth 1, four nodes at depth 1, and eight nodes at depth 3. The nodes at depth 3 are also known as leaf nodes as they do not have any child nodes. At each node of the decision tree 1800, we present example parameter values. The distance of joints to shelves is compared with threshold values. For example, at the root node, the position of left hand is compared with a threshold of −11.08. Note that negative values indicate an overlap of shelf with a joint position as described above. Similarly, positions of other joints such as left shoulder and left elbow are compared with threshold values at other nodes as shown in the example decision tree. At each node, the decision tree compares positions of left joints of subjects (such as left hand, left elbow and left shoulder) with threshold values. The technology disclosed can use similar decision tree for positions of right joints of subjects (such as right hand, right elbow, and right shoulder). Other joints of the subjects can also be used in the decision tree for event classification.

The nodes of example decision tree also show other parameters such as “gini”, “samples”, “value”, and “class”. A “gini” score is a metric that quantifies the purity of the node. A “gini” score greater than zero implies that samples contained within that node belong to different classes. A “gini” score of zero means that the node is pure i.e., within that node only a single class of samples exist. The value of “samples” parameter indicates the number of samples in the dataset. As we move to different levels of the tree, the value of the “samples” parameter changes to indicate the number of samples contained at respective nodes. The “value” is a list parameter that indicates the number of samples falling in each class (or category). The first value in the list indicates number of samples in the “no event” class and the second value in the list indicates number of samples in the “event” class. Finally, the “class” parameter shows the prediction of a given node. The class prediction can be determined from wthe “value” list. Whichever class occurs the most within the node is selected as the predicted class.

### Method 3: Applying a Random Forest Model to Detect Proximity Events

The third method for detecting proximity events uses an ensemble of decision trees. In one embodiment, we can use the trained decision trees from the method 2 above to create the ensemble random forest. Random forest classifier (also referred to as random decision forest) is an ensemble machine learning technique. Ensembled techniques or algorithms combine more than one technique of the same or different kind for classifying objects. The random forest classifier consists of multiple decision trees that operate as an ensemble. Each individual decision tree in random forest acts as base classifier and outputs a class prediction. The class with the most votes becomes the random forest model's prediction. The fundamental concept behind random forests is that a large number of relatively uncorrelated models (decision trees) operating as a committee will outperform any of the individual constituent models.

FIG. 18B illustrates training of a random forest model and application of a trained model in production. A random forest classifier with multiple decision trees and a depth of 2 to 8 or more can be used. Increasing the number of trees can increase the model performance however, it can also increase the time required for training. A training database 1811 including features for labeled images is used to train the random forest classifier as shown in the illustration 1801. In one embodiment, the training database comprises of sequences of labeled image frames with an initial frame including the distance between the (left or right) hand of a subject is positioned closer to another hand of a subject or a shelf. The sequence can include a series of image frames including the frames in which the distance between the hands or the hand and the shelf becomes (negative) indicating occlusion or overlap of a hand by another hand or shelf. The sequence of frames ends when the hands move away from each other or the shelf.

Decision trees are prone to overfitting. To overcome this issue, bagging technique is used to train the decision trees in random forest. Bagging is a combination of bootstrap and aggregation techniques. In bootstrap, during training, we take a sample of rows from our training database and use it to train each decision tree in the random forest. For example, a subset of features for the selected rows can be used in training of decision tree 1. Therefore, the training data for decision tree 1 can be referred to as row sample 1 with column sample 1 or RS1+CS1. The columns or features can be selected randomly. The decision tree 2 and subsequent decision trees in the random forest are trained in a similar manner by using a subset of the training data. Note that the training data for decision trees can be generated with replacement i.e., same row data can be used in training of multiple decision trees.

The second part of bagging technique is the aggregation part which is applied during production. Each decision tree outputs a classification whether the proximity event occurred or not. In case of binary classification, it can be 1 (indicating the proximity event occurred) or 0 (indicating the proximity event did not occur). The output of the random forest is the aggregation of outputs of decision trees in the random forest with a majority vote selected as the output of the random forest. By using votes from multiple decision trees, a random forest reduces high variance in results of decision trees, thus resulting in good prediction results. By using row and column sampling to train individual decision trees, each decision tree becomes an expert with respect to training records with selected features.

During training, the output of the random forest is compared with ground truth labels and a prediction error is calculated. During backward propagation, the weights are adjusted so that the prediction error is reduced. The trained random forest algorithm 1821 is used to classify features from production images. The trained random forest can predict whether the proximity event occurred or not. The random forest can also predict an expected time of the proximity event with respect to the initial frame in the sequence of image frames.

The technology disclosed can generate separate event streams in parallel for the same inventory events. For example, as shown in FIG. 10A, the first image processors generate an event stream A of location-based put and take events. As described above, the first image processors can also detect touch events. As touch events do not result in a put or take, the system does not update log data structures of sources and sinks when it detects a touch event. The event stream A can include location-based put and take events and can include the item identifier associated with the event. The location-based events in the event stream A can also include the subject identifier of the source subject or the sink subject, time and location of the event in the area of real space. In one embodiment, the location-based event can also include shelf identifier of the source shelf or the sink shelf.

The second image processors produce a second event stream B including put and take events based on hand-image processing of WhatCNN and time series analysis of output WhatCNN by WhenCNN. The region proposals-based put and take events in the event stream B can include item identifiers, the subjects or shelves associated with the event, time and location of the event in the real space. The events in the both event stream A and event stream B can include confidence scores identifying the confidence of the classifier.

The technology disclosed includes event fusion logic 1018 to combine events from event stream A and event stream B to increase the robustness of event predictions in the area of real space. In one embodiment, the event fusion logic determines for each event in event stream A, if there is a matching event in event stream B. The events are matched, if both events are of the same event type (put, take), if the event in event stream B has not been already matched to an event in event stream B, and if the event in event stream B is identified in a frame within a threshold of number of frames preceding or following the image frame in which the proximity event is detected. As described above, the cameras 114 can be synchronized in time with each other, so that images are captured at the same time, or close in time, and at the same image capture rate. Images captured in all the cameras covering an area of real space at the same time, or close in time, are synchronized in the sense that the synchronized images can be identified in the processing engines as representing different views at a moment in time of subjects having fixed positions in the real space Therefore, if an event is detected in a frame x in event stream A, the matching logic considers events in frame x±N, where the value of N can be set as 1, 3, 5 or more. If a matching event is found in event stream B, the technology disclosed uses a weighted combination of event predictions to generate an item put or take prediction. For example, in one embodiment, the technology disclosed can assign 50 percent weight to events of stream A and 50 percent weight to matching events from stream B and use the resulting output to update the log data structures 1020 of source and sinks. In another embodiment, the technology disclosed can assign more weightage to events from one of the streams when combining the events to predict put and take of items.

If the event fusion logic cannot find a matching event in event stream B to an event in event stream A, the technology disclosed can wait for a threshold number of frames to pass. For example, if the threshold is set as 5 frames, the system can wait until five frames following the frame in which the proximity event is detected, are processed by the second image processors. If a matching event is not found after threshold number of frames, the system can use item put or take prediction from the location-based event to update the log data structure of the source and the sink. The technology disclosed can apply the same matching logic for events in the event stream B. Thus, for an event in the events stream B, if there is no matching event in the event stream A, the system can use the item put or take detection from region proposals-based prediction to update the log data structures 1020 of source and sink subject. Therefore, the technology disclosed can produce robust event detections even when one of the first or the second image processors cannot predict a put or a take event or when one technique predicts a put or a take event with low confidence.

### Location-Based Events and Semantic Diffing-Based Events

We now present a third image processors 1022 (also referred to as the third image processing pipeline) and the logic to combine the item put and take predictions from this technique to item put and take predictions from the first image processors 1004. Note that item put and take predictions from third image processors can be combined with item put and take predictions from second image processors 1006 in a similar manner. FIG. 10B is a high-level architecture of pipelines of neural networks processing image frames received from cameras 114 to generate shopping cart data structures for subjects in the real space. The system described here includes per camera image recognition engines as described above for identifying and tracking multi joint subjects.

The processing pipelines run in parallel per camera, moving images from respective cameras to image recognition engines 112a-112n via circular buffers 1002 per camera. We have described the details of first image processors 1004 with reference to FIG. 10A. The output from first image processors is an events stream A. The technology disclosed includes event fusion logic 1018 to combine the events in the events stream A to matching events in an events stream C which is output from the third image processors.

A “semantic diffing” subsystem (also referred to as third image processors 1022) includes background image recognition engines, receiving corresponding sequences of images from the plurality of cameras and recognize semantically significant differences in the background (i.e. inventory display structures like shelves) as they relate to puts and takes of inventory items for example, over time in the images from each camera. The third image processors receive joint data structures 460 from joints CNNs 112a-112n and image frames from cameras 114 as input. The third image processors mask the identified subjects in the foreground to generate masked images. The masked images are generated by replacing bounding boxes that correspond with foreground subjects with background image data. Following this, the background image recognition engines process the masked images to identify and classify background changes represented in the images in the corresponding sequences of images. In one embodiment, the background image recognition engines comprise convolutional neural networks.

The third image processors process identified background changes to predict takes of inventory items by identified subjects and of puts of inventory items on inventory display structures by identified subjects. The set of detections of puts and takes from semantic diffing system are also referred to as background detections of puts and takes of inventory items. In the example of a shopping store, these detections can identify inventory items taken from the shelves or put on the shelves by customers or employees of the store. The semantic diffing subsystem includes the logic to associate identified background changes with identified subjects. We now present the details of components of the semantic diffing subsystem or third image processors 1022 as shown inside the broken line on the right side of FIG. 10B.

The system comprises of the plurality of cameras 114 producing respective sequences of images of corresponding fields of view in the real space. The field of view of each camera overlaps with the field of view of at least one other camera in the plurality of cameras as described above. In one embodiment, the sequences of image frames corresponding to the images produced by the plurality of cameras 114 are stored in a circular buffer 1002 (also referred to as a ring buffer) per camera 114. Each image frame has a timestamp, identity of the camera (abbreviated as “camera_id”), and a frame identity (abbreviated as “frame_id”) along with the image data. Circular buffers 1002 store a set of consecutively timestamped image frames from respective cameras 114. In one embodiment, the cameras 114 are configured to generate synchronized sequences of images.

The first image processors 1004, include joints CNN 112a-112n, receiving corresponding sequences of images from the plurality of cameras 114 (with or without image resolution reduction). The technology includes subject tracking engine to process images to identify subjects represented in the images in the corresponding sequences of images. In one embodiment, the subject tracking engines can include convolutional neural networks (CNNs) referred to as joints CNN 112a-112n. The outputs of joints CNNs 112a-112n corresponding to cameras with overlapping fields of view are combined to map the location of joints from 2D image coordinates of each camera to 3D coordinates of real space. The joints data structures 460 per subject (j) where j equals 1 to x, identify locations of joints of a subject (j) in the real space and in 2D space for each image. Some details of subject data structure 600 are presented in FIG. 6.

A background image store 1028, in the semantic diffing subsystem or third image processors 1022, stores masked images (also referred to as background images in which foreground subjects have been removed by masking) for corresponding sequences of images from cameras 114. The background image store 1028 is also referred to as a background buffer. In one embodiment, the size of the masked images is the same as the size of image frames in the circular buffer 1002. In one embodiment, a masked image is stored in the background image store 1028 corresponding to each image frame in the sequences of image frames per camera.

The semantic diffing subsystem 2604 (or the second image processors) includes a mask generator 1024 producing masks of foreground subjects represented in the images in the corresponding sequences of images from a camera. In one embodiment, one mask generator processes sequences of images per camera. In the example of the shopping store, the foreground subjects are customers or employees of the store in front of the background shelves containing items for sale.

In one embodiment, the joint data structures 460 per subject and image frames from the circular buffer 1002 are given as input to the mask generator 1024. The joint data structures identify locations of foreground subjects in each image frame. The mask generator 1024 generates a bounding box per foreground subject identified in the image frame. In such an embodiment, the mask generator 1024 uses the values of the x and y coordinates of joint locations in 2D image frame to determine the four boundaries of the bounding box. A minimum value of x (from all x values of joints for a subject) defines the left vertical boundary of the bounding box for the subject. A minimum value of y (from all y values of joints for a subject) defines the bottom horizontal boundary of the bounding box. Likewise, the maximum values of x and y coordinates identify the right vertical and top horizontal boundaries of the bounding box. In a second embodiment, the mask generator 1024 produces bounding boxes for foreground subjects using a convolutional neural network-based person detection and localization algorithm. In such an embodiment, the mask generator 1024 does not use the joint data structures 460 to generate bounding boxes for foreground subjects.

The semantic diffing subsystem (or the third image processors 1022) include a mask logic to process images in the sequences of images to replace foreground image data representing the identified subjects with background image data from the background images for the corresponding sequences of images to provide the masked images, resulting in a new background image for processing. As the circular buffer receives image frames from cameras 114, the mask logic processes images in the sequences of images to replace foreground image data defined by the image masks with background image data. The background image data is taken from the background images for the corresponding sequences of images to generate the corresponding masked images.

Consider, the example of the shopping store. Initially at time t=0, when there are no customers in the store, a background image in the background image store 1028 is the same as its corresponding image frame in the sequences of images per camera. Now consider at time t=1, a customer moves in front of a shelf to buy an item in the shelf. The mask generator 1024 creates a bounding box of the customer and sends it to a mask logic component 1026. The mask logic component 1026 replaces the pixels in the image frame at t=1 inside the bounding box by corresponding pixels in the background image frame at t=0. This results in a masked image at t=1 corresponding to the image frame at t=1 in the circular buffer 1002. The masked image does not include pixels for foreground subject (or customer) which are now replaced by pixels from the background image frame at t=0. The masked image at t=1 is stored in the background image store 1028 and acts as a background image for the next image frame at t=2 in the sequence of images from the corresponding camera.

In one embodiment, the mask logic component 1026 combines, such as by averaging or summing by pixel, sets of N masked images in the sequences of images to generate sequences of factored images for each camera. In such an embodiment, the second image processors identify and classify background changes by processing the sequence of factored images. A factored image can be generated, for example, by taking an average value for pixels in the N masked images in the sequence of masked images per camera. In one embodiment, the value of N is equal to the frame rate of cameras 114, for example if the frame rate is 30 FPS (frames per second), the value of N is 30. In such an embodiment, the masked images for a time period of one second are combined to generate a factored image. Taking the average pixel values minimizes the pixel fluctuations due to sensor noise and luminosity changes in the area of real space.

The third image processors identify and classify background changes by processing the sequence of factored images. A factored image in the sequences of factored images is compared with the preceding factored image for the same camera by a bit mask calculator 1032. Pairs of factored images 1030 are given as input to the bit mask calculator 1032 to generate a bit mask identifying changes in corresponding pixels of the two factored images. The bit mask has 1s at the pixel locations where the difference between the corresponding pixels' (current and previous factored image) RGB (red, green and blue channels) values is greater than a “difference threshold”. The value of the difference threshold is adjustable. In one embodiment, the value of the difference threshold is set at 0.1.

The bit mask and the pair of factored images (current and previous) from sequences of factored images per camera are given as input to background image recognition engines. In one embodiment, the background image recognition engines comprise convolutional neural networks and are referred to as ChangeCNN 1034a-1034n. A single ChangeCNN processes sequences of factored images per camera. In another embodiment, the masked images from corresponding sequences of images are not combined. The bit mask is calculated from the pairs of masked images. In this embodiment, the pairs of masked images and the bit mask is then given as input to the ChangeCNN.

The input to a ChangeCNN model in this example consists of seven (7) channels including three image channels (red, green and blue) per factored image and one channel for the bit mask. The ChangeCNN comprises of multiple convolutional layers and one or more fully connected (FC) layers. In one embodiment, the ChangeCNN comprises of the same number of convolutional and FC layers as the Joints CNN 112a-112n as illustrated in FIG. 4A.

The background image recognition engines (ChangeCNN 1034a-1034n) identify and classify changes in the factored images and produce change data structures for the corresponding sequences of images. The change data structures include coordinates in the masked images of identified background changes, identifiers of an inventory item subject of the identified background changes and classifications of the identified background changes. The classifications of the identified background changes in the change data structures classify whether the identified inventory item has been added or removed relative to the background image.

As multiple items can be taken or put on the shelf simultaneously by one or more subjects, the ChangeCNN generates a number “B” overlapping bounding box predictions per output location. A bounding box prediction corresponds to a change in the factored image. Consider the shopping store has a number “C” unique inventory items, each identified by a unique SKU. The ChangeCNN predicts the SKU of the inventory item subject of the change. Finally, the ChangeCNN identifies the change (or inventory event type) for every location (pixel) in the output indicating whether the item identified is taken from the shelf or put on the shelf. The above three parts of the output from ChangeCNN are described by an expression “5*B+C+1”. Each bounding box “B” prediction comprises of five (5) numbers, therefore “B” is multiplied by 5. These five numbers represent the “x” and “y” coordinates of the center of the bounding box, the width and height of the bounding box. The fifth number represents ChangeCNN model's confidence score for prediction of the bounding box. “B” is a hyperparameter that can be adjusted to improve the performance of the ChangeCNN model. In one embodiment, the value of “B” equals 4. Consider the width and height (in pixels) of the output from ChangeCNN is represented by W and H, respectively. The output of the ChangeCNN is then expressed as “W*H*(5*B+C+1)”. The bounding box output model is based on object detection system proposed by Redmon and Farhadi in their paper, “YOLO9000: Better, Faster, Stronger” published on Dec. 25, 2016. The paper is available at https://arxiv.org/pdf/1612.08242.pdf.

The outputs of ChangeCNN 1034a-1034n corresponding to sequences of images from cameras with overlapping fields of view are combined by a coordination logic component 1036. The coordination logic component processes change data structures from sets of cameras having overlapping fields of view to locate the identified background changes in real space. The coordination logic component 1036 selects bounding boxes representing the inventory items having the same SKU and the same inventory event type (take or put) from multiple cameras with overlapping fields of view. The selected bounding boxes are then triangulated in the 3D real space using triangulation techniques described above to identify the location of the inventory item in 3D real space. Locations of shelves in the real space are compared with the triangulated locations of the inventory items in the 3D real space. False positive predictions are discarded. For example, if triangulated location of a bounding box does not map to a location of a shelf in the real space, the output is discarded. Triangulated locations of bounding boxes in the 3D real space that map to a shelf are considered true predictions of inventory events.

In one embodiment, the classifications of identified background changes in the change data structures produced by the second image processors classify whether the identified inventory item has been added or removed relative to the background image. In another embodiment, the classifications of identified background changes in the change data structures indicate whether the identified inventory item has been added or removed relative to the background image and the system includes logic to associate background changes with identified subjects. The system makes detections of takes of inventory items by the identified subjects and of puts of inventory items on inventory display structures by the identified subjects.

A log generator component can implement the logic to associate changes identified by true predictions of changes with identified subjects near the location of the change. In an embodiment utilizing the joints identification engine to identify subjects, the log generator can determine the positions of hand joints of subjects in the 3D real space using joint data structures 460. A subject whose hand joint location is within a threshold distance to the location of a change at the time of the change is identified. The log generator associates the change with the identified subject.

In one embodiment, as described above, N masked images are combined to generate factored images which are then given as input to the ChangeCNN. Consider, N equals the frame rate (frames per second) of the cameras 114. Thus, in such an embodiment, the positions of hands of subjects during a one second time period are compared with the location of the change to associate the changes with identified subjects. If more than one subject's hand joint locations are within the threshold distance to a location of a change, then association of the change with a subject is deferred to output of first image processors or second image processors.

The technology disclosed can combine the events in an events stream C from semantic diffing model with events in the events stream A from location-based event detection model. The location-based put and take events are matched to put and take events from semantic diffing model by the event fusion logic component 1018. As described above, the semantic diffing events (or diff events) classify items put or taken from shelves based on background image processing. In one embodiment, the diff events can be combined with existing shelf maps from the maps of shelves including item information or planograms to determine likely items associated with pixel changes represented by diff events. The diff events may not be associated with a subject at the time of detection of the event and may not result in update of log data structure of any source subject or sink subject. The technology disclosed includes logic to match the diff events that may have been associated with a subject or not associated with a subject with a location-based put and take event from events stream A and a region proposals-based put and take event from events stream B.

Semantic diffing events are localized to an area in the 2D image plane in image frames from cameras 114 and have a start time and end time associated with them. The event fusion logic matches the semantic diffing events from event stream C to events in events stream A and events stream B by in between the start and end time of the semantic diffing event. The location-based put and take events and region proposals-based put and take events have 3D positions associated with them based on the hand joint positions in the area of real space. The technology disclosed includes logic to project the 3D positions of the location-based put and take events and region proposal-based put and take events to 2D image planes and compute overlap with the semantic diffing-based events in the 2D image planes. The following three scenarios can result based on how many predicted events from events streams A and B overlap with a semantic diffing event (also referred to as a diff event).

(1) If no event from events stream A and B overlap with a diff event in the time range of the diff event then in this case, the technology disclosed can associate the diff event with the closest person to the shelf in the time range of the diff event.

(2) If one event from events stream A or events stream B overlaps with the diff event in the time range of the diff event then in this case, the system combines the matched event to the diff event by taking a weighted combination of the item predictions from the event stream (A or B) which predicted the event and the item prediction from diff event.

(3) If two or more events from events streams A or B overlap with the diff event in the time range of the diff event, the system selects one of the matched events from events streams A or B. The event that has the closest item classification probability value to the item classification probability value in the diff event can be selected. The system can then take a weighted average of the item classification from the diff event and the item classification from the selected event from events stream A or events stream B.

FIG. 10C shows coordination logic module 1052 combining results of multiple WhatCNN models and giving it as input to a single WhenCNN model. As mentioned above, two or more cameras with overlapping fields of view capture images of subjects in real space. Joints of a single subject can appear in image frames of multiple cameras in respective image channel 1050. A separate WhatCNN model identifies SKUs of inventory items in hands (represented by hand joints) of subjects. The coordination logic module 1052 combines the outputs of WhatCNN models into a single consolidated input for the WhenCNN model. The WhenCNN model operates on the consolidated input to generate the shopping cart of the subject.

An example inventory data structure 1020 (also referred to as a log data structure) is shown in FIG. 10D. This inventory data structure stores the inventory of a subject, shelf or a store as a key-value dictionary. The key is the unique identifier of a subject, shelf or a store and the value is another key value-value dictionary where key is the item identifier such as a stock keeping unit (SKU) and the value is a number identifying the quantity of item along with the “frame_id” of the image frame that resulted in the inventory event prediction. The frame identifier (“frame_id”) can be used to identify the image frame which resulted in identification of an inventory event resulting in association of the inventory item with the subject, shelf, or the store. In other embodiments, a “camera_id” identifying the source camera can also be stored in combination with the frame_id in the inventory data structure 1020. In one embodiment, the “frame_id” is the subject identifier because the frame has the subject's hand in the bounding box. In other embodiments, other types of identifiers can be used to identify subjects such as a “subject_id” which explicitly identifies a subject in the area of real space.

When a put event is detected, the item identified by the SKU in the inventory event (such as location-based event, region proposals-based event, or semantic diffing event) is removed from the log data structure of the source subject. Similarly, when a take event is detected, the item identified by the SKU in the inventory event is added to the log data structure of the sink subject. In an item hand-off or exchange between subjects, the log data structures of both subjects in the hand-off are updated to reflect the item exchange from source subject to sink subject. Similar logic can be applied when subjects take items from shelves or put items on the shelves. Log data structures of shelves can also be updated to reflect the put and take of items.

The shelf inventory data structure can be consolidated with the subject's log data structure, resulting in reduction of shelf inventory to reflect the quantity of item taken by the customer from the shelf. If the item was put on the shelf by a shopper or an employee stocking items on the shelf, the items get added to the respective inventory locations' inventory data structures. Over a period of time, this processing results in updates to the shelf inventory data structures for all inventory locations in the shopping store. Inventory data structures of inventory locations in the area of real space are consolidated to update the inventory data structure of the area of real space indicating the total number of items of each SKU in the store at that moment in time. In one embodiment, such updates are performed after each inventory event. In another embodiment, the store inventory data structures are updated periodically.

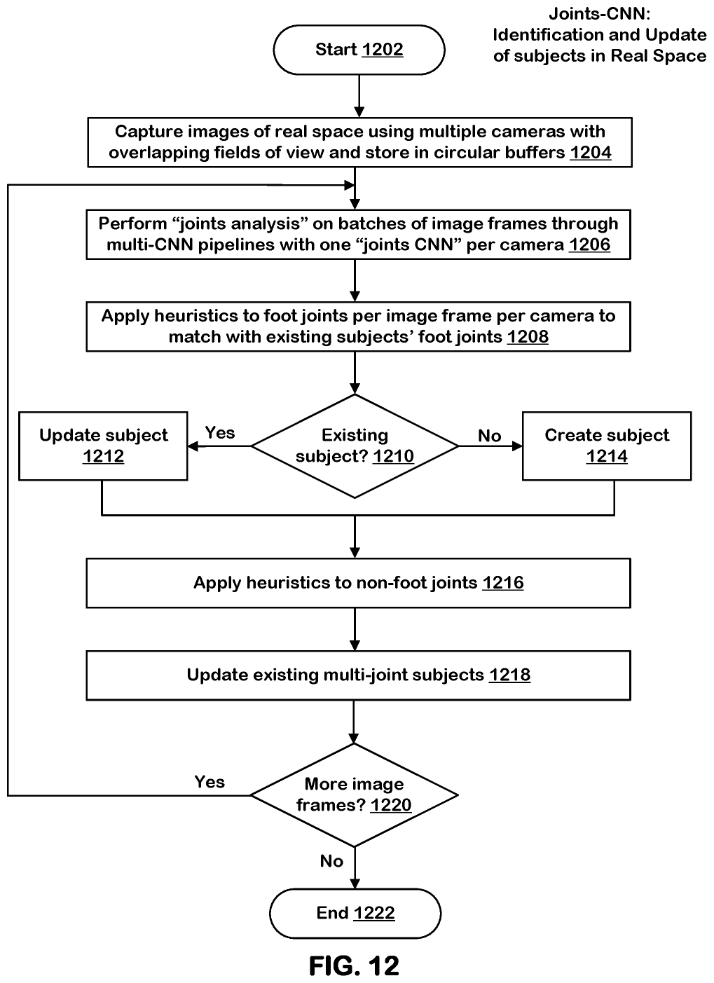

In the following process flowcharts (FIGS. 12 to 17), we present process steps for subject identification using Joints CNN, hand recognition using WhatCNN, time series analysis using WhenCNN, detection of proximity events and proximity event types (put, take, touch), detection of item in a proximity event, and fusion of multiple inventory events streams.

Joints CNN—Identification and Update of Subjects

FIG. 12 is a flowchart of processing steps performed by Joints CNN 112a-112n to identify subjects in the real space. In the example of a shopping store, the subjects are shoppers or customers moving in the store in aisles between shelves and other open spaces. The process starts at step 1202. Note that, as described above, the cameras are calibrated before sequences of images from cameras are processed to identify subjects. Details of camera calibration are presented above. Cameras 114 with overlapping fields of view capture images of real space in which subjects are present (step 1204). In one embodiment, the cameras are configured to generate synchronized sequences of images. The sequences of images of each camera are stored in respective circular buffers 1002 per camera. A circular buffer (also referred to as a ring buffer) stores the sequences of images in a sliding window of time. In an embodiment, a circular buffer stores 110 image frames from a corresponding camera. In another embodiment, each circular buffer 1002 stores image frames for a time period of 3.5 seconds. It is understood, in other embodiments, the number of image frames (or the time period) can be greater than or less than the example values listed above.

Joints CNNs 112a-112n, receive sequences of image frames from corresponding cameras 114 as output from a circular buffer, with or without resolution reduction (step 1206). Each Joints CNN processes batches of images from a corresponding camera through multiple convolution network layers to identify joints of subjects in image frames from corresponding camera. The architecture and processing of images by an example convolutional neural network is presented FIG. 4A. As cameras 114 have overlapping fields of view, the joints of a subject are identified by more than one joints-CNN. The two-dimensional (2D) coordinates of joints data structures 460 produced by Joints CNN are mapped to three dimensional (3D) coordinates of the real space to identify joints locations in the real space. Details of this mapping are presented above in which the subject tracking engine 110 translates the coordinates of the elements in the arrays of joints data structures corresponding to images in different sequences of images into candidate joints having coordinates in the real space.

The joints of a subject are organized in two categories (foot joints and non-foot joints) for grouping the joints into constellations, as discussed above. The left and right-ankle joint type in the current example, are considered foot joints for the purpose of this procedure. At step 1208, heuristics are applied to assign a candidate left foot joint and a candidate right foot joint to a set of candidate joints to create a subject. Following this, at step 1210, it is determined whether the newly identified subject already exists in the real space. If not, then a new subject is created at step 1214, otherwise, the existing subject is updated at step 1212.

Other joints from the galaxy of candidate joints can be linked to the subject to build a constellation of some or all of the joint types for the created subject. At step 1216, heuristics are applied to non-foot joints to assign those to the identified subjects. A global metric calculator can calculate the global metric value and attempts to minimize the value by checking different combinations of non-foot joints. In one embodiment, the global metric is a sum of heuristics organized in four categories as described above.

The logic to identify sets of candidate joints comprises heuristic functions based on physical relationships among joints of subjects in real space to identify sets of candidate joints as subjects. At step 1218, the existing subjects are updated using the corresponding non-foot joints. If there are more images for processing (step 1220), steps 1206 to 1218 are repeated, otherwise the process ends at step 1222. A first data sets are produced at the end of the process described above. The first data sets identify subject and the locations of the identified subjects in the real space. In one embodiment, the first data sets are presented above in relation to FIGS. 10A and 10B as joints data structures 460 per subject.

WhatCNN—Classification of Hand Joints

FIG. 13 is a flowchart illustrating process steps to identify inventory items in hands of subjects (shoppers) identified in the real space. As the subjects move in aisles and opens spaces, they pick up inventory items stocked in the shelves and put items in their shopping cart or basket. The image recognition engines identify subjects in the sets of images in the sequences of images received from the plurality of cameras. The system includes the logic to process sets of images in the sequences of images that include the identified subjects to detect takes of inventory items by identified subjects and puts of inventory items on the shelves by identified subjects.

In one embodiment, the logic to process sets of images includes, for the identified subjects, generating classifications of the images of the identified subjects. The classifications can include, predicting whether the identified subject is holding an inventory item. The classifications can include a first nearness classification indicating a location of a hand of the identified subject relative to a shelf. The classifications can include, a second nearness classification indicating a location a hand of the identified subject relative to a body of the identified subject. The classifications can further include, a third nearness classification indicating a location of a hand of an identified subject relative to a basket associated with the identified subject. The classification can include, a fourth nearness classification of the hand that identifies location of a hand of a subject positioned close to the hand of another subject. Finally, the classifications can include an identifier of a likely inventory item.

In another embodiment, the logic to process sets of images includes, for the identified subjects, identifying bounding boxes of data representing hands in images in the sets of images of the identified subjects. The data in the bounding boxes is processed to generate classifications of data within the bounding boxes for the identified subjects. In such an embodiment, the classifications can include predicting whether the identified subject is holding an inventory item. The classifications can include, a first nearness classification indicating a location of a hand of the identified subject relative to a shelf. The classifications can include, a second nearness classification indicating a location of a hand of the identified subject relative to a body of the identified subject. The classifications can include, a third nearness classification indicating a location of a hand of the identified subject relative to a basket associated with an identified subject. The classification can include, a fourth nearness classification of the hand that identifies location of a hand of a subject positioned close to the hand of another subject. Finally, the classifications can include an identifier of a likely inventory item.

The process starts at step 1302. At step 1304, locations of hands (represented by hand joints) of subjects in image frames are identified. The bounding box generator 1304 identifies hand locations of subjects per frame from each camera using joint locations identified in the first data sets generated by Joints CNNs 112a-112n. Following this, at step 1306, the bounding box generator 1008 processes the first data sets to specify bounding boxes which include images of hands of identified multi joint subjects in images in the sequences of images. Details of bounding box generator are presented above with reference to FIG. 10A.

A second image recognition engine receives sequences of images from the plurality of cameras and processes the specified bounding boxes in the images to generate a classification of hands of the identified subjects (step 1308). In one embodiment, each of the image recognition engines used to classify the subjects based on images of hands comprises a trained convolutional neural network referred to as a WhatCNN 1010. WhatCNNs are arranged in multi-CNN pipelines as described above in relation to FIG. 10A. In one embodiment, the input to a WhatCNN is a multi-dimensional array B×W×H×C (also referred to as a B×W×H×C tensor). “B” is the batch size indicating the number of image frames in a batch of images processed by the WhatCNN. “W” and “H” indicate the width and height of the bounding boxes in pixels, “C” is the number of channels. In one embodiment, there are 30 images in a batch (B=30), so the size of the bounding boxes is 32 pixels (width) by 32 pixels (height). There can be six channels representing red, green, blue, foreground mask, forearm mask and upperarm mask, respectively. The foreground mask, forearm mask and upperarm mask are additional and optional input data sources for the WhatCNN in this example, which the CNN can include in the processing to classify information in the RGB image data. The foreground mask can be generated using mixture of Gaussian algorithms, for example. The forearm mask can be a line between the wrist and elbow providing context produced using information in the Joints data structure. Likewise, the upperarm mask can be a line between the elbow and shoulder produced using information in the Joints data structure. Different values of B, W, H and C parameters can be used in other embodiments. For example, in another embodiment, the size of the bounding boxes is larger e.g., 64 pixels (width) by 64 pixels (height) or 128 pixels (width) by 128 pixels (height).

Each WhatCNN 1010 processes batches of images to generate classifications of hands of the identified subjects. The classifications can include whether the identified subject is holding an inventory item. The classifications can further include one or more classifications indicating locations of the hands relative to the shelf and relative to the subject, relative to a shelf or a basket, and relative to a hand or another subject, usable to detect puts and takes. In this example, a first nearness classification indicates a location of a hand of the identified subject relative to a shelf. The classifications can include a second nearness classification indicating a location a hand of the identified subject relative to a body of the identified subject. A subject may hold an inventory item during shopping close to his or her body instead of placing the item in a shopping cart or a basket. The classifications can further include a third nearness classification indicating a location of a hand of the identified subject relative to a basket associated with an identified subject. A “basket” in this context can be a bag, a basket, a cart or other object used by the subject to hold the inventory items during shopping. The classification can include, a fourth nearness classification of the hand that identifies location of a hand of a subject positioned close to the hand of another subject. Finally, the classifications can include an identifier of a likely inventory item. The final layer of the WhatCNN 1010 produces logits which are raw values of predictions. The logits are represented as floating point values and further processed, as described below, for generating a classification result. In one embodiment, the outputs of the WhatCNN model, include a multi-dimensional array B×L (also referred to as a B×L tensor). “B” is the batch size, and “L=N+5” is the number of logits output per image frame. “N” is the number of SKUs representing “N” unique inventory items for sale in the shopping store.

The output “L” per image frame is a raw activation from the WhatCNN 1010. Logits “L” are processed at step 1310 to identify inventory item and context. The first “N” logits represent confidence that the subject is holding one of the “N” inventory items. Logits “L” include an additional five (5) logits which are explained below. The first logit represents confidence that the image of the item in hand of the subject is not one of the store SKU items (also referred to as non-SKU item). The second logit indicates a confidence whether the subject is holding an item or not. A large positive value indicates that WhatCNN model has a high level of confidence that the subject is holding an item. A large negative value indicates that the model is confident that the subject is not holding any item. A close to zero value of the second logit indicates that WhatCNN model is not confident in predicting whether the subject is holding an item or not. The value of the holding logit is provided as input to the proximity event detector for location-based put and take detection.

The next three logits represent first, second and third nearness classifications, including a first nearness classification indicating a location of a hand of the identified subject relative to a shelf, a second nearness classification indicating a location of a hand of the identified subject relative to a body of the identified subject, a third nearness classification indicating a location of a hand of the identified subject relative to a basket associated with an identified subject. Thus, the three logits represent context of the hand location with one logit each indicating confidence that the context of the hand is near to a shelf, near to a basket (or a shopping cart), or near to a body of the subject. In one embodiment, the output can include a fourth logit representing context of the hand of a subject positioned close to hand of another subject. In one embodiment, the WhatCNN is trained using a training dataset containing hand images in the three contexts: near to a shelf, near to a basket (or a shopping cart), and near to a body of a subject. In another embodiment, the WhatCNN is trained using a training dataset containing hand images in the four contexts: near to a shelf, near to a basket (or a shopping cart), and near to a body of a subject, near to hand of another subject. In another embodiment, a “nearness” parameter is used by the system to classify the context of the hand. In such an embodiment, the system determines the distance of a hand of the identified subject to the shelf, basket (or a shopping cart), and body of the subject to classify the context.

The output of a WhatCNN is “L” logits comprised of N SKU logits, 1 Non-SKU logit, 1 holding logit, and 3 context logits as described above. The SKU logits (first N logits) and the non-SKU logit (the first logit following the N logits) are processed by a softmax function. As described above with reference to FIG. 4A, the softmax function transforms a K-dimensional vector of arbitrary real values to a K-dimensional vector of real values in the range [0, 1] that add up to 1. A softmax function calculates the probabilities distribution of the item over N+1 items. The output values are between 0 and 1, and the sum of all the probabilities equals one. The softmax function (for multi-class classification) returns the probabilities of each class. The class that has the highest probability is the predicted class (also referred to as target class). The value of the predicted item class is averaged over N frames before and after the proximity event to determine the item associated with the proximity event.

The holding logit is processed by a sigmoid function. The sigmoid function takes a real number value as input and produces an output value in the range of 0 to 1. The output of the sigmoid function identifies whether the hand is empty or holding an item. The three context logits are processed by a softmax function to identify the context of the hand joint location. At step 1312, it is checked if there are more images to process. If true, steps 1304-1310 are repeated, otherwise the process ends at step 1314.

WhenCNN—Time Series Analysis to Identify Puts and Takes of Items

In one embodiment, the technology disclosed performs time sequence analysis over the classifications of subjects to detect takes and puts by the identified subjects based on foreground image processing of the subjects. The time sequence analysis identifies gestures of the subjects and inventory items associated with the gestures represented in the sequences of images.

The outputs of WhatCNNs 1010 are given as input to the WhenCNN 1012 which processes these inputs to detect puts and takes of items by the identified subjects. The system includes logic, responsive to the detected takes and puts, to generate a log data structure including a list of inventory items for each identified subject. In the example of a shopping store, the log data structure is also referred to as a shopping cart data structure 1020 per subject.

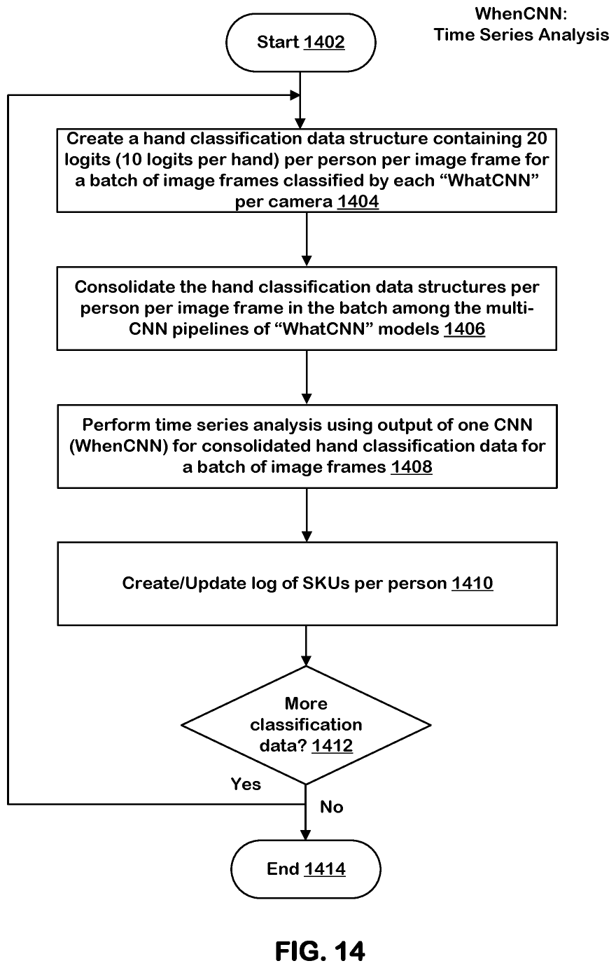

FIG. 14 presents a process implementing the logic to generate a shopping cart data structure per subject. The process starts at step 1402. The input to WhenCNN 1012 is prepared at step 1404. The input to the WhenCNN is a multi-dimensional array B×C×T×Cams, where B is the batch size, C is the number of channels, T is the number of frames considered for a window of time, and Cams is the number of cameras 114. In one embodiment, the batch size “B” is 64 and the value of “T” is 110 image frames or the number of image frames in 3.5 seconds of time. It is understood that other values of batch size “B” greater than or less than 64 can be used. Similarly, the value of the parameter “T” can be set greater than or less than 110 images frames or a time period greater than or less than 3.5 seconds can be used to select the number of frames for processing.

For each subject identified per image frame, per camera, a list of 10 logits per hand joint (20 logits for both hands) is produced. The holding and context logits are part of the “L” logits generated by WhatCNN 1010 as described above.

| [ | |
|---|---|
| holding, | # 1 logit |
| context, | # 3 logits |
| slice_dot(sku, log_sku), | # 1 logit |
| slice_dot(sku, log_other_sku), | # 1 logit |
| slice_dot(sku, roll(log_sku, −30)), | # 1 logit |
| slice_dot(sku, roll(log_sku, 30)), | # 1 logit |
| slice_dot(sku, roll(log_other_sku, −30)), | # 1 logit |
| slice_dot(sku, roll(log_other_sku, 30)) | # 1 logit |
| ] | |

The above data structure is generated for each hand in an image frame and also includes data about the other hand of the same subject. For example, if data is for the left hand joint of a subject, corresponding values for the right hand are included as “other” logits. The fifth logit (item number 3 in the list above referred to as log_sku) is the log of SKU logit in “L” logits described above. The sixth logit is the log of SKU logit for other hand. A “roll” function generates the same information before and after the current frame. For example, the seventh logit (referred to as roll(log_sku, −30)) is the log of the SKU logit, 30 frames earlier than the current frame. The eighth logit is the log of the SKU logits for the hand, 30 frames later than the current frame. The ninth and tenth data values in the list are similar data for the other hand 30 frames earlier and 30 frames later than the current frame. A similar data structure for the other hand is also generated, resulting in a total of 20 logits per subject per image frame per camera. Therefore, the number of channels in the input to the WhenCNN is 20 (i.e. C=20 in the multi-dimensional array B×C×T×Cams), whereas “Cams” represents the number of cameras in the area of real space.

For all image frames in the batch of image frames (e.g., B=64) from each camera, similar data structures of 20 hand logits per subject, identified in the image frame, are generated. A window of time (T=3.5 seconds or 110 image frames) is used to search forward and backward image frames in the sequence of image frames for the hand joints of subjects. At step 1406, the 20 hand logits per subject per frame are consolidated from multiple WhatCNNs. In one embodiment, the batch of image frames (64) can be imagined as a smaller window of image frames placed in the middle of a larger window of image frame 110 with additional image frames for forward and backward search on both sides. The input B×C×T×Cams to WhenCNN 1012 is composed of 20 logits for both hands of subjects identified in batch “B” of image frames from all cameras 114 (referred to as “Cams”). The consolidated input is given to a single trained convolutional neural network referred to as WhenCNN model 1508.

The output of the WhenCNN model comprises of 3 logits, representing confidence in three possible actions of an identified subject: taking an inventory item from a shelf, putting an inventory item back on the shelf, and no action. The three output logits are processed by a softmax function to predict an action performed. The three classification logits are generated at regular intervals for each subject and results are stored per person along with a time stamp. In one embodiment, the three logits are generated every twenty frames per subject. In such an embodiment, at an interval of every 20 image frames per camera, a window of 110 image frames is formed around the current image frame.

A time series analysis of these three logits per subject over a period of time is performed (step 1408) to identify gestures corresponding to true events and their time of occurrence. A non-maximum suppression (NMS) algorithm is used for this purpose. As one event (i.e. put or take of an item by a subject) is detected by WhenCNN 1012 multiple times (both from the same camera and from multiple cameras), the NMS removes superfluous events for a subject. NMS is a rescoring technique comprising two main tasks: “matching loss” that penalizes superfluous detections and “joint processing” of neighbors to know if there is a better detection close-by.

The true events of takes and puts for each subject are further processed by calculating an average of the SKU logits for 30 image frames prior to the image frame with the true event. Finally, the arguments of the maxima (abbreviated arg max or argmax) is used to determine the largest value. The inventory item classified by the argmax value is used to identify the inventory item put or take from the shelf. The inventory item is added to a log of SKUs (also referred to as shopping cart or basket) of respective subjects in step 1410. The process steps 1404 to 1410 are repeated, if there is more classification data (checked at step 1412). Over a period of time, this processing results in updates to the shopping cart or basket of each subject. The process ends at step 1414.

We now present process flowcharts for location-based event detection, item detection in location-based events and fusion of location-based events stream with region proposals-based events stream and semantic diffing-based events stream.

### Process Flowchart for Proximity Event Detection

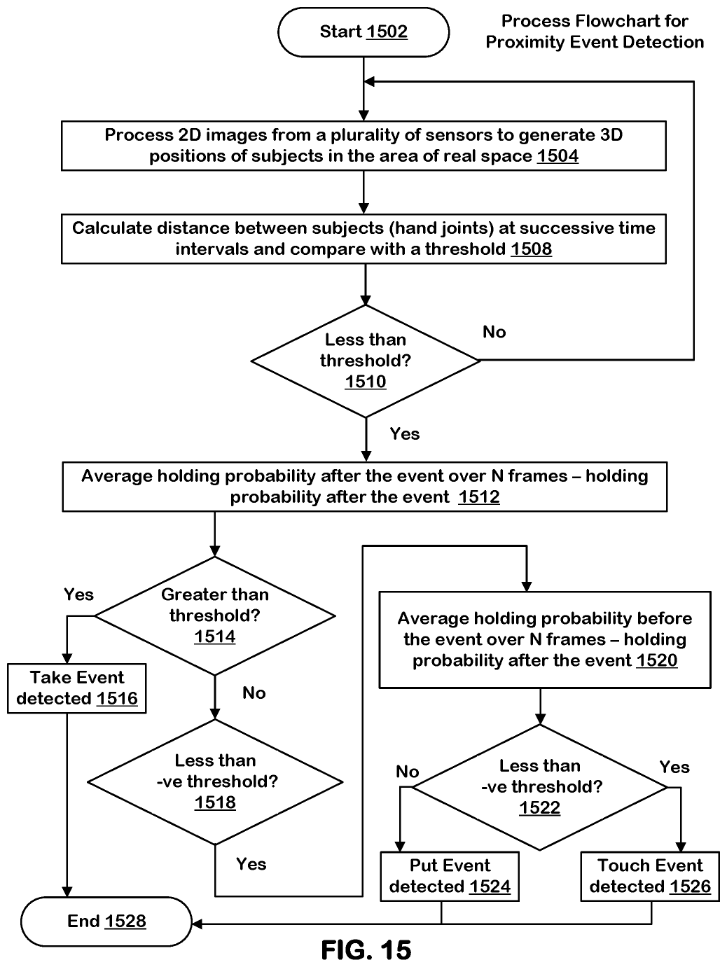

FIG. 15 presents a flowchart of process steps for detecting location-based events in the area of real space. The process starts at a step 1502. The system processes 2D images from a plurality of sensors to generate 3D positions of subjects in the area of real space (step 1504). As described above, the system uses image frames from synchronized sensors with overlapping fields of views for 3D scene generation. In one embodiment, the system uses joints to create and track subjects in the area of real space. The system calculates distances between hand joints (both left and right hands) of subjects at regular time intervals and compares the distances with a threshold. If the distance between hand joints of two subjects is below a threshold (step 1510), the system continues the process steps for detecting the type of the proximity event (put, take or touch). Otherwise, the system repeats steps 1504 to 1510 for detecting proximity events.

At a step 1512, the system calculates average holding probability over N frames after the frame in which the proximity event was detected for the subjects whose hands were positioned closer than the threshold. Note that WhatCNN model described above outputs holding probability per hand per subject per frame which is used in this process step. The system calculates difference between average holding probability over N frames after the proximity event and the holding probability in a frame following the frame in which proximity event is detected. If the result of the difference is greater than a threshold (step 1514), the system detects a take event (step 1516) for the subject in the image frame. Note that when one subject hands-off an item to another subject, the location-based event can have a take event (for the subject who takes the item) and a put event (for the subject who hands-off the item). The system processes the logic described in this flowchart for each hand joint in the proximity event thus the system is able to detect both take and put events for the subjects in the location-based events. If at step 1514, it is determined that the difference between the average holding probability value over N frames after the event and the holding probability value in the frame following the proximity event is not greater than the threshold (step 1514), the system compares the difference to a negative threshold (step 1518). If the difference is less than the negative threshold then the proximity event can be a put event, however, it can also indicate a touch event. Therefore, the system calculates the difference between average holding probability value over N frames before the proximity event and holding probability value after the proximity event (step 1520). If the difference is less than a negative threshold, the system detects a touch event (step 1526). Otherwise, the system detects a put event (step 1524). The process ends at a step 1528.

### Process Flowchart for Item Detection

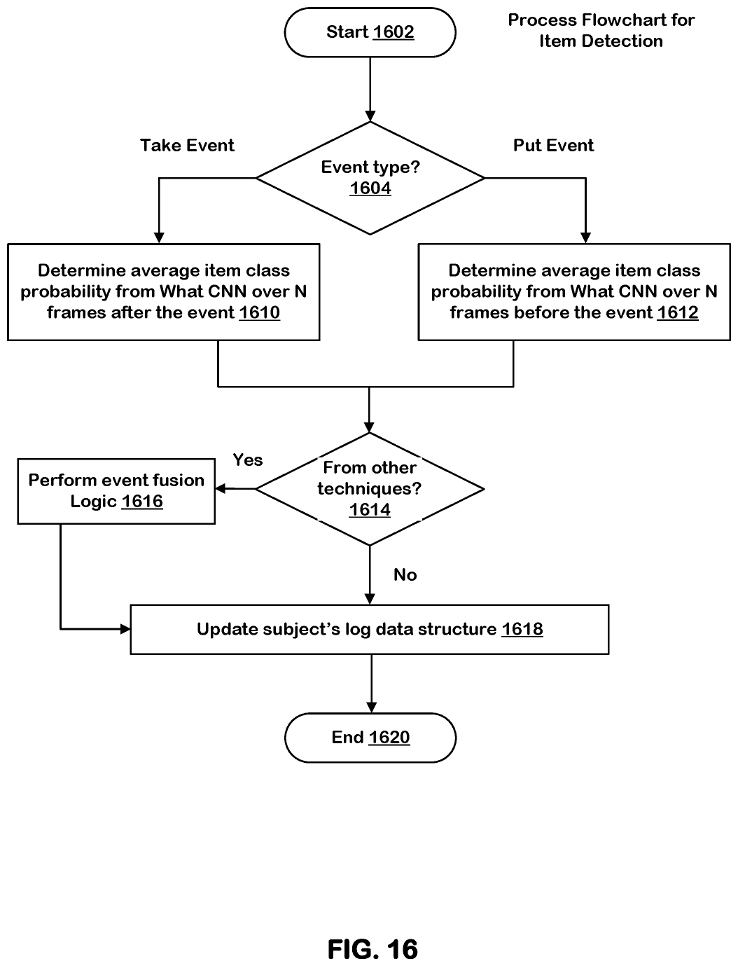

FIG. 16 presents a process flowchart for item detection in a proximity event. The process starts at a step 1602. The event type is detected at a step 1604. We presented detailed process steps of event type detection in the process flowchart in FIG. 15. If a take event is detected (step 1606), the process continues at a step 1610. The system determines average item class probability by taking an average of item class probability values from WhatCNN over N frames after the frame in which proximity event is detected. If a put event is detected the process continues at a step 1612 in the process flowchart. The system determines average item class probability by taking an average of item class probability values from WhatCNN over N frames before the frame in which proximity event is detected.

At a step 1614, the system checks if event streams from other event detection techniques have a matching event. We have presented details of two parallel event detection techniques above: a region proposals-based event detection technique (also referred to as second image processors) and a semantic diffing-based event detection technique (also referred to as third image processors). If a matching event is detected from other event detection techniques, the system combines the two events using event fusion logic in a step 1616. As described above, the event fusion logic can include weighted combination of events from multiple event streams. If no matching event is detected from other events streams, then the system can use the item classification from location-based event. The process continues at a step 1618 in which the subject's log data structure is updated using the item classification and the event type. The process ends at a step 1620.

### Process Flowchart for Events Stream Fusion

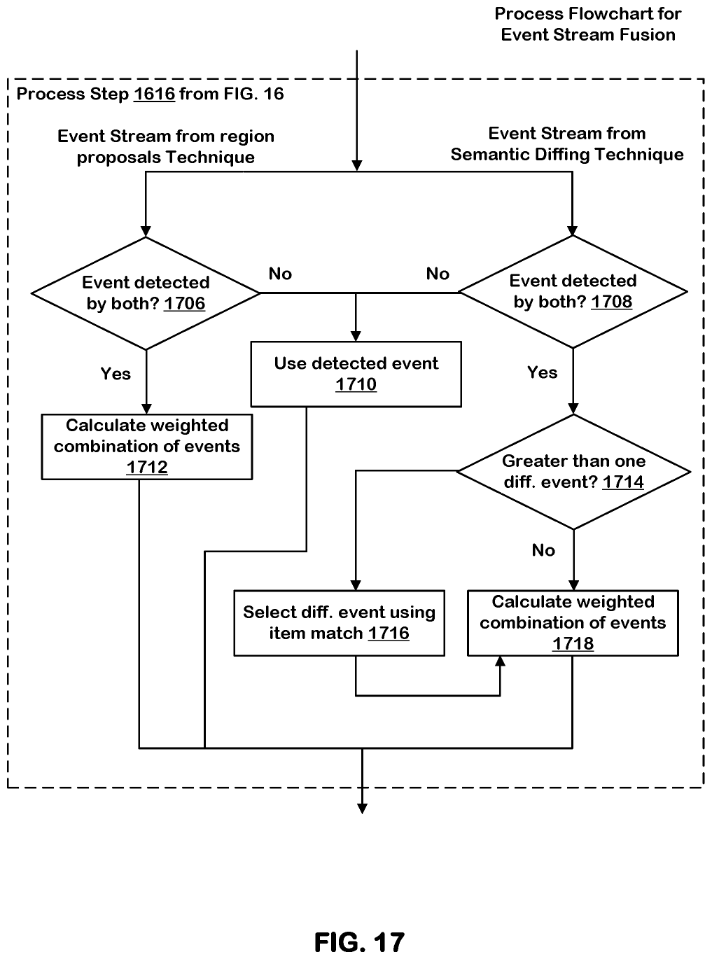

FIG. 17 presents detailed process steps for event fusion logic step 1616 from FIG. 16. The system determines a matching event from region proposals-based technique at a step 1706 and semantic diffing-based technique at a step 1708. If no matching event is detected from other event streams, the system uses the detected event to update the log data structure of the subject (step 1710). If matching events are detected from region proposals-based technique, the system calculates a weighted combination of events from both stream (step 1712) to update the log data structure of the subject. If matching event is detected from semantic diffing-based technique (step 1708), the system determines if more than one event from semantic diffing-based technique matches the location-based event (step 1714). If there are more than one matching events from semantic diffing-based technique, then the matching event with closest item class probability value to the item class probability value in the location-based event is selected (step 1716). The system calculates a weighted combination of events at a step 1718. The output from process step 1616 is used to update log data structures of subjects as shown in the process flowchart in FIG. 16.

### Example Architecture of What-CNN Model

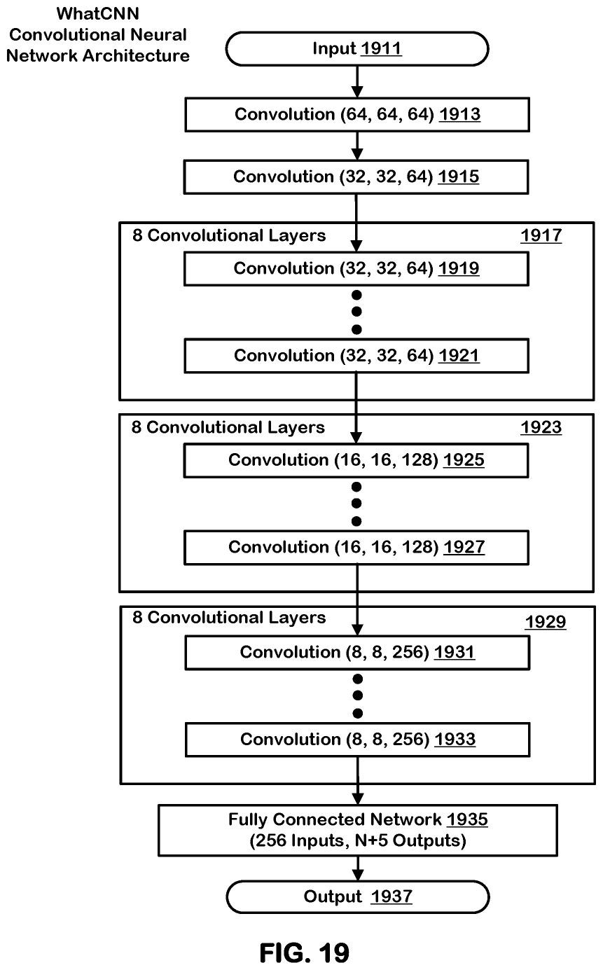

FIG. 19 presents an example architecture of WhatCNN model 1010. In this example architecture, there are a total of 26 convolutional layers. The dimensionality of different layers in terms of their respective width (in pixels), height (in pixels) and number of channels is also presented. The first convolutional layer 1913 receives input 1911 and has a width of 64 pixels, height of 64 pixels and has 64 channels (written as 64×64×64). The details of input to the WhatCNN are presented above. The direction of arrows indicates flow of data from one layer to the following layer. The second convolutional layer 1915 has a dimensionality of 32×32×64. Followed by the second layer, there are eight convolutional layers (shown in box 1917) each with a dimensionality of 32×32×64. Only two layers 1919 and 1921 are shown in the box 1917 for illustration purposes. This is followed by another eight convolutional layers 1923 of 16×16×128 dimensions. Two such convolutional layers 1925 and 1927 are shown in FIG. 19. Finally, the last eight convolutional layers 1929, have a dimensionality of 8×8×256 each. Two convolutional layers 1931 and 1933 are shown in the box 1929 for illustration.

There is one fully connected layer 1935 with 256 inputs from the last convolutional layer 2133 producing N+5 outputs. As described above, “N” is the number of SKUs representing “N” unique inventory items for sale in the shopping store. The five additional logits include the first logit representing confidence that item in the image is a non-SKU item, and the second logit representing confidence whether the subject is holding an item. The next three logits represent first, second and third nearness classifications, as described above. The final output of the WhatCNN is shown at 1937. The example architecture uses batch normalization (BN). Distribution of each layer in a convolutional neural network (CNN) changes during training and it varies from one layer to another. This reduces convergence speed of the optimization algorithm. Batch normalization (Ioffe and Szegedy 2015) is a technique to overcome this problem. ReLU (Rectified Linear Unit) activation is used for each layer's non-linearity except for the final output where softmax is used.

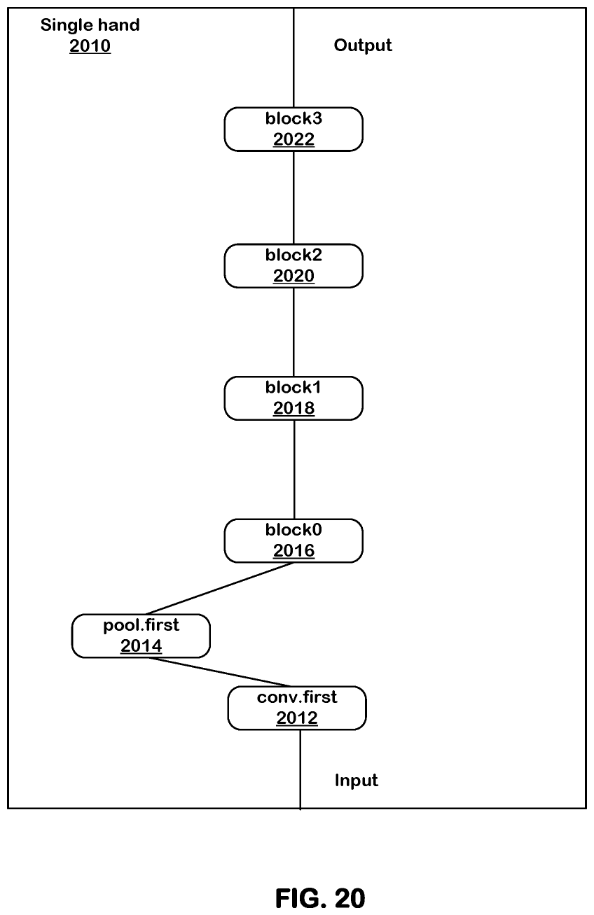

FIGS. 20, 21, and 22 are graphical visualizations of different parts of an implementation of WhatCNN 1010. The figures are adapted from graphical visualizations of a WhatCNN model generated by TensorBoard™. TensorBoard™ is a suite of visualization tools for inspecting and understanding deep learning models e.g., convolutional neural networks.

FIG. 20 shows a high-level architecture of the convolutional neural network model that detects a single hand (“single hand” model 2010). WhatCNN model 1010 comprises two such convolutional neural networks for detecting left and right hands, respectively. In the illustrated embodiment, the architecture includes four blocks referred to as block0 2016, block1 2018, block2 2020, and block3 2022. A block is a higher-level abstraction and comprises multiple nodes representing convolutional layers. The blocks are arranged in a sequence from lower to higher such that output from one block is input to a successive block. The architecture also includes a pooling layer 2014 and a convolution layer 2012. In between the blocks, different non-linearities can be used. In the illustrated embodiment, a ReLU non-linearity is used as described above.

In the illustrated embodiment, the input to the single hand model 2010 is a B×W×H×C tensor defined above in description of WhatCNN 1506. “B” is the batch size, “W” and “H” indicate the width and height of the input image, and “C” is the number of channels. The output of the single hand model 2010 is combined with a second single hand model and passed to a fully connected network.

During training, the output of the single hand model 2010 is compared with ground truth. A prediction error calculated between the output and the ground truth is used to update the weights of convolutional layers. In the illustrated embodiment, stochastic gradient descent (SGD) is used for training WhatCNN 1010.

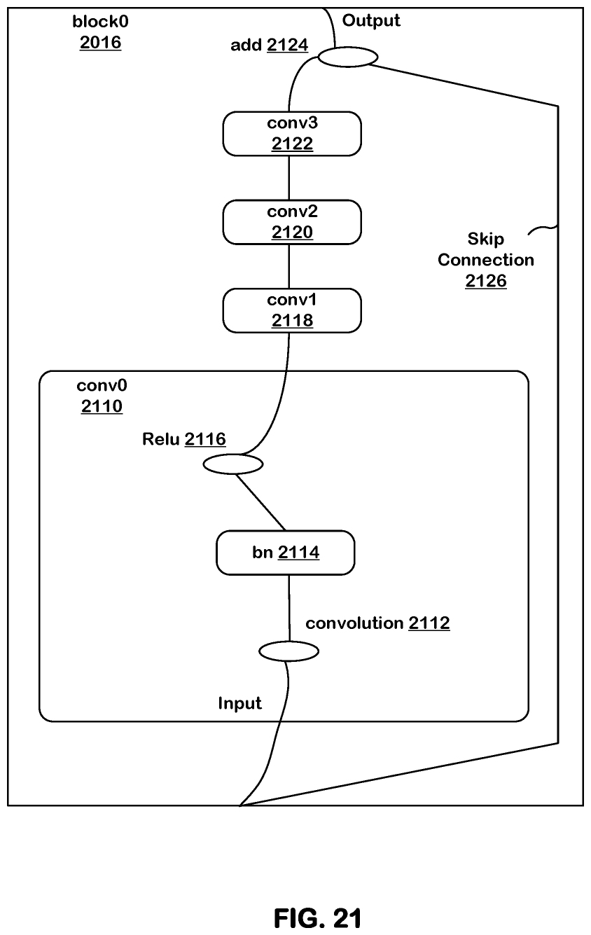

FIG. 21 presents further details of the block0 2016 of the single hand convolutional neural network model of FIG. 20. It comprises four convolutional layers labeled as conv0 in box 2110, conv1 2118, conv2 2120, and conv3 2122. Further details of the convolutional layer conv0 are presented in the box 2110. The input is processed by a convolutional layer 2112. The output of the convolutional layer is processed by a batch normalization layer 2114. ReLU non-linearity 2116 is applied to the output of the batch normalization layer 2114. The output of the convolutional layer conv0 is passed to the next layer conv1 2118. The output of the final convolutional layer conv3 is processed through an addition operation 2124. This operation sums the output from the layer conv3 2322 to unmodified input coming through a skip connection 2126. It has been shown by He et al. in their paper titled, “Identity mappings in deep residual networks” (published at https://arxiv.org/pdf/1603.05027.pdf on Jul. 25, 2016) that forward and backward signals can be directly propagated from one block to any other block. The signal propagates unchanged through the convolutional neural network. This technique improves training and test performance of deep convolutional neural networks.

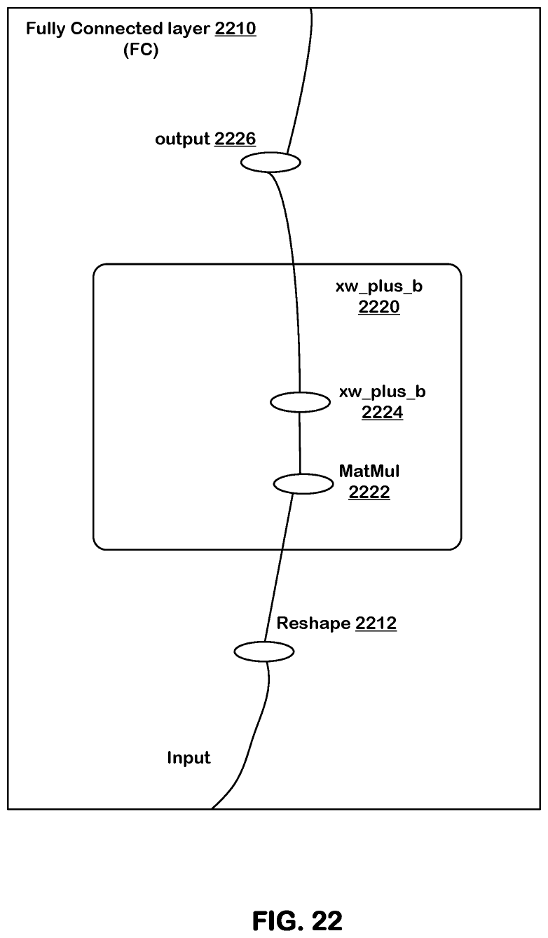

As described with reference to FIG. 19, the output of convolutional layers of a WhatCNN is processed by a fully connected layer. The outputs of two single hand models 2010 are combined and passed as input to a fully connected layer. FIG. 22 is an example implementation of a fully connected layer (FC) 2210. The input to the FC layer is processed by a reshape operator 2212. The reshape operator changes the shape of the tensor before passing it to a next layer 2220. Reshaping includes flattening the output from the convolutional layers i.e., reshaping the output from a multi-dimensional matrix to a one-dimensional matrix or a vector. The output of the reshape operator 2212 is passed to a matrix multiplication operator labelled as MatMul 2222. The output from the MatMul operator 2222 is passed to a matrix plus addition operator labelled as xw_plus_b 2224. For each input “x”, the operator 2224 multiplies the input by a matrix “w” and a vector “b” to produce the output. “w” is a trainable parameter associated with the input “x” and “b” is another trainable parameter which is called bias or intercept. The output 2226 from the fully connecter layer 2210 is a B×L tensor as explained above in the description of WhatCNN 1010. “B” is the batch size, and “L=N+5” is the number of logits output per image frame. “N” is the number of SKUs representing “N” unique inventory items for sale in the shopping store.

### Training of WhatCNN Model

A training data set of images of hands holding different inventory items in different contexts, as well as empty hands in different contexts is created. To achieve this, human actors hold each unique SKU inventory item in multiple different ways, at different locations of a test environment. The context of their hands range from being close to the actor's body, being close to the store's shelf, and being close to the actor's shopping cart or basket. The actor performs the above actions with an empty hand as well. This procedure is completed for both left and right hands. Multiple actors perform these actions simultaneously in the same test environment to simulate the natural occlusion that occurs in real shopping stores.

Cameras 114 takes images of actors performing the above actions. In one embodiment, twenty cameras are used in this process. The joints CNNs 112a-112n and the tracking engine 110 process the images to identify joints. The bounding box generator 1008 creates bounding boxes of hand regions similar to production or inference. Instead of classifying these hand regions via the WhatCNN 1010, the images are saved to a storage disk. Stored images are reviewed and labelled. An image is assigned three labels: the inventory item SKU, the context, and whether the hand is holding something or not. This process is performed for a large number of images (up to millions of images).

The image files are organized according to data collection scenes. The naming convention for image file identifies content and context of the images. A first part of the file name identifies the data collection scene and also includes the timestamp of the image. A second part of the file name identifies the source camera e.g., “camera 4”. A third part of the file name identifies the frame number from the source camera, e.g., a file name can include a value such as 94,600^{th} image frame from camera 4. A fourth part of the file name identifies ranges of x and y coordinates region in the source image frame from which this hand region image is taken. In the illustrated example, the region is defined between x coordinate values from pixel 117 to 370 and y coordinates values from pixels 370 and 498. A fifth part of the file name identifies the subject identifier of the actor in the scene, e.g., subject with an identifier “3”. Finally, a sixth part of the file name identifies the SKU number (e.g., item=68) of the inventory item, identified in the image.

In training mode of the WhatCNN 1010, forward passes and backpropagations are performed as opposed to production mode in which only forward passes are performed. During training, the WhatCNN generates a classification of hands of the identified subjects in a forward pass. The output of the WhatCNN is compared with the ground truth. In the backpropagation, a gradient for one or more cost functions is calculated. The gradient(s) are then propagated to the convolutional neural network (CNN) and the fully connected (FC) neural network so that the prediction error is reduced causing the output to be closer to the ground truth. In one embodiment, stochastic gradient descent (SGD) is used for training WhatCNN 1010.

In one embodiment, 64 images are randomly selected from the training data and augmented. The purpose of image augmentation is to diversify the training data resulting in better performance of models. The image augmentation includes random flipping of the image, random rotation, random hue shifts, random Gaussian noise, random contrast changes, and random cropping. The amount of augmentation is a hyperparameter and is tuned through hyperparameter search. The augmented images are classified by WhatCNN 1010 during training. The classification is compared with ground truth and coefficients or weights of WhatCNN 1010 are updated by calculating gradient loss function and multiplying the gradient with a learning rate. The above process is repeated many times (e.g., approximately 1000 times) to form an epoch. Between 50 to 200 epochs are performed. During each epoch, the learning rate is slightly decreased following a cosine annealing schedule.

### Training of WhenCNN Model

Training of WhenCNN 1012 is similar to the training of WhatCNN 1010 described above, using backpropagations to reduce prediction error. Actors perform a variety of actions in the training environment. In the example embodiment, the training is performed in a shopping store with shelves stocked with inventory items. Examples of actions performed by actors include, take an inventory item from a shelf, put an inventory item back on a shelf, put an inventory item into a shopping cart (or a basket), take an inventory item back from the shopping cart, swap an item between left and right hands, put an inventory item into the actor's nook. A nook refers to a location on the actor's body that can hold an inventory item besides the left and right hands. Some examples of nook include, an inventory item squeezed between a forearm and upper arm, squeezed between a forearm and a chest, squeezed between neck and a shoulder.

The cameras 114 record videos of all actions described above during training. The videos are reviewed, and all image frames are labelled indicating the timestamp and the action performed. These labels are referred to as action labels for respective image frames. The image frames are processed through the multi-CNN pipelines up to the WhatCNNs 1010 as described above for production or inference. The output of WhatCNNs along with the associated action labels are then used to train the WhenCNN 1012, with the action labels acting as ground truth. Stochastic gradient descent (SGD) with a cosine annealing schedule is used for training as described above for training of WhatCNN 1010.

In addition to image augmentation (used in training of WhatCNN), temporal augmentation is also applied to image frames during training of the WhenCNN. Some examples include mirroring, adding Gaussian noise, swapping the logits associated with left and right hands, shortening the time, shortening the time series by dropping image frames, lengthening the time series by duplicating frames, and dropping the data points in the time series to simulate spottiness in the underlying model generating input for the WhenCNN. Mirroring includes reversing the time series and respective labels, for example a put action becomes a take action when reversed.

### Process Flow of Background Image Semantic Diffing

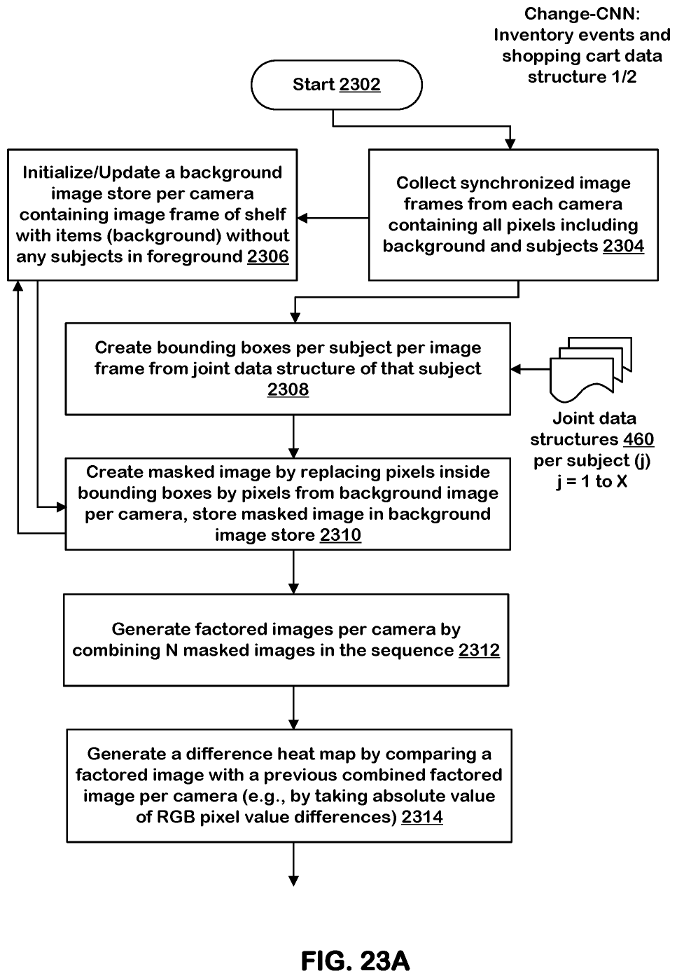

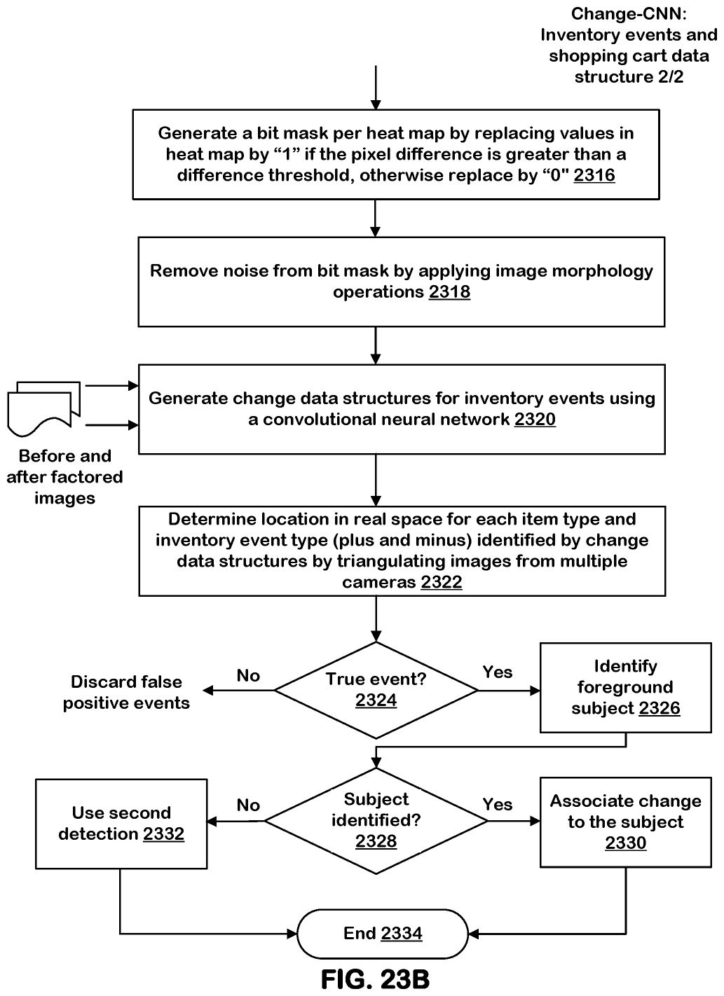

FIGS. 23A and 23B present detailed steps performed by the semantic diffing technique (also referred to as third image processors 1022) to track changes by subjects in an area of real space. In the example of a shopping store the subjects are customers and employees of the store moving in the store in aisles between shelves and other open spaces. The process starts at step 2302. As described above, the cameras 114 are calibrated before sequences of images from cameras are processed to identify subjects. Details of camera calibration are presented above. Cameras 114 with overlapping fields of view capture images of real space in which subjects are present. In one embodiment, the cameras are configured to generate synchronized sequences of images at the rate of N frames per second. The sequences of images of each camera are stored in respective circular buffers 1002 per camera at step 2304. A circular buffer (also referred to as a ring buffer) stores the sequences of images in a sliding window of time. The background image store 1028 is initialized with initial image frame in the sequence of image frames per camera with no foreground subjects (step 2306).

As subjects move in front of the shelves, bounding boxes per subject are generated using their corresponding joint data structures 460 as described above (step 2308). At a step 2310, a masked image is created by replacing the pixels in the bounding boxes per image frame by pixels at the same locations from the background image from the background image store 1028. The masked image corresponding to each image in the sequences of images per camera is stored in the background image store 1028. The ith masked image is used as a background image for replacing pixels in the following (i+1) image frame in the sequence of image frames per camera.

At a step 2312, N masked images are combined to generate factored images. At a step 2314, a difference heat map is generated by comparing pixel values of pairs of factored images. In one embodiment, the difference between pixels at a location (x, y) in a 2D space of the two factored images (fi1 and fi2) is calculated as shown below in equation 1:

$$\sqrt{\begin{matrix}( {( fi 1 [ x , y ] [ red ] - fi 2 [ x , y ] [ red ] )}^{2} + ( fi 1 [ x , y ] [ green ] - \\ {fi 2 [ x , y ] [ green ] )}^{2} + {( fi 1 [ x , y ] [ blue ] - fi 2 [ x , y ] [ blue ] )}^{2}\end{matrix}} \qquad ( 1 )$$

The difference between the pixels at the same x and y locations in the 2D space is determined using the respective intensity values of red, green and blue (RGB) channels as shown in the equation. The above equation gives a magnitude of the difference (also referred to as Euclidean norm) between corresponding pixels in the two factored images.

The difference heat map can contain noise due to sensor noise and luminosity changes in the area of real space. In FIG. 23B, at a step 2316, a bit mask is generated for a difference heat map. Semantically meaningful changes are identified by clusters of is (ones) in the bit mask. These clusters correspond to changes identifying inventory items taken from the shelf or put on the shelf. However, noise in the difference heat map can introduce random 1s in the bit mask. Additionally, multiple changes (multiple items take from or put on the shelf) can introduce overlapping clusters of 1s. At a next step (2318) in the process flow, image morphology operations are applied to the bit mask. The image morphology operations remove noise (unwanted 1s) and also attempt to separate overlapping clusters of 1s. This results in a cleaner bit mask comprising clusters of is corresponding to semantically meaningful changes.

Two inputs are given to the morphological operation. The first input is the bit mask and the second input is called a structuring element or kernel. Two basic morphological operations are “erosion” and “dilation”. A kernel consists of is arranged in a rectangular matrix in a variety of sizes. Kernels of different shapes (for example, circular, elliptical or cross-shaped) are created by adding 0's at specific locations in the matrix. Kernels of different shapes are used in image morphology operations to achieve desired results in cleaning bit masks. In erosion operation, a kernel slides (or moves) over the bit mask. A pixel (either 1 or 0) in the bit mask is considered 1 if all the pixels under the kernel are 1s. Otherwise, it is eroded (changed to 0). Erosion operation is useful in removing isolated is in the bit mask. However, erosion also shrinks the clusters of is by eroding the edges.

Dilation operation is the opposite of erosion. In this operation, when a kernel slides over the bit mask, the values of all pixels in the bit mask area overlapped by the kernel are changed to 1, if value of at least one pixel under the kernel is 1. Dilation is applied to the bit mask after erosion to increase the size clusters of 1s. As the noise is removed in erosion, dilation does not introduce random noise to the bit mask. A combination of erosion and dilation operations are applied to achieve cleaner bit masks. For example, the following line of computer program code applies a 3×3 filter of is to the bit mask to perform an “open” operation which applies erosion operation followed by dilation operation to remove noise and restore the size of clusters of is in the bit mask as described above. The above computer program code uses OpenCV (open source computer vision) library of programming functions for real time computer vision applications. The library is available at https://opencv.org/. _bit_mask=cv2.morphologyEx(bit_mask, cv2.MORPH_OPEN, self.kernel_3×3, dst=_bit_mask).

A “close” operation applies dilation operation followed by erosion operation. It is useful in closing small holes inside the clusters of 1s. The following program code applies a close operation to the bit mask using a 30×30 cross-shaped filter. _bit_mask=cv2.morphologyEx(bit_mask, cv2.MORPH_CLOSE, self.kernel_30×30_cross, dst=_bit_mask).

The bit_mask and the two factored images (before and after) are given as input to a convolutional neural network (referred to as ChangeCNN above) per camera. The outputs of ChangeCNN are the change data structures. At a step 2322, outputs from ChangeCNNs with overlapping fields of view are combined using triangulation techniques described earlier. A location of the change in the 3D real space is matched with locations of shelves. If location of an inventory event maps to a location on a shelf, the change is considered a true event (step 2324). Otherwise, the change is a false positive and is discarded. True events are associated with a foreground subject. At a step 2326, the foreground subject is identified. In one embodiment, the joints data structure 460 is used to determine location of a hand joint within a threshold distance of the change. If a foreground subject is identified at the step 2328, the change is associated to the identified subject at a step 2330. If no foreground subject is identified at the step 2328, for example, due to multiple subjects' hand joint locations within the threshold distance of the change. Then the detection of the change by region proposals subsystem is selected at a step 2332. The process ends at a step 2334.

### Training the ChangeCNN

A training data set of seven channel inputs is created to train the ChangeCNN. One or more subjects acting as customers, perform take and put actions by pretending to shop in a shopping store. Subjects move in aisles, taking inventory items from shelve and putting items back on the shelves. Images of actors performing the take and put actions are collected in the circular buffer 1002. The images are processed to generate factored images as described above. Pairs of factored images 1030 and corresponding bit mask output by the bit mask calculator 1032 are reviewed to visually identify a change between the two factored images. For a factored image with a change, a bounding box is manually drawn around the change. This is the smallest bounding box that contains the cluster of 1s corresponding to the change in the bit mask. The SKU number for the inventory item in the change is identified and included in the label for the image along with the bounding box. An event type identifying take or put of inventory item is also included in the label of the bounding box. Thus, the label for each bounding box identifies, its location on the factored image, the SKU of the item and the event type. A factored image can have more than one bounding boxes. The above process is repeated for every change in all collected factored images in the training data set. A pair of factored images along with the bit mask forms a seven channel input to the ChangeCNN.

During training of the ChangeCNN, forward passes and backpropagations are performed. In the forward pass, the ChangeCNN identify and classify background changes represented in the factored images in the corresponding sequences of images in the training data set. The ChangeCNN process identified background changes to make a first set of detections of takes of inventory items by identified subjects and of puts of inventory items on inventory display structures by identified subjects. During backpropagation the output of the ChangeCNN is compared with the ground truth as indicated in labels of training data set. A gradient for one or more cost functions is calculated. The gradient(s) are then propagated to the convolutional neural network (CNN) and the fully connected (FC) neural network so that the prediction error is reduced causing the output to be closer to the ground truth. In one embodiment, a softmax function and a cross-entropy loss function is used for training of the ChangeCNN for class prediction part of the output. The class prediction part of the output includes an SKU identifier of the inventory item and the event type i.e., a take or a put.

A second loss function is used to train the ChangeCNN for prediction of bounding boxes. This loss function calculates intersection over union (IOU) between the predicted box and the ground truth box. Area of intersection of bounding box predicted by the ChangeCNN with the true bounding box label is divided by the area of the union of the same bounding boxes. The value of IOU is high if the overlap between the predicted box and the ground truth boxes is large. If more than one predicted bounding boxes overlap the ground truth bounding box, then the one with highest IOU value is selected to calculate the loss function. Details of the loss function are presented by Redmon et. al., in their paper, “You Only Look Once: Unified, Real-Time Object Detection” published on May 9, 2016. The paper is available at https://arxiv.org/pdf/1506.02640.pdf.

### Computer System

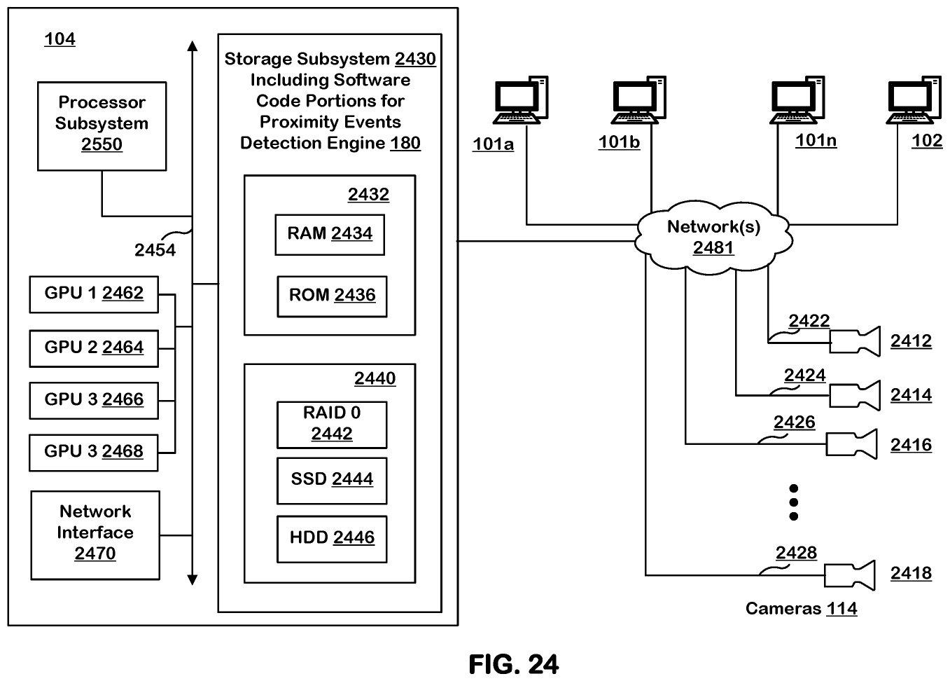

FIG. 24 presents an architecture of a network hosting image recognition engines. The system includes a plurality of network nodes 101a-101n in the illustrated embodiment. In such an embodiment, the network nodes are also referred to as processing platforms. Processing platforms 101a-101n and cameras 2412, 2414, 2416, . . . 2418 are connected to network(s) 2481.

FIG. 24 shows a plurality of cameras 2412, 2414, 2416, . . . 2418 connected to the network(s). A large number of cameras can be deployed in particular systems. In one embodiment, the cameras 2412 to 2418 are connected to the network(s) 2481 using Ethernet-based connectors 2422, 2424, 2426, and 2428, respectively. In such an embodiment, the Ethernet-based connectors have a data transfer speed of 1 gigabit per second, also referred to as Gigabit Ethernet. It is understood that in other embodiments, cameras 114 are connected to the network using other types of network connections which can have a faster or slower data transfer rate than Gigabit Ethernet. Also, in alternative embodiments, a set of cameras can be connected directly to each processing platform, and the processing platforms can be coupled to a network.

Storage subsystem 2430 stores the basic programming and data constructs that provide the functionality of certain embodiments of the present invention. For example, the various modules implementing the functionality of proximity event detection engine may be stored in storage subsystem 2430. The storage subsystem 2430 is an example of a computer readable memory comprising a non-transitory data storage medium, having computer instructions stored in the memory executable by a computer to perform the all or any combination of the data processing and image processing functions described herein, including logic to identify changes in real space, to track subjects, to detect puts and takes of inventory items, and to detect hand off of inventory items from one subject to another in an area of real space by processes as described herein. In other examples, the computer instructions can be stored in other types of memory, including portable memory, that comprise a non-transitory data storage medium or media, readable by a computer.

These software modules are generally executed by a processor subsystem 2450. The processor subsystem 2450 can include sequential instruction processors such as CPUs and GPUs, data flow instruction processors, such as FPGAs configured by instructions in the form of bit files, dedicated logic circuits supporting some or all of the functions of the processor subsystem, and combinations of one or more of these components. The processor subsystem may include a cloud-based processors in some embodiments.

A host memory subsystem 2432 typically includes a number of memories including a main random access memory (RAM) 2434 for storage of instructions and data during program execution and a read-only memory (ROM) 2436 in which fixed instructions are stored. In one embodiment, the RAM 2434 is used as a buffer for storing video streams from the cameras 114 connected to the platform 101a.

A file storage subsystem 2440 provides persistent storage for program and data files. In an example embodiment, the storage subsystem 2440 includes four 120 Gigabyte (GB) solid state disks (SSD) in a RAID 0 (redundant array of independent disks) arrangement identified by a numeral 2442. In the example embodiment, in which CNN is used to identify joints of subjects, the RAID 0 2442 is used to store training data. During training, the training data which is not in RAM 2434 is read from RAID 0 2442. Similarly, when images are being recorded for training purposes, the data which is not in RAM 2434 is stored in RAID 0 2442. In the example embodiment, the hard disk drive (HDD) 2446 is a 10 terabyte storage. It is slower in access speed than the RAID 0 2442 storage. The solid state disk (SSD) 2444 contains the operating system and related files for the image recognition engine 112a.

In an example configuration, three cameras 2412, 2414, and 2416, are connected to the processing platform 101a. Each camera has a dedicated graphics processing unit GPU 1 2462, GPU 2 2464, and GPU 3 2466, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 2450, the storage subsystem 2430 and the GPUs 2462, 2464, and 2466 communicate using the bus subsystem 2454.

A number of peripheral devices such as a network interface subsystem, user interface output devices, and user interface input devices are also connected to the bus subsystem 2454 forming part of the processing platform 101a. These subsystems and devices are intentionally not shown in FIG. 24 to improve the clarity of the description. Although bus subsystem 2454 is shown schematically as a single bus, alternative embodiments of the bus subsystem may use multiple busses.

In one embodiment, the cameras 2412 can be implemented using Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300−∞, a field of view field of view with a ⅓″ sensor of 98.2°−23.8°.

A first system, method and computer program product are provided for tracking exchanges of inventory items by subjects in an area of real space, comprising a processing system configured to receive a plurality of sequences of images of corresponding fields of view in the real space, the processing system including

an image recognition logic, receiving sequences of images from the plurality of sequences, the image recognition logic processing the images in sequences to identify locations of first and second subjects over time represented in the images; and

logic to process the identified locations of the first and second subjects over time to detect an exchange of an inventory item between the first and second subjects.

The first system, method and computer program product can include a plurality of sensors, sensors in the plurality of sensors producing respective sequences in the plurality of sequences of images of corresponding fields of view in the real space, the field of view of each sensor overlapping with the field of view of at least one other sensor in the plurality of sensors.

The first system, method and computer program product is provided wherein the image recognition logic includes an image recognition engine to detect the inventory item of the detected exchange.

The first system, method and computer program product is provided, wherein the locations of the first and second subjects include locations corresponding to hands of the first and second subjects, and wherein the image recognition logic includes an image recognition engine to detect the inventory item in the hands of the first and second subjects in the detected exchange.

The first system, method and computer program product is provided, wherein the image recognition logic includes a neural network trained to detect joints of subjects in images in the sequences of images, and heuristics to identify constellations of detected joints as locations of subjects, the image recognition logic further including logic to produce locations corresponding to hands of the first and second subjects in the detected joints, and a neural network trained to detect inventory items in hands of the first and second subjects in images in the sequences of images.

The first system, method and computer program product is provided, wherein the logic to process locations of the first and second subjects over time includes logic to detect proximity events when distance between locations of the first and second subjects is below a pre-determined threshold, wherein the locations of the subjects include three-dimensional positions in the area of real space.

The first system, method and computer program product is provided, wherein the logic to process locations over time includes a trained neural network to detect a likelihood that the first and second subjects are holding an inventory item in images preceding the proximity event and in images following the proximity event.

The first system, method and computer program product is provided, wherein the logic to process locations over time includes a trained decision tree network to detect the proximity event.

The first system, method and computer program product is provided, wherein the logic to process locations over time includes a trained random forest network to detect the proximity event.

A second system method and computer program product are provided for detecting exchanges of inventory items in an area of real space, for a method including:

receiving a plurality of sequences of images of corresponding fields of view in the real space;

processing the sequences of images to identify locations of first sources and first sinks, wherein the first sources and the first sinks represent subjects in three dimensions in the area of real space;

receiving positions of second sources and second sinks in three dimensions in the area of real space, wherein the second sources and the second sinks represent locations on inventory display structures in the area of real space; and

processing the identified locations of the first sources and the first sinks and locations of the second sources and second sinks over time to detect an exchange of an inventory item between sources and sinks in the first sources and the first sinks and sources and sinks in a combined first and second sources and sinks, by determining a proximity event in case distance between location of a source in the first sources and second sources is below a pre-determined threshold to location of a sink in the first sinks and second sinks, or

distance between location of a sink in the first sinks and second sinks is below a pre-determined threshold to location of a source in a combined first and second sources, and processing images before and after a determined proximity event to identify an exchange by detecting a condition,

wherein the source in the first sources and second sources holds the inventory item of the exchange prior to the detected proximity event and does not hold the inventory item after the detected proximity event and the sink in the first sinks and second sinks does not hold the inventory item of the exchange prior to the detected proximity event and holds the inventory item after the detected proximity event

A third system method and computer program product are provided for detecting exchanges of inventory items in an area of real space, for a method for fusing inventory events in an area of real space, the method including:

receiving a plurality of sequences of images of corresponding fields of view in the real space;

processing the sequences of images to identify locations of sources and sinks over time represented in the images, wherein the sources and sinks represent subjects in three dimensions in the area of real space;

using redundant procedures to detect an inventory event indicating exchange of an item between a source and a sink;

producing streams of inventory events using the redundant procedures, the inventory events including classification of the item exchanged;

matching an inventory event in one stream of the inventory events with inventory events in other streams of the inventory events within a threshold of a number of frames preceding or following the detection of the inventory event; and

generating a fused inventory event by weighted combination of the item classification of the item exchanged in the inventory event and the item exchanged in the matched inventory event.

A fourth system method and computer program product are provided for detecting exchanges of inventory items in an area of real space, for a method for fusing inventory events in an area of real space, the method including:

receiving a plurality of sequences of images of corresponding fields of view in the real space;

processing the sequences of images to identify locations of sources and sinks over time represented in the images, wherein the sources and sinks represent subjects in three dimensions in the area of real space;

detecting a proximity event indicating exchange of an item between a source and a sink when distance between the source and the sink is below a pre-determined threshold,

producing a stream of proximity events over time, the proximity events including classifications of items exchanged between the sources and the sinks;

processing bounding boxes of hands in images in the sequences of images to produce holding probabilities and classifications of items in the hands;

performing a time sequence analysis of the holding probabilities and classifications of items to detect region proposals events and producing a stream of region proposal events over time;

matching a proximity event in the stream of proximity events with events in the stream of region proposals events within a threshold of a number of frames preceding or following the detection of the proximity event; and

generating a fused inventory event by weighted combination of the item classification of the item exchanged in the proximity event and the item exchanged in the matched region proposals event.

A fifth system method and computer program product are provided for detecting exchanges of inventory items in an area of real space, for a method for fusing inventory events in an area of real space, the method including:

receiving a plurality of sequences of images of corresponding fields of view in the real space;

processing the sequences of images to identify locations of sources and sinks over time represented in the images, wherein the sources and sinks represent subjects in three dimensions in the area of real space;

detecting a proximity event indicating exchange of an item between a source and a sink when distance between the source and the sink is below a pre-determined threshold,

producing a stream of proximity events over time, the proximity events including classifications of items exchanged between the sources and the sinks;

masking foreground source and sinks in images in the sequences of images to generate background images of inventory display structures;

processing background images to detect semantic diffing events including item classifications and sources and sinks associated with the classified items and producing a stream of semantic diffing events over time;

matching a proximity event in the stream of proximity events with events in the stream of semantic diffing events within a threshold of a number of frames preceding or following the detection of the proximity event; and

generating a fused inventory event by weighted combination of the item classification of the item exchanged in the proximity event and the item exchanged in the matched semantic diffing event.

What is claimed is:

1. A method for tracking exchanges of inventory items between inventory caches which can act as at least one of sources and sinks of inventory items in exchanges of inventory items; the method including:
first processing a plurality of sequences of images, in which sequences of images in the plurality of sequences of images have respective fields of view in the real space, to locate inventory caches which move over time having locations in three dimensions;
accessing data to locate inventory caches on inventory display structures in the area of real space;
second processing the located inventory caches over time to detect a proximity event between the located inventory caches, the proximity event having a location in the area of real space and a time; and
third processing images in at least one sequence of images in the plurality of sequences of images before and after the time of the proximity event to classify an exchange of an inventory item in the proximity event.

2. The method of claim 1, wherein the images plurality of sequences of images are received with a first image resolution, the first processing includes reducing the resolution of images in the plurality of images to a second image resolution, and applying the reduced resolution images as input to a trained inference engine.

3. The method of claim 2, wherein the second processing includes using a second trained inference engine.

4. The method of claim 2, wherein the third processing includes applying images in the plurality of images with the first resolution to a third trained inference engine.

5. The method of claim 1, wherein the second processing includes applying the locations of inventory caches from the first processing over time to a trained inference engine.

6. The method of claim 1, wherein the third processing includes cropping images in the plurality of sequences of images to provide cropped images, applying the cropped images a third trained inference engine.

7. The method of claim 1, further including using an image recognition engine to identify an inventory item linked to the proximity event.

8. The method of claim 1, wherein the locations of the inventory caches include locations corresponding to hands of identified subjects, and wherein the processing the sequences of images includes using an image recognition engine to detect the inventory item in the hands of the identified in the detected exchange.

9. The method of claim 1, wherein the first processing the sequences of images includes using a first neural network trained to detect joints of subjects in images in the sequences of images, and using heuristics to identify constellations of detected joints of individual subjects, wherein locating inventory caches includes locating joints in the detected joints of individual subjects.

10. The method of claim 1 wherein the second processing the located inventory caches over time to detect a proximity event, further including,
detecting proximity events when distance between locations of the inventory caches is below a pre-determined threshold.

11. The method of claim 1, wherein second processing the located inventory caches over time to detect a proximity event, further including,
detecting the proximity event using a trained neural network.

12. The method of claim 1, wherein second processing the located inventory caches over time to detect a proximity event, further including,
detecting the proximity event using a trained random forest.

13. A system including one or more processors and memory accessible by the processors, the memory loaded with computer instructions tracking exchanges of inventory items between inventory caches which can act as at least one of sources and sinks of inventory items in exchanges of inventory items, the instructions, when executed on the processors, implement actions comprising:
first processing a plurality of sequences of images, in which sequences of images in the plurality of sequences of images have respective fields of view in the real space, to locate inventory caches which move over time having locations in three dimensions;
accessing data to locate inventory caches on inventory display structures in the area of real space;
second processing the located inventory caches over time to detect a proximity event between the located inventory caches, the proximity event having a location in the area of real space and a time; and
third processing images in at least one sequence of images in the plurality of sequences of images before and after the time of the proximity event to classify an exchange of an inventory item in the proximity event.

14. The system of claim 13, wherein the images plurality of sequences of images are received with a first image resolution, the first processing includes reducing the resolution of images in the plurality of images to a second image resolution, and applying the reduced resolution images as input to a trained inference engine.

15. The system of claim 14, wherein the second processing includes using a second trained inference engine.

16. The system of claim 14, wherein the third processing includes applying images in the plurality of images with the first resolution to a third trained inference engine.

17. The system of claim 13, wherein the second processing includes applying the locations of inventory caches from the first processing over time to a trained inference engine.

18. The system of claim 13, wherein the third processing includes cropping images in the plurality of sequences of images to provide cropped images, applying the cropped images a third trained inference engine.

19. The system of claim 13, further including using an image recognition engine to identify an inventory item linked to the proximity event.

20. The system of claim 13, wherein the locations of the inventory caches include locations corresponding to hands of identified subjects, and wherein the processing the sequences of images includes using an image recognition engine to detect the inventory item in the hands of the identified in the detected exchange.

21. The system of claim 13, wherein the first processing the sequences of images includes using a first neural network trained to detect joints of subjects in images in the sequences of images, and using heuristics to identify constellations of detected joints of individual subjects, wherein locating inventory caches includes locating joints in the detected joints of individual subjects.

22. The system of claim 13, wherein the second processing the located inventory caches over time to detect a proximity event, further includes detecting proximity events when distance between locations of the inventory caches is below a pre-determined threshold.

23. The system of claim 13, wherein second processing the located inventory caches over time to detect a proximity event, further includes detecting the proximity event using a trained neural network.

24. The system of claim 13, wherein second processing the located inventory caches over time to detect a proximity event, further including,
detecting the proximity event using a trained random forest.

25. The system of claim 13, further including, a plurality of sensors, sensors in the plurality of sensors producing respective sequences in the plurality of sequences of images of corresponding fields of view in the real space, the field of view of each sensor overlapping with the field of view of at least one other sensors in the plurality of sensors.

26. A non-transitory computer readable storage medium impressed with computer program instructions to track exchanges of inventory items between inventory caches which can act as at least one of sources and sinks of inventory items in exchanges of inventory items, the instructions when executed implement a method comprising:
first processing a plurality of sequences of images, in which sequences of images in the plurality of sequences of images have respective fields of view in the real space, to locate inventory caches which move over time having locations in three dimensions;
accessing data to locate inventory caches on inventory display structures in the area of real space;
second processing the located inventory caches over time to detect a proximity event between the located inventory caches, the proximity event having a location in the area of real space and a time; and
third processing images in at least one sequence of images in the plurality of sequences of images before and after the time of the proximity event to classify an exchange of an inventory item in the proximity event.

27. The non-transitory computer readable storage medium of claim 26, wherein the images plurality of sequences of images are received with a first image resolution, the first processing includes reducing the resolution of images in the plurality of images to a second image resolution, and applying the reduced resolution images as input to a trained inference engine.

28. The non-transitory computer readable storage medium of claim 27, wherein the second processing includes using a second trained inference engine.

29. The non-transitory computer readable storage medium of claim 27, wherein the third processing includes applying images in the plurality of images with the first resolution to a third trained inference engine.

30. The non-transitory computer readable storage medium of claim 26, wherein the second processing includes applying the locations of inventory caches from the first processing to a second trained inference engine.

31. The non-transitory computer readable storage medium of claim 26, wherein the third processing includes cropping images in the plurality of sequences of images to provide cropped images, applying the cropped images a third trained inference engine.

32. The non-transitory computer readable storage medium of claim 26, further including using an image recognition engine to identify an inventory item linked to the proximity event.

33. The non-transitory computer readable storage medium of claim 26, wherein the locations of the inventory caches include locations corresponding to hands of identified subjects, and wherein the processing the sequences of images includes using an image recognition engine to detect the inventory item in the hands of the identified in the detected exchange.

34. The non-transitory computer readable storage medium of claim 26, wherein the first processing the sequences of images includes using a first neural network trained to detect joints of subjects in images in the sequences of images, and using heuristics to identify constellations of detected joints of individual subjects, wherein locating inventory caches includes locating joints in the detected joints of individual subjects.

35. The non-transitory computer readable storage medium of claim 26, wherein the second processing the located inventory caches over time to detect a proximity event, further includes
detecting proximity events when distance between locations of the inventory caches is below a pre-determined threshold.

36. The non-transitory computer readable storage medium of claim 26, wherein second processing the located inventory caches over time to detect a proximity event, further includes
detecting the proximity event using a trained neural network.

37. The non-transitory computer readable storage medium of claim 26, wherein second processing the located inventory caches over time to detect a proximity event, further including,
detecting the proximity event using a trained random forest.
